(19) United States
(12) Patent Application Publication
(10) Pub. No.: US 2023/0305895 A1
(43) Pub. Date: Sep. 28, 2023

(54) SYSTEMS, APPARATUS, ARTICLES OF MANUFACTURE, AND METHODS FOR DATA DRIVEN NETWORKING

(71) Applicant: Intel Corporation, Santa Clara, CA (US)

(72) Inventors: Roya Doostnejad, Los Altos, CA (US); Soo Jin Tan, Shanghai (CN); Valerie Parker, Portland, OR (US); Stephen Palermo, Chandler, AZ (US); John Belstner, Scottsdale, AZ (US); Pranali Jhaveri, Sunnyvale, CA (US); Georgia Sandoval, Irvine, CA (US); Daviann A. Duarte, Portland, OR (US)

(21) Appl. No.: 18/189,813

(22) Filed: Mar. 24, 2023

Related U.S. Application Data
(63) Continuation-in-part of application No. PCT/CN2022/082979, filed on Mar. 25, 2022.

(30) Foreign Application Priority Data
Mar. 25, 2022 (WO) PCT/CN2022/082979

(51) Int. Cl. G06F 9/50; G06F 9/455

(52) U.S. Cl. CPC G06F 9/5027; G06F 9/45558; G06F 2009/4557

(57) ABSTRACT

Systems, apparatus, articles of manufacture, and methods are disclosed. An example edge compute device disclosed herein includes interface circuitry, machine readable instructions, and programmable circuitry to execute the machine readable instructions to configure compute resources of the edge compute device based on a first resource demand associated with a first location of the edge compute device, detect a change in location of the edge compute device to a second location, and in response to detection of the change in location, reconfigure the compute resources of the edge compute device based on a second resource demand associated with the second location.

### RELATED APPLICATION

This patent claims priority to International Application No. PCT/CN2022/082979, which was filed on Mar. 25, 2022. International Patent Application No. PCT/CN2022/082979 is hereby incorporated herein by reference in its entirety. Priority to International Patent Application No. PCT/CN2022/082979 is hereby claimed.

### FIELD OF THE DISCLOSURE

This disclosure relates generally to communication networks and, more particularly, to systems, apparatus, articles of manufacture, and methods for data driven networking.

### BACKGROUND

In recent years, the volume of data generated by sensors and devices has grown rapidly. To effectively process this data, a computing paradigm called edge computing has developed. In edge computing, rather than transmitting all data to a centralized server for processing, workloads can be executed at the edge, bringing computation and data storage closer to the source of the data. With the greater prevalence of edge computing, management and optimization of edge resources has become an area of intense research and industrial interest.

### BRIEF DESCRIPTION OF THE DRAWINGS

FIG. 1 depicts an example data driven networking (DDN) system.

FIG. 2 depicts an example implementation of the DDN system of FIG. 1, which includes an example DDN control circuitry.

FIG. 3 depicts an example implementation of the DDN control circuitry of FIG. 2.

FIG. 4 depicts another example implementation of the DDN control circuitry of FIG. 2 in a first example state.

FIG. 5 depicts the example implementation of the DDN control circuitry of FIG. 4 in a second example state.

FIG. 6 depicts another example implementation of the DDN control circuitry of FIG. 2.

FIG. 7 depicts an example system including example fixed and mobile network nodes.

FIG. 8 depicts an example system that may implement the examples disclosed herein.

FIG. 9 depicts an example implementation of a DDN server.

FIG. 10 depicts another example implementation of a DDN server.

FIG. 11 depicts yet another example implementation of a DDN server.

FIG. 12 depicts another example implementation of a DDN server.

FIG. 13 depicts yet another example implementation of a DDN server.

FIG. 14 depicts another example implementation of a DDN server.

FIG. 15 depicts an example workflow for an example DDN server as disclosed herein.

FIG. 16 depicts another example workflow for an example DDN server as disclosed herein.

FIG. 17 depicts yet another example workflow for an example DDN server as disclosed herein.

FIG. 18 depicts another example workflow for an example DDN server as disclosed herein.

FIG. 19 depicts yet another example workflow for an example DDN server as disclosed herein.

FIG. 20 depicts a block diagram of an example DDN system architecture.

FIG. 21 depicts an example workflow of the example DDN system architecture of FIG. 20.

FIG. 22 depicts another example workflow of the example DDN system architecture of FIG. 20.

FIG. 23 depicts yet another example workflow of the example DDN system architecture of FIG. 20.

FIG. 24 depicts another example workflow of the example DDN system architecture of FIG. 20.

FIG. 25 illustrates an overview of an example edge cloud configuration for edge computing that may implement the examples disclosed herein.

FIG. 26 illustrates operational layers among example endpoints, an example edge cloud, and example cloud computing environments that may implement the examples disclosed herein.

FIG. 27 illustrates an example approach for networking and services in an edge computing system that may implement the examples disclosed herein.

FIG. 28 depicts an example edge computing system for providing edge services and applications to multi-stakeholder entities, as distributed among one or more client compute platforms, one or more edge gateway platforms, one or more edge aggregation platforms, one or more core data centers, and a global network cloud, as distributed across layers of the edge computing system.

FIG. 29 depicts a cloud computing network, or cloud, in communication with a number of Internet of Things (IoT) devices, according to an example.

FIG. 30 illustrates network connectivity in non-terrestrial (satellite) and terrestrial (mobile cellular network) settings, according to an example.

FIG. 31 is a block diagram of an example implementation of the DDN control circuitry of FIG. 2.

FIGS. 32-35C are flowcharts representative of example machine readable instructions and/or example operations that may be executed, instantiated, and/or performed by example programmable circuitry to implement the DDN control circuitry of FIGS. 2 and/or 31.

FIG. 36 illustrates a block diagram for an example IoT processing system architecture upon which any one or more of the techniques (e.g., operations, processes, methods, and methodologies) discussed herein may be performed, according to an example.

FIG. 37 is a block diagram of an example processing platform including programmable circuitry structured to execute, instantiate, and/or perform the example machine readable instructions and/or perform the example operations of FIGS. 32-35C to implement the DDN control circuitry of FIGS. 2 and/or 31.

FIG. 38 is a block diagram of an example implementation of the programmable circuitry of FIGS. 36 and/or 37.

FIG. 39 is a block diagram of another example implementation of the programmable circuitry of FIG. 37.

FIG. 40 is a block diagram of an example software/firmware/instructions distribution platform (e.g., one or more servers) to distribute software, instructions, and/or firmware (e.g., corresponding to the example machine readable instructions of FIGS. 32-35C) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Networks of multiple frequencies, spectrums, and/or communication types are increasingly important in modern computing. Prevalent technologies and standards that facilitate modern communication include fourth, fifth, and sixth generation cellular (e.g., 4G or 5G or 6G), Citizens Broadband Radio Service (CBRS), private cellular, Wireless Fidelity (Wi-Fi), satellite (e.g., a geosynchronous equatorial orbit (GEO) satellite, a non-governmental organization (NGO) satellite), etc.

Management of devices that utilize more than one connectivity technology (e.g., different wireless spectrums) presents multiple challenges. Specifically, issues may arise with control, connectivity management, and workload consolidation of such devices. Such problems are compounded when managing devices across multiple clients and geographic locations (e.g., the edge, the cloud). Conventional network connection implementation (e.g., conventional network effectuation) and management techniques may be performed in silos from fixed spectrum chipsets, which makes ensuring a satisfactory quality-of-service (QoS) from each spectrum, security management across spectrums, and configuration profiling challenging. Examples disclosed herein overcome such challenges via frictionless spectrum detection (FSD) based on data driven conditioning to order spectrum feeds. Some examples include a dynamic landscape of fixed or mobile edge nodes. Such examples may include terrestrial or non-terrestrial devices, creating a network that can adapt based on a location, time, and workload associated with the network. Some examples include policy techniques to correct for lost packets (e.g., within a specific spectrum and/or for out of order processing across multiple spectrums).

Conventional communication networks may be characterized as static. A network may be static in terms of connectivity, as it does not adequately support multiple connection types. A network may also be static in terms of configuration, unable to improve its efficiency via configuration changes. Conventional communication networks are typically configured based on estimated usage and/or connection type, and therefore are put into operation to support specific wireless connection and predetermined capacity. Conventional network deployments may include multiple radio base stations to connect to each type of available communication connection (e.g., 4G/5G/6G, Wi-Fi, private radio, etc.). Conventional communication connections can include long term evolution (LTE), 4G LTE (e.g., Cat-20, spectrums), 5G NR sub6G, 5G millimeter wave, private network space LEO satellites, public and/or private space satellites, GEO satellites, LEO satellites, etc., and/or any combination(s) thereof.

The deployment of multiple radio base stations increases deployment complexity and cost (e.g., monetary cost associated with additional hardware, resource cost associated with increased number of compute, memory, and/or network resources required to be in operation, etc.). Examples disclosed herein overcome such challenges of conventional network deployments by utilizing multi-spectrum, multi-modal terrestrial and non-terrestrial sensors and/or communication connection technologies to continuously identify devices that are connected to network(s). Examples disclosed herein identify optimal and/or otherwise improved selection of communication connection technologies for devices. For example, devices can include electronic devices associated with persons (e.g., pedestrians, persons in an industrial or manufacturing setting, etc.), vehicles, equipment, tools, etc. Examples disclosed herein can identify an electronic device and its communication connection capabilities and, based on a variety of factors (e.g., connection data, network environment data, etc.), identify a communication connection network of which the electronic device can utilize to improve network QoS (e.g., increased throughput, reduced latency, etc.). Advantageously, examples disclosed herein can connect to these spectrums autonomously (e.g., fluidly connect and/or disconnect), which conventional communication networks cannot. Advantageously, examples disclosed herein can achieve improved service, greater user choice (e.g., based on network quality), and lower total cost of ownership for enterprises.

Network quality and usage optimizations are typically focused on specific user equipment (UE) communicating via a single connection type (e.g., 4G/5G, Wi-Fi, etc.). Such conventional solutions do not consider environmental conditions (e.g., weather conditions), network-centric environmental impacts (e.g., signal blockage), or actual usage at a particular network node (e.g., at a fixed network node or base station). Conventional techniques for optimizing and/or otherwise improving network communications are limited to one connection type and do not consider real-time usage of multi-access users and devices, which can include wireless sensors, wired sensors, active/passive sensors, etc. Examples disclosed herein overcome the limitations of conventional network communication optimizations by utilizing an array of real-time network telemetry and/or real-world multi-access activity at a specific physical location. In some disclosed examples, a data driven networking (DDN) controller can invoke Artificial Intelligence/Machine Learning (AI/ML) techniques to utilize multi-access converged connection data at a physical network node and actual network traffic utilization to configure and/or reconfigure network nodes with a re-dimensioned network node that can adapt over time to address the needs of connected UEs or gateways.

In some disclosed examples, the DDN control circuitry can leverage location-aware capabilities for device identification with terrestrial techniques (e.g., time-of-arrival (TOA), angle-of-arrival (AOA), round-trip time (RTT), etc.) in cellular networks and/or non-terrestrial techniques (e.g., sync pulse generator (SPG) techniques, SPG, global navigation satellite system (GNSS), etc.) in satellite-based networks for different types of devices, such as 5G or 6G enabled devices, CBRS enabled devices, category 1 (CAT-1) devices, category M (CAT-M) devices, Narrowband Internet of Things (NB-IoT) devices, etc.

In some disclosed examples, the DDN control circuitry can self-calibrate network nodes using active, live, operational, etc., usage data. For example, the DDN control circuitry can adjust (e.g., automatically adjust) a network node to converged multi-access usage by reconfiguring either fixed or mobile network nodes to accommodate actual-, live-, or real-world usage and telemetry of connected users, devices, or gateways. For example, the devices, gateways, etc., can include 4G, 5G New Radio (NR), CBRS, private cellular, Wi-Fi, satellite, Bluetooth, light detection and ranging devices, passive/active sensors, etc.

Conventional communication networks use location detection capabilities to identify devices connected to a network. Conventional location detection capabilities have many shortcomings, especially when applied to mobile objects. When objects move, variance in signal strength and coverage can reduce location detection accuracy when compared to non-moving objects. Such shortcomings may challenge positioning, navigation, and timing (PNT) resilience in important applications (e.g., infrastructure, commercial applications, research). GPS is susceptible to challenges in location determination such as potential signal loss and unverified/unauthenticated receipt of GPS data (e.g., ranging signals). Applications relying on satellite GPS/GNSS location determination may be limited because of signal strength used for doppler frequency shift signatures. Furthermore, weak signals from distance geosynchronous equatorial orbit (GEO) (also referred to as geostationary orbit) satellites may be susceptible to malicious activity (e.g., jamming and spoofing) or electromagnetic noise. Terrestrial-based location determination may be limited by a lack of continuous global coverage (e.g., gaps between networks), local obstructions to sensors (e.g., causing a break in object tracking).

In some disclosed examples, the DDN control circuitry can access wireless connectivity at an 1-2 OSI layer, sense a wireless spectrum type, enable a connection based on the sensed wireless spectrum, provide multi-access at one or more base stations, and/or select an appropriate billing method. In some disclosed examples, the DDN control circuitry can use substantially real time, low latency analytics to determine how and when to connect to an electronic device (e.g., a UE). In some disclosed examples, the DDN control circuitry can store encryption keys with other identifying information (e.g., location) to ensure privacy and security. In some disclosed examples, the DDN control circuitry can perform on the wire modifications to ongoing packet streams using real-time telemetry. In some disclosed examples, the DDN control circuitry can use satellite data to alter wireless connectivity based on geographic activities. In some disclosed examples, the DDN control circuitry can implement security policies using telemetry and/or AI. For example, the DDN control circuitry may use unsupervised learning to detect one or more anomalies in a network communication and implement a security policy for the network in response to detection of the one or more anomalies.

In some disclosed examples, the DDN control circuitry leverages data driven location detection using multi-modal, multi-spectrum terrestrial and/or non-terrestrial techniques and sensors to achieve continuous, seamless, and/or otherwise frictionless coverage of active and/or passive objects. Multi-modal may refer to the utilization of multiple, different types of data sources (e.g., homogeneous, heterogeneous, etc.). For example, multi-modal location detection may be implemented as disclosed herein by determining a location of an object based on data from multiple, different (e.g., heterogeneous) data sources (e.g., a video camera, a wireless communication beacon, etc.). In some examples, multi-modal location detection may be implemented by determining a location of an object based on data from multiple homogeneous data sources (e.g., multiple cameras, multiple beacons, multiple base stations, multiple Wi-Fi access points, etc.). In other examples, multiple heterogenous data sources may be used for multi-modal location detection.

Multi-spectrum (or multi-spectral) may refer to two or more ranges of frequencies or wavelengths in the electromagnetic spectrum, which may be heterogeneous (e.g., corresponding to different frequency/wavelength ranges processed by different connection technologies), homogeneous (e.g., corresponding to different frequency/wavelength ranges processed by a given type of connection technology. For example, heterogeneous, multi-spectrum location detection may be implemented as disclosed herein by determining a location of an object based on light sensing (e.g., sensing based on LIDAR techniques) and electromagnetic sensing (e.g., sensing based on Wi-Fi, cellular, Bluetooth, etc., techniques). In some examples, homogeneous, multi-spectrum location detection may be implemented as disclosed herein by determining a location of an object based on a first type of cellular connection technology (e.g., 4G LTE), a second type of cellular connection technology (e.g., 5G, 6G, etc.), or any combination(s) thereof. In some examples, homogeneous, multi-spectrum location detection may be implemented as disclosed herein by determining a location of an object based on a first type of Bluetooth connection technology (e.g., Bluetooth low energy (BLE)), a second type of Bluetooth connection technology (e.g., Bluetooth version 3.0 (v3.0), Bluetooth version 4.0 (v4.0), etc.), or combination(s) thereof.

Advantageously, any connection technology, such as Wi-Fi, cellular, satellite, LIDAR, wireline Ethernet, Bluetooth, etc., along with other (multi-modal) sensor information, such as cameras and environmental sensors (e.g., air pressure, carbon monoxide, light, temperature, etc., sensors), or any combination(s) thereof, may be utilized to leverage legacy equipment, reduce installation costs and complexity, and improve accuracy of location detection. Advantageously, utilization of any connection technology, or combination(s) thereof, may generate a sufficiency and/or diversity of data to improve location, identification, machine learning, and dynamic sensor utilization applications to reduce a total cost of ownership and thereby provide a higher return on investment (ROI) for civilian, commercial, and/or industrial stakeholders.

In some disclosed examples, the DDN control circuitry can include a location engine to locate (e.g., position) a passive object or an active object based on data generated from multiple sensors. A passive object may refer to an object that is not powered and/or needs power for operation. An active object may refer to a mobile object and/or an object that is powered. In some disclosed examples, the location engine may leverage the participation of passive and/or active objects in the location detection of themselves. For example, an active object such as powered user equipment (e.g., a mobile handset device, a wearable device, etc.) may generate and transmit location data (e.g., 5G Layer 1 (L1) data, 5G data of a physical layer or Layer 1 (L1) of an Open Systems Interconnection (OSI) model, etc.) to the location engine. For example, the 5G L1 data can include Sounding Reference Signal (SRS) data or any other type of cellular data.

In some disclosed examples, the location engine may utilize homogeneous data and/or heterogeneous data based on at least one of need or availability. For example, the location engine may utilize homogeneous data to compute location while, in other examples, the location engine may utilize heterogeneous data to compute the location data. In some examples, the location engine may utilize homogeneous data to determine location data and, in response to determination that the location data has an accuracy, a reliability, etc., that is less than a threshold (e.g., an accuracy threshold, a reliability threshold, etc.), the location engine may utilize heterogeneous data to determine the location data to improve accuracy, reliability, etc. In some examples, the location engine may utilize heterogeneous data to determine an accuracy of location data. Then, in response to a determination that the location data has an accuracy, a reliability, etc., that is less than a threshold (e.g., an accuracy threshold, a reliability threshold, etc.), the location engine may utilize homogeneous data to determine the location data to improve the accuracy, the reliability, etc.

In some disclosed examples, the location engine may utilize AI/ML techniques to detect and/or otherwise determine a location of an object (e.g., a passive object, an active object, etc.). For example, the location engine may use different video pixels generated by a video camera as one of multiple sensors tracking the object. In some disclosed examples, the location engine may execute an AI/ML model using the video pixels as inputs (e.g., data inputs, AI/ML inputs, AI/ML model inputs, etc.) to generate outputs (e.g., data outputs, AI/ML outputs, AI/ML model outputs, etc.). In some disclosed examples, the location engine may execute the AI/ML model to generate the outputs to include a prediction and/or otherwise a determination of an instant location of the object, a future or subsequent location of the object, etc. In some disclosed examples, the location engine may execute the AI/ML model to generate the outputs to include detections of changes in an environment including the object. For example, the location engine may detect that another object or item is blocking the camera and/or the object of interest. For example, in an industrial environment including an autonomous robot having a robotic arm, the robotic arm may need to pick up a tool but the tool may have been previously moved away from the robotic arm. In some examples, the location engine may execute an AI/ML model to locate the tool and provide the location (e.g., the precise location, a location within a specified tolerance, etc.) to the robot so that the robot may re-find or locate the tool, pick up the tool, and execute an operation with the tool. Advantageously, the location engine may utilize AI/ML techniques, which may include the use of one or more machine learning models, by ingesting data from multiple modes, multiple spectrums, etc. Furthermore, although examples disclosed herein are described in reference to modern compute workloads and network transformations for workloads (e.g., vRAN), the techniques described herein are not limited thereto.

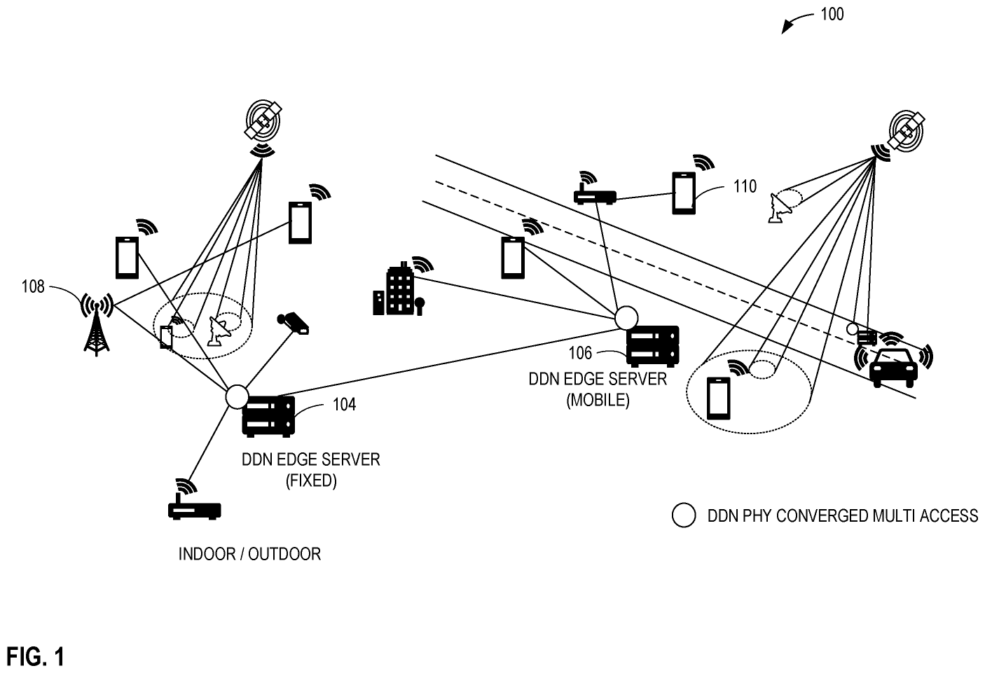

FIG. 1 depicts an example data driven networking (DDN) system 100 that includes multiple DDN nodes (e.g., edge compute devices). The DDN system 100 includes a first example DDN edge server 104 (e.g., a first DDN node, a first edge compute device) and an example second DDN edge server 106 (e.g., a second DDN node, a second edge compute device). The first DDN edge server 104 is a fixed and/or otherwise stationary edge server. Alternatively, the first DDN edge server 104 may be mobile and/or otherwise move from location to location. The first DDN edge server 104 is in communication with a variety of the first devices 108 and all other devices shown but not labeled that connect to the circle on the first DDN edge server 104, which can include a base station (e.g., a remote radio unit (RRU)), mobile handsets (e.g., Internet-enabled smartphones), a ground-based satellite antenna, a satellite (e.g., a low-earth orbit (LEO) satellite or any other type of satellite), a network interface (e.g., a router, a gateway, etc.), a sensor (e.g., a video camera, a LIDAR sensor, etc.), etc., and/or any combination(s) thereof. In some examples, the first DDN edge server 104 and/or one(s) of the first devices 108 may be associated with an indoor environment (e.g., a commercial or residential building) or an outdoor environment (e.g., a public park).

In contrast to the first DDN edge server 104, which is fixed, the second DDN edge server 106 is a mobile edge server. For example, the second DDN edge server 106 can be a vehicle (e.g., included in and/or otherwise associated with a vehicle) or a non-terrestrial vehicle such as an NGO satellite, airplane, etc. Alternatively, the second DDN edge server 106 may be a fixed and/or otherwise stationary edge server. The second DDN edge server 106 is in communication with a variety of example second devices 110, which can include a base station coupled to infrastructure (e.g., a residential or commercial building, a traffic light pole, a highway overpass, etc.), mobile handsets, tablet computers, a vehicle (e.g., a device of a vehicle that is capable of communicating via cellular or vehicle-to-everything (V2X) networks), etc., and/or any combination(s) thereof.

In example operation, the second DDN edge servers 104, 106 can achieve DDN physical (PHY) converged multi access communication. For example, the first DDN edge server 104 can obtain telemetry data associated with one(s) of the first devices 108 and network data (e.g., network environment data, network quality data, etc.) from network devices such as a base station. In some examples, the first DDN edge server 104 can determine that one of the first devices 108 is experiencing relatively low communication quality with a first type of communication connection (e.g., a 4G/5G/6G connection) and can instruct the one of the first devices 108 to switch and/or otherwise transition over to a second type of communication connection (e.g., Wi-Fi) based on the second type of communication connection having a relatively higher communication quality than the first type of communication connection.

In example operation, the second DDN edge server 106 can obtain telemetry data associated with one(s) of the second devices 110 and network data from network devices such as a base station. In some examples, the second DDN edge server 106 can determine that one of the second devices 110 is experiencing relatively low communication quality with a first type of communication connection (e.g., a 4G/5G/6G connection) and can instruct the one of the second devices 110 to switch and/or otherwise transition over to a second type of communication connection (e.g., Wi-Fi) based on the second type of communication connection having a relatively higher communication quality than the first type of communication connection. In some examples, communication link quality can be impacted by natural (e.g., weather) or unnatural (e.g., garbage truck or other obstruction) environmental conditions impacting the signal strength to and from a DDN node. For example, the second DDN edge server 106 may identify that multipath fading, scattering, doppler, power loss, and/or signal fade have impacted wireless signal link quality.

The illustrated example of FIG. 1 shows two DDN edge servers: the first DDN edge server 104 (e.g., a fixed DDN edge server) and the second DDN edge server 106 (e.g., a mobile edge server). However, in some examples there may be many more (e.g., hundreds, thousands, millions, etc.) of edge nodes, including terrestrial and non-terrestrial edge nodes. Furthermore, edge node compute and network customizations may happen frequently (e.g., within seconds, milliseconds, etc.).

In general, any number of edge nodes (e.g., gNBs, DDN nodes, DDN servers, etc.) may combine to form a networked system of DDN nodes (e.g., edge compute devices) as illustrated in FIG. 1. Factors such as how large a desired area of coverage is, a level of resource demand, a capability of each edge node, etc., may determine how many DDN edge nodes are appropriate for a network. For example, a single DDN edge node may provide adequate coverage for a small area. However, to cover a larger area with greater demand, multiple edge nodes may be deployed together, forming a fluid network of interconnected DDN nodes. In some examples, a DDN edge node can be fixed (e.g., on a street lamp) or mobile (e.g., mounted on an electric vehicle). In some examples the edge compute device is a mobile edge compute device included in a network of edge compute devices, the network of edge compute devices including at least one stationary (e.g., does not operate while changing geographic location) compute device.

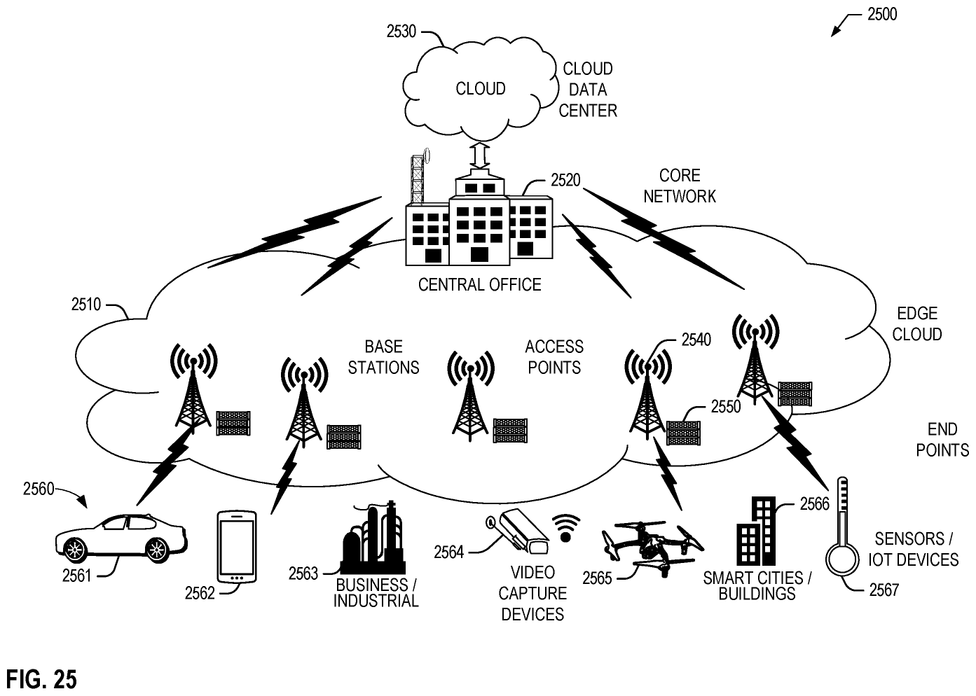

Some examples described herein include one or more edge compute devices. An edge compute device may be any object that has the capacity to process instructions in executable code form. Examples of edge compute devices may include personal computers, servers, mobile devices, tablets, routers, switches, wireless access points, etc. Furthermore, although any of the edge nodes and/or edge devices described herein may be edge compute devices, many additional types of compute devices are compatible with the techniques described herein. In particular, the interested reader may refer to FIGS. 25-29 below for a discussion of edge computing, edge compute devices, IoT devices, and more.

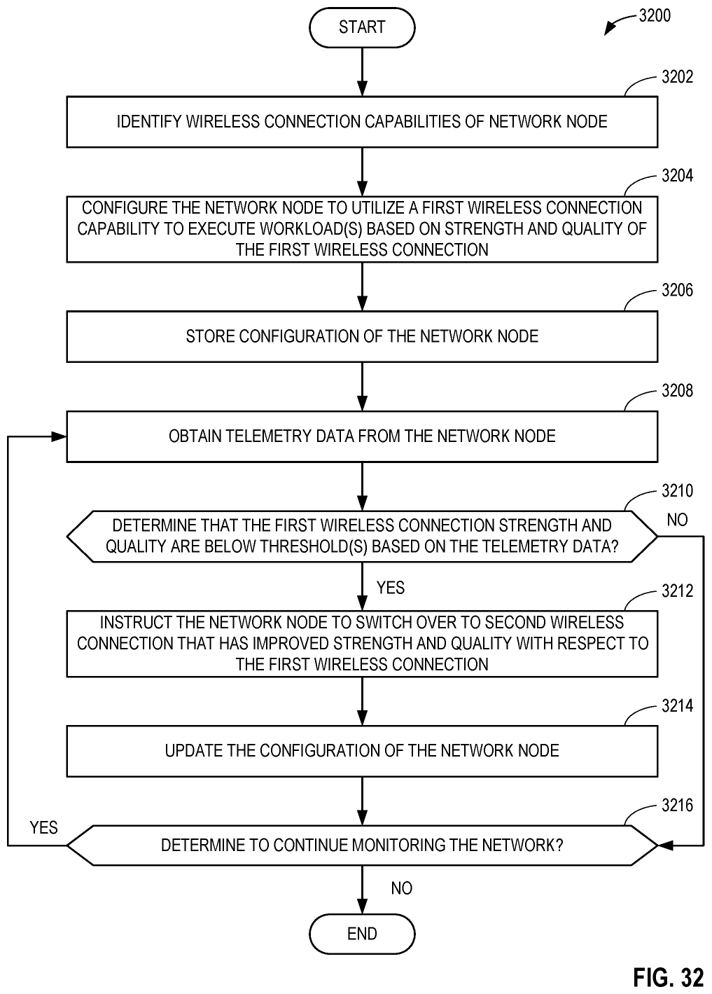

In some examples, a network of DDN edge nodes may integrate additional DDN nodes into a network and/or transform an edge node (e.g., a “dumb” node) in the network into a DDN node (e.g., a “smart” node) with DDN circuitry and/or an artificial intelligence engine. For example, an edge compute device may be updated to include a capability to configure compute resources based on a resource demand. In some examples, programmable circuitry is to configure compute resources of an edge compute device responsive to an input from another edge compute devices, the input based on a resource demand. For example, a network of DDN nodes may include a set of fluid interconnected (e.g., mobile and/or fixed) generic edge nodes that are temporarily customized for specific workloads, reprogramming one or more of the edge node(s) to function as DDN edge node(s) for a specified period of time. In some examples, the DDN control circuitry 240 may execute instructions such as will be described in FIGS. 32-35C below.

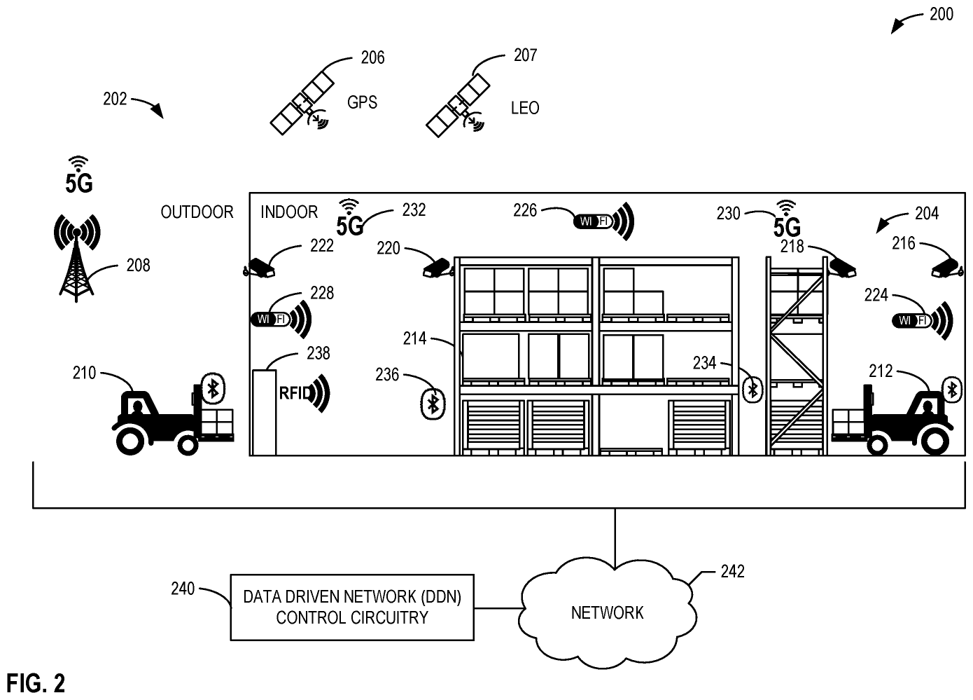

FIG. 2 is an illustration of an example data driven network (DDN) system 200 including an example outdoor environment 202 and an example indoor environment 204. The outdoor environment 202 includes an example GPS satellite 206, an example LEO satellite 207, an example 5G cellular system 208, and an example first industrial machine 210. In some examples, the 5G cellular system 208 may be implemented by one or more radio antennas, radio towers, RAN devices, distributed units (DUs), control units (CUs), etc. Additionally or alternatively, the outdoor environment 202 may include any other type of satellite (e.g., a low-earth orbit (LEO) satellite), a GSM network, an LTE network, a 6G network, etc. The first industrial machine 210 is a connection technology enabled forklift. For example, the first industrial machine 210 may be a Bluetooth-enabled forklift. Additionally or alternatively, the first industrial machine 210 may be enabled to connect to other device(s) via any other connection technology (e.g., 5G/6G, Wi-Fi, etc.).

The indoor environment 204 of the illustrated example includes an example second industrial machine 212, example storage containers (e.g., boxes, crates, etc.) 214, example video cameras 216, 218, 220, 222 (e.g., surveillance cameras), example Wi-Fi devices (e.g., Wi-Fi beacons, Wi-Fi enabled sensors, routers, modems, gateways, access points, hotspots, etc.) 224, 226, 228, example 5G devices (e.g., 5G beacons, 5G enabled sensors, access points, hotspots, etc.) 230, 232, example Bluetooth devices (e.g., Bluetooth beacons, Bluetooth enabled sensors, access points, hotspots, etc.) 234, 236, and an example radio-frequency identification (RFID) system 238. In the illustrated example, the second industrial machine 212 is a connection technology enabled forklift. For example, the second industrial machine 212 may be a Bluetooth-enabled forklift. Additionally or alternatively, the second industrial machine 212 may be enabled to connect to other device(s) via any other connection technology (e.g., 5G/6G, Wi-Fi, etc.).

In some examples, one(s) of the storage containers 214 may be enabled with connection technology. For example, one(s) of the storage containers 214 may be affixed with, coupled to, and/or otherwise include an RFID device (e.g., an RFID tag), an antenna (e.g., a Bluetooth antenna, a Wi-Fi antenna, a 5G/6G antenna, etc.), a transmitter (e.g., a Bluetooth transmitter, a Wi-Fi transmitter, a 5G/6G transmitter, etc.), etc., and/or any combination thereof. In some examples, the RFID system 238 may be implemented by one or more radio transponders, receivers, and/or transmitters.

In some examples, data producer(s) (e.g., sensor(s)) may be clustered. For example, one(s) of the video cameras 216, 218, 220, 222 may be coupled to one(s) of the industrial machines 210, 212. In some examples, other sensors, such as audio sensors, may be coupled to the industrial machines 210, 212, one(s) of the storage container(s) 214, etc. In the illustrated example, data driven network (DDN) control circuitry 240 can obtain audio-related data, such as Delivered Audio Quality (DAQ) data, amplitude data, frequency data, etc., and/or combination(s) thereof, from the audio sensor(s) from which location data may be determined. In some examples, the data producer(s) of the illustrated example are not singular in function and may be used in connection with one(s) of the other data producer(s). For example, the video cameras 216, 218, 220, 222 may be used to identify object(s) in the indoor environment 204, provide input(s) to an autonomous driving system of the industrial machines 210, 212, execute anomaly detection, etc.

In the illustrated example, one(s) of the second industrial machine 212, the storage containers 214, the video cameras 216, 218, 220, 222, the Wi-Fi devices 224, 226, 228, the 5G devices 230, 232, the Bluetooth devices 234, 236, and/or the RFID system 238 may be in communication with one(s) of each other via one or more connection technologies (e.g., Bluetooth, Wi-Fi, RFID, 5G/6G, etc.). In some examples, one(s) of the second industrial machine 212, the storage containers 214, the video cameras 216, 218, 220, 222, the Wi-Fi devices 224, 226, 228, the 5G devices 230, 232, the Bluetooth devices 234, 236, and/or the RFID system 238 may be in communication with the DDN control circuitry 240 via an example network 242. In some examples, the network 242 of the illustrated example of FIG. 2 may be the Internet. In some examples, the network 242 of the illustrated example of FIG. 2 may be implemented using any suitable wired and/or wireless network(s) including, for example, one or more data buses, one or more Local Area Networks (LANs), one or more wireless LANs, one or more cellular networks, one or more private networks, one or more public networks, one or more optical networks, one or more satellite networks, etc.

In the illustrated example of FIG. 2, the outdoor environment 202, the indoor environment 204, and/or, more generally, the DDN system 200, may implement a smart warehouse (e.g., a smart commercial or industrial warehouse). For example, the outdoor environment 202, the indoor environment 204, and/or, more generally, the DDN system 200, may implement one(s) of the computational use cases 205 of FIG. 2, such as manufacturing, smart building, logistics, vehicle, and/or video computational use cases. In some examples, the smart warehouse of the illustrated example may include the first industrial machine 210 and/or the second industrial machine 212 moving one(s) of the storage containers 214 from location to location (e.g., from a first shelf to a second shelf, from the first shelf to a pallet, from the first shelf to a truck, etc.). In some examples, the first industrial machine 210 and/or the second industrial machine 212 may transport one(s) of the storage containers 214 between the indoor environment 204 and the outdoor environment 202.

Although only one instance of the DDN control circuitry 240 is depicted in the illustrated example, in some examples, more than one of the DDN control circuitry 240 may be utilized. For example, the DDN control circuitry 240 depicted in FIG. 2 may be a first instance of the DDN control circuitry 240 associated with a first spatial relational space and the DDN system 200 may include a second instance of the DDN control circuitry 240 associated with a second spatial relational space (e.g., a different indoor environment, a different outdoor environment, etc.). In some examples, the first and second instances of the DDN control circuitry 240 may exchange and/or otherwise provide each other with multi-spectrum, multi-modal data that they have respectively obtained and/or processed. In some examples, the first and second instances of the DDN control circuitry 240 may merge data from the different spatial relational spaces, domains, etc., to generate a result, such as a location of an object desired to be tracked and/or otherwise located.

In some examples, the DDN control circuitry 240 may determine locations, positions, etc., of objects of the DDN system based on multi-spectrum, multi-modal data sources. In some examples, the DDN control circuitry 240 may determine a strength and/or quality of network connection(s) associated with an electronic device of the DDN system 200 based on multi-spectrum, multi-modal data sources. For example, the DDN control circuitry 240 may obtain satellite signal data from the GPS satellite 206, satellite signal data from the LEO satellite 207, 5G signal data from the 5G cellular system 208, Bluetooth signal data from the first industrial machine 210 and/or the second industrial machine 212, Wi-Fi signal data from one(s) of the video cameras 216, 218, 220, 222, RFID signal data from the RFID system 238 (e.g., a strength of an RFID beacon of the RFID system 238). In some examples, the DDN control circuitry 240 may execute one or more machine learning models using the multi-spectrum, multi-modal data as data inputs to generate data outputs. In some examples, the outputs may include determinations of whether device(s) in the outdoor environment 202, the indoor environment 204, and/or, more generally, the DDN system 200, is/are to switch from a first network (or first mode of communication) to a second network (or second mode of communication) based on the multi-spectrum, multi-modal data.

Advantageously, the DDN control circuitry 240 may determine whether electronic device(s) is/are to switch network connections in the DDN system 200 based on homogeneous and/or heterogeneous data sources. For example, the DDN control circuitry 240 may determine QoS parameters associated with network connections that the first industrial machine 210 is capable to utilize based on homogeneous data sources. In some examples, the DDN control circuitry 240 may determine QoS parameters associated with a 5G cellular connection of the first industrial machine 210 based on data from one or more 5G radio hardware units (RUs), one or more 5G Distributed Units (DUs), one or more 5G central units (CUs), etc. In some examples, the DDN control circuitry 240 may determine QoS parameters associated with the 5G cellular connection of the first industrial machine 210 and a Wi-Fi connection of the first industrial machine 210 based on heterogeneous data sources. For example, the DDN control circuitry 240 may determine the QoS parameters associated with the 5G cellular connection based on data from the one or more 5G RUs and determine the QoS parameters associated with the Wi-Fi connection from one or more Wi-Fi access points. In some examples, the DDN control circuitry 240 may determine whether a device is to switch network connections of the first industrial machine 210 based on homogeneous and heterogeneous data sources. For example, the DDN control circuitry 240 may determine to switch from a 5G cellular connection to a Wi-Fi connection based on data from (i) the 5G cellular system 208 and/or (ii) the first Wi-Fi device 224 and/or the third Wi-Fi device 228.

In some examples, the DDN control circuitry 240 executes and/or instantiates one or more artificial intelligence (AI) models to determine whether to cause an electronic device to utilize different network connections for communication (e.g., wireless communication). AI, including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the DDN control circuitry 240 may train the machine learning model(s) with data to recognize patterns and/or associations and follow such patterns and/or associations when processing input data such that other input(s) result in output(s) consistent with the recognized patterns and/or associations.

Many different types of machine learning models and/or machine learning architectures exist. In some examples, the DDN control circuitry 240 generates the machine learning model(s) as neural network model(s). The DDN control circuitry 240 may use a neural network model to execute an AI/ML workload, which, in some examples, may be executed using one or more hardware accelerators. In general, machine learning models/architectures that are suitable to use in the example approaches disclosed herein include recurrent neural networks. However, other types of machine learning models could additionally or alternatively be used such as supervised learning artificial neural network (ANN) models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine or network, Naive Bayes, etc. In some examples, the DDN control circuitry 240 may compile and/or otherwise generate one(s) of the machine learning model(s) as lightweight machine learning models.

In general, implementing an machine learning/artificial intelligence (ML/AI) system involves two phases, a learning/training phase and an inference phase. In the learning/training phase, the DDN control circuitry 240 uses a training algorithm to train the machine learning model(s) to operate in accordance with patterns and/or associations based on, for example, training data. In general, the machine learning model(s) include(s) internal parameters (e.g., configuration register data) that guide how input data is transformed into output data, such as through a series of nodes and connections within the machine learning model(s) to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the DDN control circuitry 240 may invoke supervised training to use inputs and corresponding expected (e.g., labeled) outputs to select parameters (e.g., by iterating over combinations of select parameters) for the machine learning model(s) that reduce model error. As used herein, “labeling” refers to an expected output of the machine learning model (e.g., a classification, an expected output value, etc.). Alternatively, the DDN control circuitry 240 may invoke unsupervised training (e.g., used in deep learning, a subset of machine learning, etc.) that involves inferring patterns from inputs to select parameters for the machine learning model(s) (e.g., without the benefit of expected (e.g., labeled) outputs).

In some examples, the DDN control circuitry 240 trains the machine learning model(s) using unsupervised clustering of operating observables. For example, the operating observables may include a vendor identifier, an Internet Protocol (IP) address, a media access control (MAC) address, a serial number, a certificate, etc., of a device (e.g., an enterprise device, an IoT device, etc.), Sounding Reference Signal (SRS) parameters, etc. However, the DDN control circuitry 240 may additionally or alternatively use any other training algorithm such as stochastic gradient descent, simulated annealing, particle swarm optimization, evolution algorithms, genetic algorithms, nonlinear conjugate gradient, etc.

In some examples, the DDN control circuitry 240 may train the machine learning model(s) until the level of error is no longer reducing. In some examples, the DDN control circuitry 240 may train the machine learning model(s) locally on the DDN control circuitry 240 and/or remotely at an external computing system communicatively coupled to the network 242. In some examples, the DDN control circuitry 240 trains the machine learning model(s) using hyperparameters that control how the learning is performed (e.g., a learning rate, a number of layers to be used in the machine learning model, etc.). In some examples, the DDN control circuitry 240 may use hyperparameters that control model performance and training speed such as the learning rate and regularization parameter(s). The DDN control circuitry 240 may select such hyperparameters by, for example, trial and error to reach an optimal model performance. In some examples, the DDN control circuitry 240 utilizes Bayesian hyperparameter optimization to determine an optimal and/or otherwise improved or more efficient network architecture to avoid model overfitting and improve the overall applicability of the machine learning model(s). Alternatively, the DDN control circuitry 240 may use any other type of optimization. In some examples, the DDN control circuitry 240 may perform re-training. The DDN control circuitry 240 may execute such re-training in response to override(s) by a user of the DDN control circuitry 240, a receipt of new training data, etc.

In some examples, the DDN control circuitry 240 facilitates the training of the machine learning model(s) using training data. In some examples, the DDN control circuitry 240 utilizes training data that originates from locally generated data, such as 5G Layer 1 (L1) data, IP addresses, MAC addresses, radio identifiers, SRS parameters, etc. In some examples, the DDN control circuitry 240 utilizes training data that originates from externally generated data. For example, the DDN control circuitry 240 may utilize L1 data from any data source (e.g., a camera, a RAN system, a satellite, etc.). In some examples, the L1 data may correspond to L1 data of an OSI model. In some examples, the L1 data of an OSI model may correspond to the physical layer of the OSI model, L2 data of the OSI model may correspond to the data link layer, L3 data of the OSI model may correspond to the network layer, and so forth. In some examples, the L1 data may correspond to the transmitted raw bit stream over a physical medium (e.g., a wired line physical structure such as coax or fiber, an antenna, a receiver, a transmitter, a transceiver, etc.). In some examples, the L1 data may be implemented by signals, binary transmission, etc. In some examples, the L2 data may correspond to physical addressing of the data, which may include Ethernet data, MAC addresses, logical link control (LLC) data, etc.

In some examples where supervised training is used, the DDN control circuitry 240 may label the training data (e.g., label training data or portion(s) thereof as object identification data, location data, etc.). Labeling is applied to the training data by a user manually or by an automated data pre-processing system. In some examples, the DDN control circuitry 240 may pre-process the training data using, for example, an interface (e.g., network interface circuitry) to extract and/or otherwise identify data of interest and discard data not of interest to improve computational efficiency. In some examples, the DDN control circuitry 240 sub-divides the training data into a first portion of data for training the machine learning model(s), and a second portion of data for validating the machine learning model(s).

Once training is complete, the DDN control circuitry 240 may deploy the machine learning model(s) for use as an executable construct that processes an input and provides an output based on the network of nodes and connections defined in the machine learning model(s). The DDN control circuitry 240 may store the machine learning model(s) in a datastore that may be accessed by the DDN control circuitry 240, a cloud repository, etc. In some examples, the DDN control circuitry 240 may transmit the machine learning model(s) to external computing system(s) via the network 242. In some examples, in response to transmitting the machine learning model(s) to the external computing system(s), the external computing system(s) may execute the machine learning model(s) to execute AI/ML workloads with at least one of improved efficiency or performance to achieve improved object tracking, location detection, etc., and/or a combination thereof.

Once trained, the deployed one(s) of the machine learning model(s) may be operated in an inference phase to process data. In the inference phase, data to be analyzed (e.g., live data) is input to the machine learning model(s), and the machine learning model(s) execute(s) to create an output. This inference phase can be thought of as the AI “thinking” to generate the output based on what it learned from the training (e.g., by executing the machine learning model(s) to apply the learned patterns and/or associations to the live data). In some examples, input data undergoes pre-processing before being used as an input to the machine learning model(s). Moreover, in some examples, the output data may undergo post-processing after it is generated by the machine learning model(s) to transform the output into a useful result (e.g., a display of data, a detection and/or identification of an object, a location determination of an object, an instruction to be executed by a machine, etc.).

In some examples, output of the deployed one(s) of the machine learning model(s) may be captured and provided as feedback. By analyzing the feedback, an accuracy of the deployed one(s) of the machine learning model(s) can be determined. If the feedback indicates that the accuracy of the deployed model is less than a threshold or other criterion, training of an updated model can be triggered using the feedback and an updated training data set, hyperparameters, etc., to generate an updated, deployed model.

As used herein, data is information in any form that may be ingested, processed, interpreted and/or otherwise manipulated by processor circuitry to produce a result. The produced result may itself be data. As used herein, a model is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data. As used herein “threshold” is expressed as data such as a numerical value represented in any form, that may be used by processor circuitry as a reference for a comparison operation.

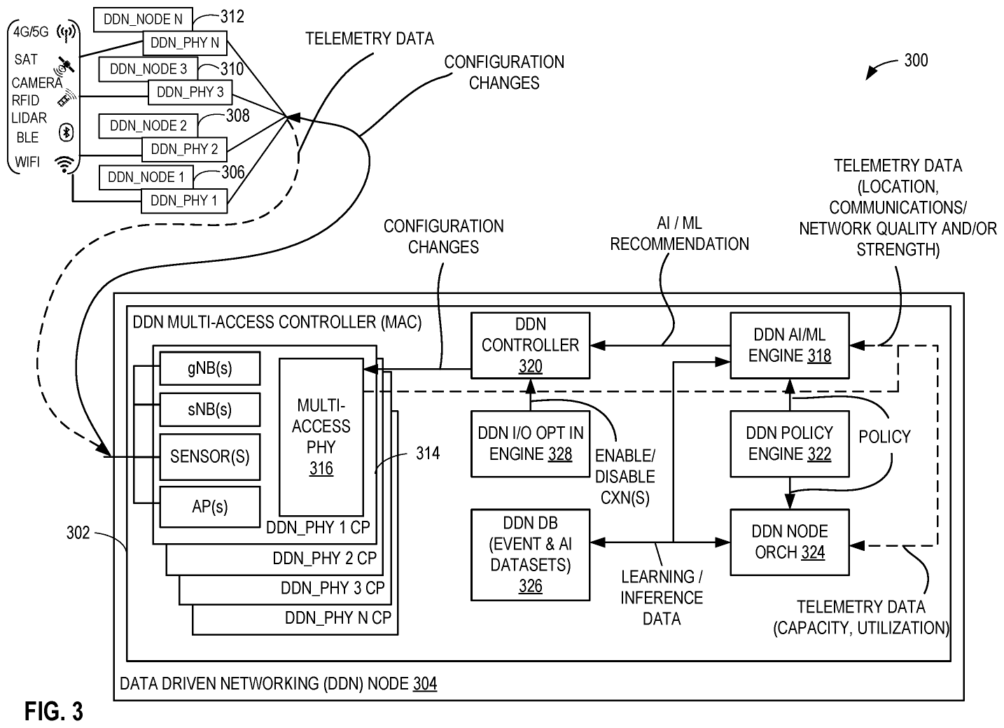

FIG. 3 depicts an example DDN system 300 including an example DDN multi-access controller (DDNMAC) 302. In some examples, the DDNMAC 302 can implement the DDN control circuitry 240 of FIG. 2. In the illustrated example, a first example DDN node 304 includes, instantiates, and/or otherwise implements the DDNMAC 302. Further depicted in the illustrated example are a second example DDN node (DDN_NODE 1) 306, a third example DDN node (DDN_NODE 2) 308, a fourth example DDN node (DDN_NODE 3) 310, and a fifth example DDN node (DDN_NODE N) 312.

In some examples, one(s) of the DDN nodes 304, 306, 308, 310, 312 is/are logical entities representative of hardware (e.g., an ASIC, register-transfer level (RTL) hardware, etc.), software, and/or firmware. For example, one(s) of the DDN nodes 304, 306, 308, 310, 312 can be implemented using hardware (e.g., processor circuitry, memory, interface circuitry, accelerators, etc.), software (e.g., driver(s), an operating system (OS), application programming interface(s) (API(s)), etc.), and/or firmware.

In some examples, one(s) of the DDN nodes 304, 306, 308, 310, 312 is/are physical device(s). For example, one(s) of the DDN nodes 304, 306, 308, 310, 312 can be a server (e.g., a blade server, an edge server, a radio access network (RAN) server, etc.), a personal computer, a workstation, a self-learning machine (e.g., a neural network), a mobile device (e.g., a cell phone, a smart phone, a tablet such as an iPad™), a personal digital assistant (PDA), an Internet appliance, a terrestrial or non-terrestrial vehicle (e.g., an autonomous vehicle, satellite, aircraft, boat, etc.), industrial equipment, a gaming console, a headset (e.g., an augmented reality (AR) headset, a virtual reality (VR) headset, etc.) or other wearable device, or any other type of computing or electronic device. In some examples, one(s) of the DDN nodes 304, 306, 308, 310, 312 can be a sensor (e.g., an electronic device capable of generating analog measurements and converting the analog measurements data into digital data). For example, one(s) of the DDN nodes 304, 306, 308, 310, 312 can be a sensor such as an antenna, a camera (e.g., a still-image camera, a video camera, an infrared camera, etc.), a laser (e.g., a light detection and ranging (LIDAR) sensor), a radiofrequency identification (RFID) reader, an environment sensor (e.g., a humidity sensor, a light sensor, a temperature sensor, a wind sensor, etc.), etc., or any other type of sensor. In some examples, one(s) of the DDN nodes 304, 306, 308, 310, 312 is/are logical entities representative of hardware, software, and/or firmware that is in communication with sensor(s). For example, one(s) of the DDN nodes 304, 306, 308, 310, 312 can be an edge server, a network interface, an Infrastructure Processing Unit (IPU), etc., that receives data from a sensor, such as an antenna.

In the illustrated example of FIG. 3, the second through fifth DDN nodes 306, 308, 310, 312 each have one or more network interfaces identified by DDN_PHY 1, DDN_PHY 2, etc. For example, the second DDN node 306 can have one or more network interfaces represented by DDN_PHY 1. In some examples, the one or more network interfaces can be a cellular connection (e.g., 4G, 5G, etc., cellular connection), a satellite connection, a sensor interface or connection (e.g., an interface to a camera, RFID terminal, LIDAR system, a peer-to-peer (P2P) connection, etc.), a Bluetooth connection (e.g., a Bluetooth Low Energy (BLE) connection, a Wi-Fi connection, etc., and/or any combination(s) thereof. For example, the second node 306 can have multiple network interfaces instantiated by physical interface circuitry. In some examples, the second node 306 can have first interface circuitry to effectuate 4G/5G cellular connectivity, second interface circuitry to effectuate a satellite connectivity, etc. In some examples, the first interface circuitry can effectuate different types of connectivity, such as 4G/5G cellular connectivity and Wi-Fi connectivity.

In the illustrated example of FIG. 3, one(s) of the DDN nodes 304, 306, 308, 310, 312 include the DDNMAC 302, or portion(s) thereof. For example, the first DDN node 304 can include, instantiate, and/or otherwise implement the DDNMAC 302, or portion(s) thereof. In the illustrated example, the DDNMAC 302 includes example control planes 314 for one(s) of the DDN nodes 306, 308, 310, 312. The control planes 314 include a first control plane (CP) for the second DDN node 306, which is identified by DDN_PHY 1 CP. The control planes 314 include a second control plane for the third DDN node 308, which is identified by DDN_PHY 2 CP. The control planes 314 include a third control plane for the fourth DDN node 310, which is identified by DDN_PHY 3 CP. The control planes 314 include a fourth control plane for the fifth DDN node 312, which is identified by DDN_PHY N CP.

In some examples, the control planes 314 are implemented by hardware, software, and/or firmware. For example, the control planes 314 can be implemented by (i) network interface circuitry, (ii) firmware associated with the network interface circuitry, and/or (iii) a software application. For example, the software application can be executed to execute a workload based on digital data that is converted from analog data, which can be received by the network interface circuitry. In the illustrated example, the control planes 314 are configured to receive data associated with gNodeB(s) (gNB(s)), satellite NodeBs (sNB(s)), sensor(s) (e.g., active sensor(s), passive sensor(s), etc.), and/or access point(s) (AP(s)). For example, the control planes 314 can be implemented with network interface circuitry to receive data from gNB(s) and/or associated firmware and/or software to process the data. Additionally and/or alternatively, the control planes 314 can be configured to receive data from any other source, such as a BLE device, an Ethernet device, etc. In the illustrated example, the control planes 314 can be instantiated to receive data from devices, extract parameters of interest from the data, and provide the parameters to other portion(s) of the DDNMAC 302. For example, the control planes 314 include an example multi-access PHY 316 to process the data from the data sources (e.g., the gNB(s), the sNB(s), etc.) in a centralized location.

In the illustrated example of FIG. 3, the DDNMAC 302 includes an example DDN AI/ML engine 318, an example DDN controller 320, an example DDN policy engine 322, an example DDN node orchestrator 324 (identified by DDN NODE ORCH), an example DDN database 326 (identified by DDN DB), and an example DDN I/O opt in engine 328.

In the illustrated example, the DDNMAC 302 includes the DDN AI/ML engine 318 to output AI/ML recommendations based on telemetry data. For example, the DDN AI/ML engine 318 can provide telemetry data to one or more AI/ML models as model inputs to generate the AI/ML recommendations as model outputs. In some examples, the telemetry data is from the second through fifth DDN nodes 306, 308, 310, 312. For example, the telemetry data can include location data, communications and/or network quality data, and/or communications and/or network strength data. In some examples, network strength could be measured in packets retransmitted, packets dropped, throughput limits, throughput latency, jitter limits, etc., and/or any combination(s) thereof. In some examples, the AI/ML recommendation can include a recommendation, a request, a command, an instruction, etc., to cause one(s) of the second through fifth nodes 306, 308, 310, 312 to switch from a first network connection to a second network connection because the second network connection can have improved communications/network quality and/or strength with respect to the first network connection. In some examples, the DDN AI/ML engine 318 implements a decision tree that includes received signal strength indicator (RSSI) data, channel quality index (CQI) data, frequency utilization data, band utilization data, utilization load data of channel(s) for active connection(s), MIMO rank order, etc., and/or any combination(s) thereof.

In the illustrated example, the DDNMAC 302 includes the DDN controller 320 to cause one(s) of the second through fifth DDN nodes 306, 308, 310, 312 to change network connections based on the AI/ML recommendation. For example, the DDN controller 320 can determine that the AI/ML recommendation is indicative of recommending the second DDN node 306 to switch from a 5G cellular connection to a Wi-Fi connection to facilitate execution of one or more applications (e.g., a teleconference software application, a streaming media application, etc.). In some examples, the DDN controller 320 can generate a command in a data format that the second DDN node 306 is capable of receiving. For example, the DDN controller 320 can determine that the second DDN node 306 is using a 5G cellular connection and thereby the DDN controller 320 can transmit a command to the second DDN node 306 via a 5G cellular connection to have the second DDN node 306 switch from a 5G cellular connection to a Wi-Fi connection.

In the illustrated example, the DDNMAC 302 includes the DDN policy engine 322 to generate, modify, and/or maintain policies associated with one(s) of the DDN nodes 306, 308, 310, 312. In some examples, the policy can be a service level agreement (SLA). In some examples, the DDN policy engine 322 can receive data associated with the second DDN node 306. In some examples, the data can include types of network connections that the second DDN node 306 is capable of utilizing. In some examples, the DDN policy engine 322 can generate a policy (e.g., a network connection policy) corresponding to the second DDN node 306 based on the data. In some examples, the DDN policy engine 322 can modify the policy based on new or updated data from the second DDN node 306.

In the illustrated example, the DDNMAC 302 includes the DDN node orchestrator 324, which instantiates a DDN node (e.g., the first DDN edge server 104 of FIG. 1, the second DDN edge server 106 of FIG. 1, the nodes 306, 308, 310, 312 of FIG. 3, etc.). For example, the DDN node orchestrator 324 can instantiate a DDN node based on a location of the DDN node, which can be based on communication link quality and/or strength, environmental conditions, etc. In some examples, the DDN node orchestrator 324 can identify changes that can be made in connection with one(s) of the second through fifth nodes 306, 308, 310, 312. In some examples, the DDN node orchestrator 324 can obtain a policy from the DDN policy engine 322 that corresponds to the second DDN node 306. The DDN node orchestrator 324 can receive telemetry data associated with the second DDN node 306. The DDN node orchestrator 324 can determine that if the second DDN node 306 is using a 5G cellular connection based on the telemetry data, then based on an inspection of the policy, the DDN node orchestrator 324 can determine that the second DDN node 306 can transition to a different network connection, such as Wi-Fi. In some examples, the DDN node orchestrator 324 can provide the potential different network connections to the DDN AI/ML engine 318 so that the DDN AI/ML engine 318 can analyze the potential different network connections (e.g., to avoid wasting resources analyzing infeasible network connections).

In the illustrated example, the DDNMAC 302 includes the DDN database 326 to store event and/or AI datasets. For example, the DDN database 326 can store AI training or learning data and output the AI training or learning data to the DDN AI/ML engine 318. In some examples, the DDN database 326 can store inference data output from the DDN AI/ML engine 318. In some examples, the DDN database 326 can be implemented using one or more datastores. For example, the one or more datastores can be memory, one or more mass storage devices, etc., and/or any combination(s) thereof.

In the illustrated example, the DDNMAC 302 includes the DDN I/O opt in engine 328 to enable or disable network connections based on opt in selections from a user. For example, a user associated with the second DDN node 306 can determine to opt into using a 5G cellular connection and a Wi-Fi connection and to opt out of using a satellite connection and/or providing sensor data. In some examples, the DDN I/O opt in engine 328 can instruct the DDN controller 320 to enable or disable a network connection (identified by CXN(S)) associated with a node. For example, in response to a determination that a user associated with the second DDN node 306 opted out of using 5G cellular connection, the DDN I/O opt in engine 328 can instruct the DDN controller 320 to switch the second DDN node 306 from using a 5G cellular connection to a different cellular connection based on at least one of the user I/O opt in selections or the policy associated with the second DDN node 306. In some examples, the DDN I/O opt in engine 328 can obtain the opt in information from one(s) of the second through fifth nodes 306, 308, 310, 312. In some examples, the DDN I/O opt in engine 328 can obtain the opt in information from any other source, such as the DDN policy engine 322, the DDN database 326, etc.

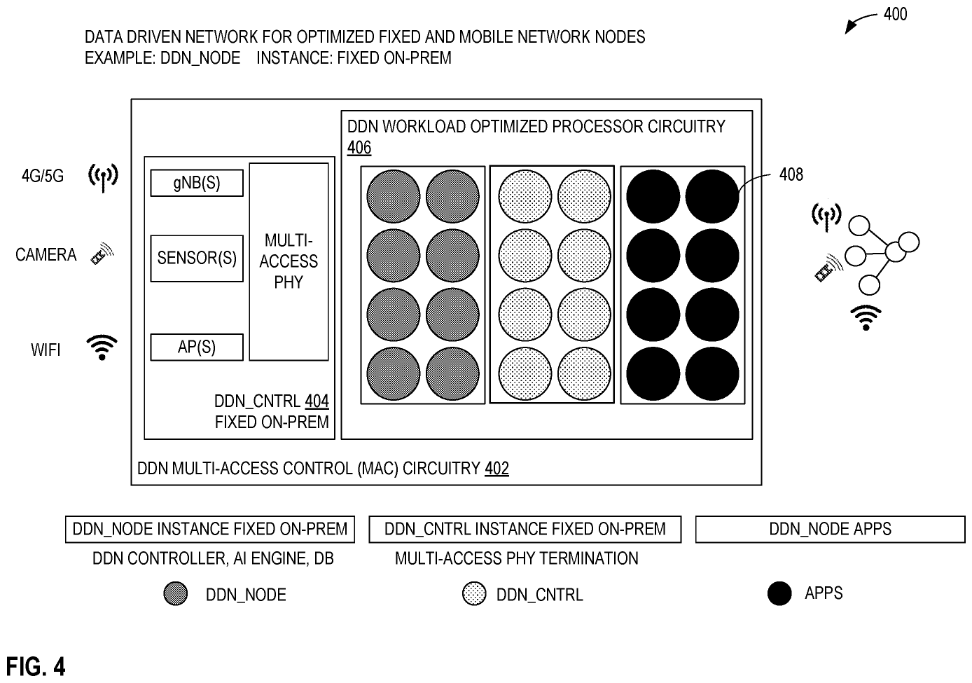

FIG. 4 depicts an example DDN system 400 including example DDN multi-access control (MAC) circuitry 402. In some examples, the DDNMAC circuitry 402 can implement the DDN control circuitry 240 of FIG. 2 and/or the DDNMAC 302 of FIG. 3. The DDNMAC circuitry 402 includes an example control plane 404 (identified by DDN_CNTRL) that can be implemented using hardware, firmware, and/or software. For example, the control plane 404 can receive data from gNB(s), sensor(s) (e.g., active sensor(s), passive sensor(s), etc.), access point(s) (AP(s)), etc., and/or any combination(s) thereof. In this example, the control plane 404 is a fixed on-premises (ON-PREM) control plane. For example, the DDNMAC circuitry 402 can be executed and/or instantiated to effectuate DDN in a private network.

In the illustrated example, the DDNMAC circuitry 402 includes DDN workload optimized processor circuitry 406 in a first state. For example, the DDN workload optimized processor circuitry 406 is multi-core processor circuitry that includes a plurality of example compute cores 408. In the illustrated example, first ones of the compute cores 408 execute workloads associated with the control plane 404 receiving and/or transmitting data to the gNB(s), the sensor(s), the AP(s), etc. For example, the first ones of the compute cores 408 can be configured to optimize and/or otherwise improve execution of the workloads by changing a core clock frequency, a type of instruction set to be utilized, etc. In the illustrated example, second ones of the compute cores 408 execute workloads associated with the control plane 404 controlling the multi-access PHY. For example, the second ones of the compute cores 408 can be configured to optimize and/or otherwise improve execution of the workloads by changing a core clock frequency, a type of instruction set to be utilized, etc. In the illustrated example, third ones of the compute cores 408 execute workloads associated with applications executed and/or instantiated by the DDNMAC circuitry 402. For example, the third ones of the compute cores 408 can be configured to optimize and/or otherwise improve execution of the workloads by changing a core clock frequency, a type of instruction set to be utilized, etc.

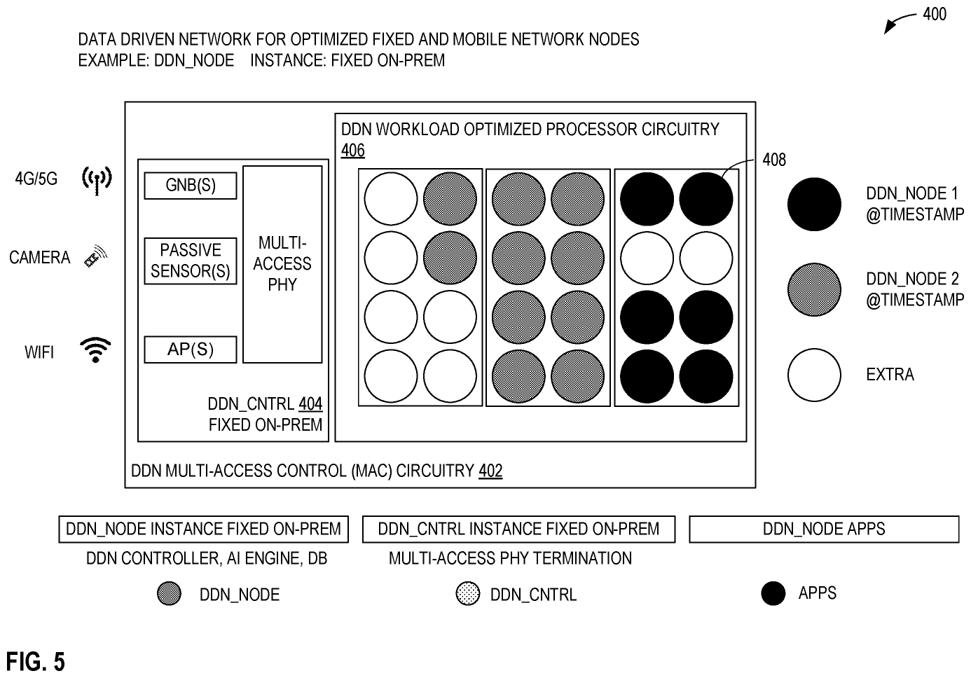

FIG. 5 depicts the DDNMAC circuitry 402 in a second state. For example, first ones of the compute cores 408 are configured at a first timestamp to execute first workloads associated with the second DDN node 306 of FIG. 3. Second ones of the compute cores 408 are configured at the first timestamp to execute second workloads associated with the third DDN node 308 of FIG. 3. Third ones of the compute cores 408 may be unutilized. Advantageously, one(s) of the compute cores 408 can be statically or dynamically configured to optimize and/or otherwise improve execution of workloads associated with different node(s).

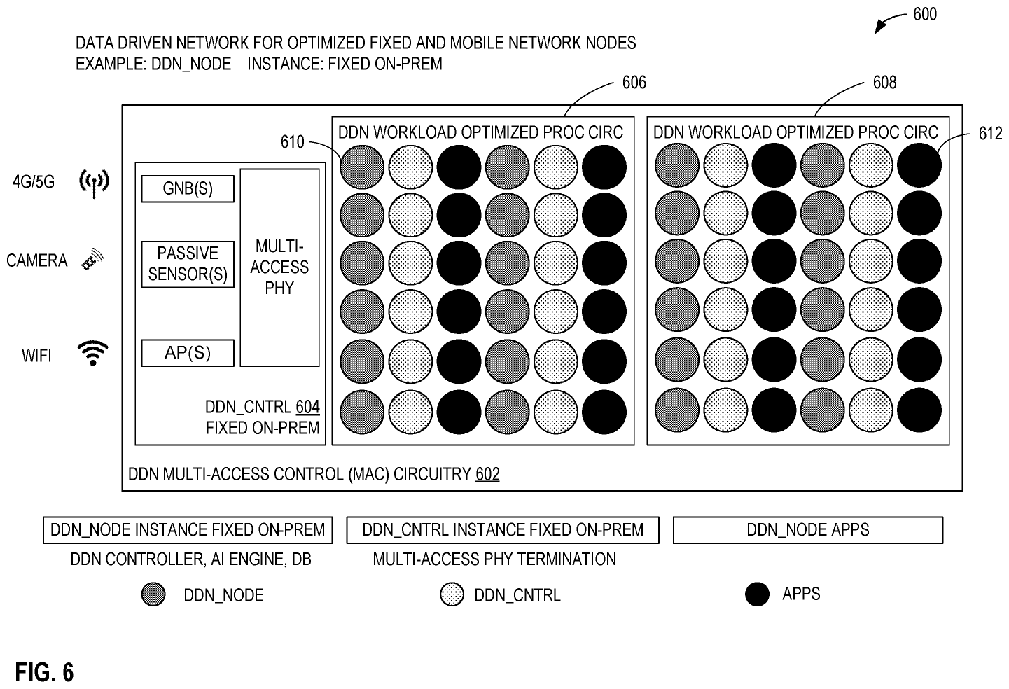

FIG. 6 depicts an example DDN system 600 including example DDN multi-access control (MAC) circuitry 602. In some examples, the DDNMAC circuitry 602 can implement the DDN control circuitry 240 of FIG. 2 and/or the DDNMAC 302 of FIG. 3. The DDNMAC circuitry 602 includes an example control plane 604 (identified by DDN_CNTRL) that can be implemented using hardware, firmware, and/or software. For example, the control plane 604 can receive data from gNB(s), sensor(s) (e.g., active sensor(s), passive sensor(s), etc.), access point(s) (AP(s)), etc., and/or any combination(s) thereof. In this example, the control plane 604 is a fixed on-premises (ON-PREM) control plane. For example, the DDNMAC circuitry 602 can be executed and/or instantiated to effectuate DDN in a private network.

In the illustrated example, the DDNMAC circuitry 602 includes first example DDN workload optimized processor circuitry 606 and second example DDN workload optimized processor circuitry 608 in a first state. For example, the DDNMAC circuitry 602 can be dual-socket hardware. In the illustrated example, the first and second DDN workload optimized processor circuitry 606, 608 are multi-core processor circuitry that each include a plurality of example compute cores 610, 612. In the illustrated example, first ones of the first and second compute cores 610, 612 execute workloads associated with the control plane 604 receiving and/or transmitting data to the gNB(s), the sensor(s), the AP(s), etc. For example, the first and second ones of the compute cores 610, 612 can be configured to optimize and/or otherwise improve execution of the workloads by changing a core clock frequency, a type of instruction set to be utilized, etc. In the illustrated example, second ones of the first and second compute cores 610, 612 execute workloads associated with the control plane 604 controlling the multi-access PHY. For example, the second ones of the first and second compute cores 610, 612 can be configured to optimize and/or otherwise improve execution of the workloads by changing a core clock frequency, a type of instruction set to be utilized, etc. In the illustrated example, third ones of the first and second compute cores 610, 612 execute workloads associated with applications executed and/or instantiated by the DDNMAC circuitry 602. For example, the third ones of the first and second compute cores 610, 612 can be configured to optimize and/or otherwise improve execution of the workloads by changing a core clock frequency, a type of instruction set to be utilized, etc.

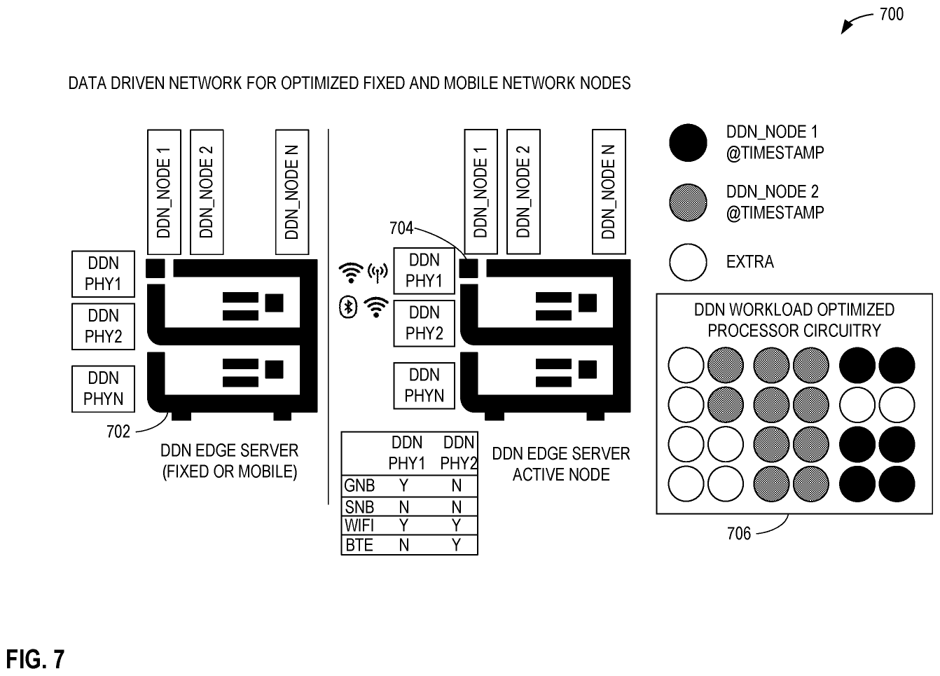

FIG. 7 depicts an example system 700 including an example first DDN edge server 702 and a second example DDN edge server 704. The first DDN edge server 702 handles and/or otherwise manages fixed or mobile DDN nodes. The second DDN edge server 704 handles and/or otherwise manages active nodes. For example, the first DDN edge server 702 and/or the second edge server 704 (e.g., DDN edge server) can include one or more instances of example DDN workload optimized processor circuitry 706.

In the illustrated example, DDN nodes can be fixed or mobile with fluid (dynamic) multi-access PHY connections and core capacity. In some examples, DDN nodes can support one or more (virtual) instances per edge server. In some examples, DDN nodes can be reconfigured based on real-time telemetry (e.g., Link Quality, Environmental Conditions, etc., and/or any combination(s) thereof) and AI/ML Engine direction at a physical location at a specific time. In the illustrated example, the second edge server 704 is hosting two active DDN nodes, which include a first node (DDN PHY1) that has Wi-Fi and 5G multi-access PHYs and 6 core Capacity; and a second node (DDN PHY2) with Wi-Fi and BLE multi-access PHYs and 8 core capacity.

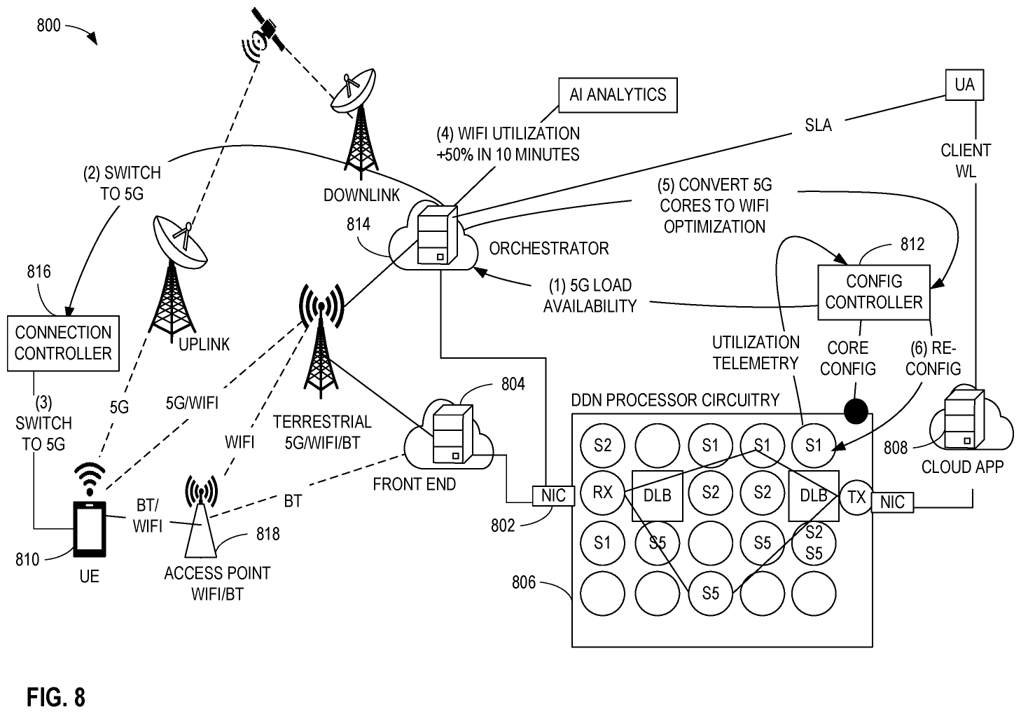

FIG. 8 depicts an example system 800 that may implement DDN techniques as described herein. In example operation, example network interface circuitry (NIC) 802 receives data via a wireless connection (e.g., a terrestrial 5G, Wi-Fi, Bluetooth (BT), etc., network connection) from example front end circuitry 804. Example DDN processor circuitry 806 receives the data (e.g., cleartext data, ciphertext data, etc.) from the NIC 802 at a receive (RX) core (e.g., a producer core). The RX core provides a point that references the data to a dynamic load balancer (DLB). The DLB can be implemented by hardware queue management circuitry. For example, the DLB can be configured based on a DDN policy. In some examples, the configuration can include a priority of a data packet (e.g., a queue identifier (QID)). The RX core can generate an event (e.g., an EVENT_DEV event) to enqueue the data with the DLB. The DLB can select consumer cores to process the data. For example, the DLB can select a first core to execute a workload. In some examples, the workload can include signal processing, compression, encryption, etc., workload(s). In response to the first core completing the workload, the first core can provide an indication to the DLB. In response to receiving the indication, the DLB can perform packet reordering and assembly (e.g., atomic reassembly or any other type of reassembly). The DLB can dequeue the reordered and/or reassembled data to a transmit (TX) core (e.g., a consumer core) to output the data into UE location flow. The transmit core can provide the data to the NIC 802 (or different NIC). The NIC 802 can provide and/or otherwise transmit the data to an example application 808. The application 808 can use and/or otherwise consume the data to effectuate a computing task. In this example, the application 808 is a cloud-based application. Additionally and/or alternatively, the application 808 may be any other type of application.

In some examples, a UE 810 that generates the data may have reduced communication and/or network quality when using Wi-Fi. In some examples, an example configuration controller 812 obtains telemetry data from the DDN processor circuitry 806. The telemetry data can include communication/network quality associated with the UE 810 Wi-Fi connection. The telemetry data can include communication capabilities of the UE 810, which can include the capability to use 5G cellular communication to transmit/receive data. The configuration controller 812 can determine that a possible solution is to cause the UE 810 to switch from Wi-Fi to 5G cellular. The configuration controller 812 can instruct an example orchestrator 814 that there is 5G network load availability to accommodate the UE 810. The orchestrator 814 can instruct an example connection controller 816 to direct the UE 810 to switch from Wi-Fi to 5G cellular. In response to the switch, the UE 810 can transmit data to an example access point 818 using Wi-Fi.

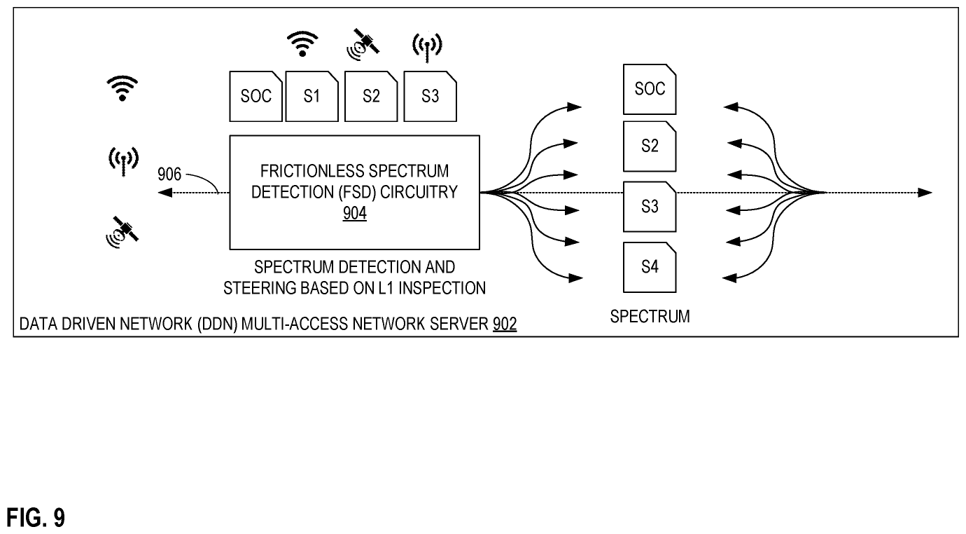

FIG. 9 depicts an example implementation of an example DDN server 902. In the illustrated example, the DDN server 902 is a DDN multi-access network server. In some examples, the DDN server 902 may implement homogeneous data processing (e.g., processing data from multiple data sources, such as a Wi-Fi, cellular, and/or satellite data source). The DDN server 902 of the illustrated example includes example frictionless spectrum detection (FSD) circuitry 904 that detects a spectrum of example incoming wireless data 906 generated by a Wi-Fi data source, a cellular data source, a satellite data source, etc. In some examples, the FSD circuitry 904 uses data driven conditioning to order spectrum feeds and policy techniques to correct for lost packets within a specific spectrum and/or out-of-order processing of multiple spectrums. In some examples, the FSD circuitry 904 detects a spectrum of the incoming wireless data 906 and steers the incoming wireless data 906 to one or more spectrums. In some examples, the FSD circuitry 904 uses conditioning including spectrum order correction (SOC) techniques to correct for lost packets within a specific spectrum and/or out-of-order processing of multiple spectrums. Advantageously, the FSD circuitry 904 can seamlessly and/or otherwise frictionlessly receive and/or transmit data using combination(s) of wireless communication techniques with reduced policy overhead.

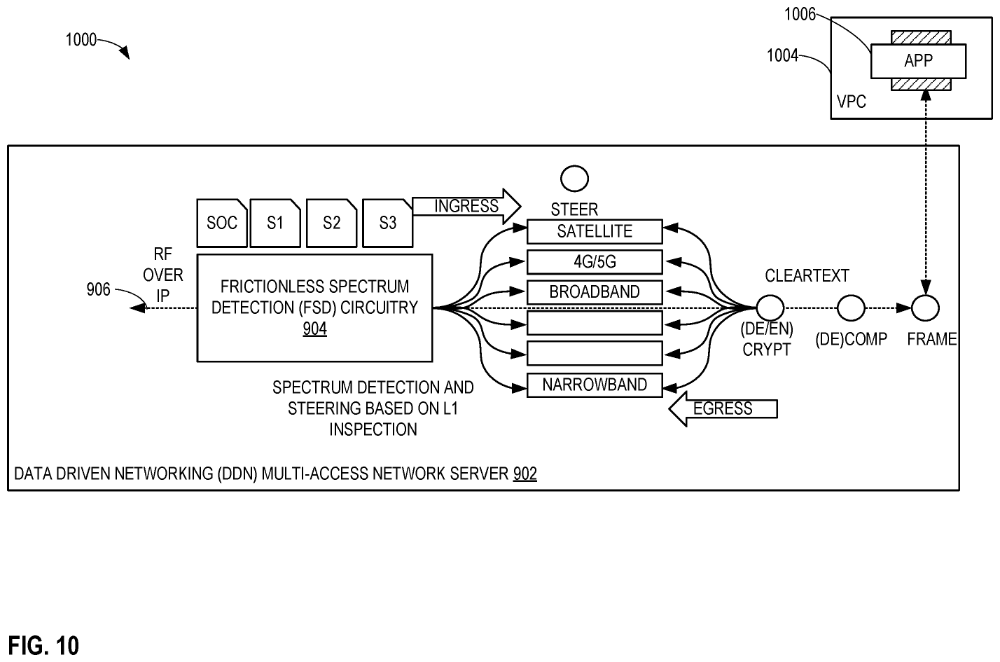

FIG. 10 depicts an example system 1000 including the DDN server 902, the FSD circuitry 904, and the incoming wireless data 906 of FIG. 9. In the illustrated example, the DDN server 1002 is a DDN multi-access network server that includes the FSD circuitry 904. In example operation, the FSD circuitry 904 obtains the incoming wireless data 906, which can be radiofrequency over internet protocol (RF/IP) data. In some examples, the RF/IP data can be received by way of one or more spectrums such as satellite, 4G, 5G, broadband, narrowband, etc. The FSD circuitry 904 can process the RF/IP data and output the RF/IP data along an ingress path. The DDN server 902 can execute workloads along the ingress path, which can include decryption, decompression, and frame workloads. The DDN server 902 can output the data to an example virtual private cloud (VPC) 1004, which executes and/or instantiates an example application 1006. The application 1006 can ingest, consume, and/or otherwise utilize the data from the DDN server 902 to output a result. The VPC 1004 can output the result to the DDN server 902 along an egress path, which can include frame, compression, and encryption workloads. The DDN server 902 can steer the data by way of one or more spectrums to output RF/IP data.

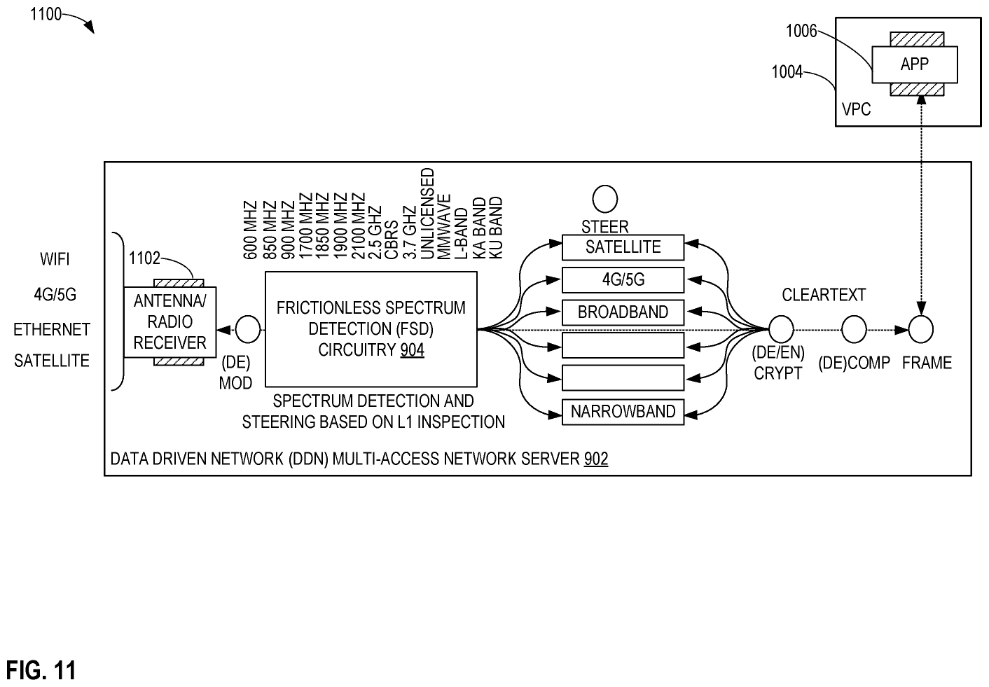

FIG. 11 is an example system 1100 including the DDN server 902 and the FSD circuitry 904 of FIG. 9, and the VPC 1004 and the application 1006 of FIG. 10. In example operation, the FSD circuitry 904 can obtain data (e.g., Wi-Fi data, 4G data, 5G data, Ethernet data, satellite data, etc.) via an example antenna and/or radio receiver 1102. The DDN circuitry 902 can demodulate the received data. The FSD circuitry 904 can execute spectrum detection and steering based on L1 data inspection. The application 1006 can receive the data and determine an action based on the data. For example, the application 1006 can determine to reroute subsequent data by way of a different spectrum, adjust security settings associated with the data, change a bandwidth associated with the data, etc., and/or any combination(s) thereof. Advantageously, the FSD circuitry 904 and/or, more generally, the DDN server 902 can handle substantial capacity (e.g., a substantial number of UEs) substantially simultaneously. Advantageously, the FSD circuitry 904 can handle UEs that have different needs and/or different locations.

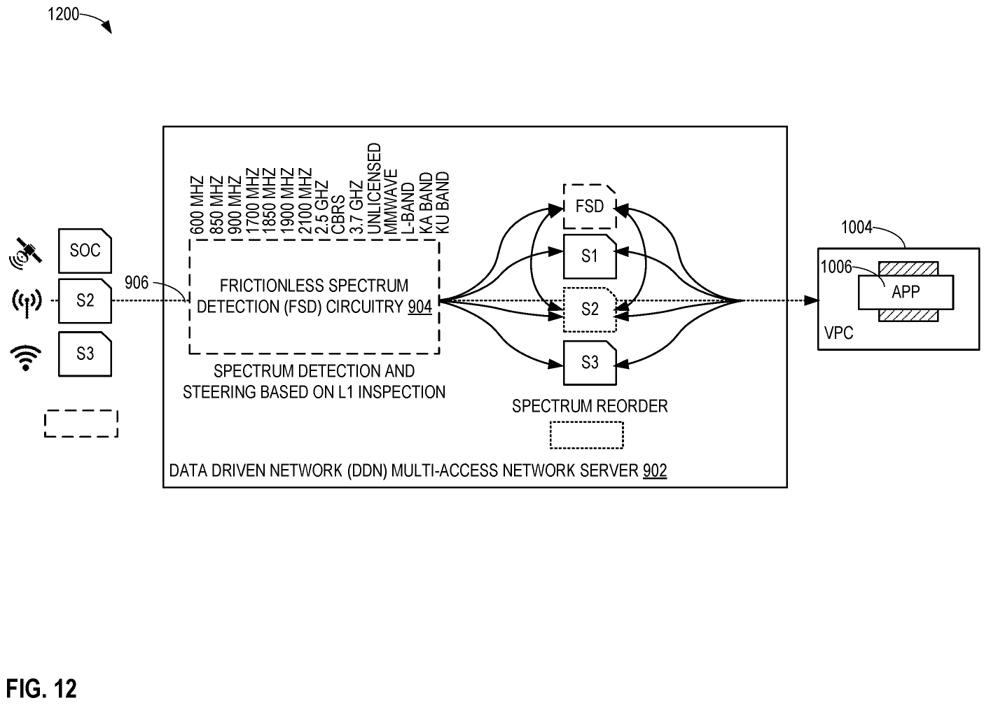

FIG. 12 is an example system 1200 including the DDN server 902 and the FSD circuitry 904 of FIG. 9, and the VPC 1004 and the application 1006 of FIG. 10. In example operation, in response to the detection of the spectrum of the incoming wireless data 906, the FSD circuitry 904 may reorder the incoming wireless data 906, which may be implemented by data packets. In response to the reordering of incoming wireless data 906, the FSD circuitry 904 may deliver the reordered wireless data to the application 1006 of the VPC 1004.

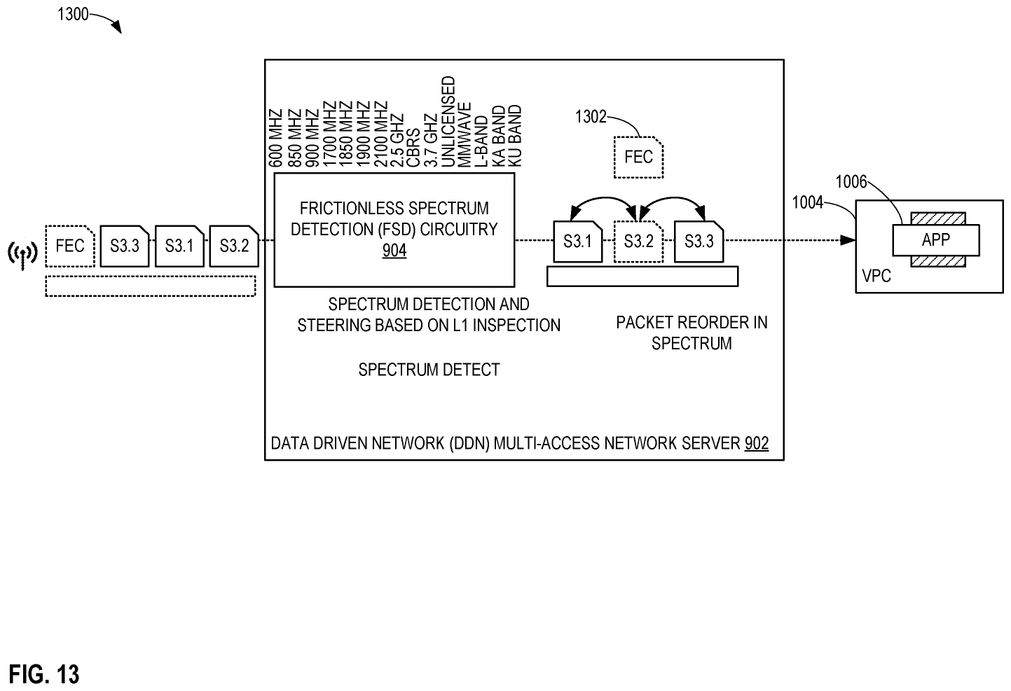

FIG. 13 is an example system 1300 including the DDN server 902 and the FSD circuitry 904 of FIG. 9, and the VPC 1004 and the application 1006 of FIG. 10. In this example, the DDN server 902 includes example forward error correcting (FEC) circuitry 1302. In example operation, in response to the detection of the spectrum of the incoming wireless data 906, the FSD circuitry 904 may reorder the incoming wireless data 906, which may be implemented by data packets. In response to the reordering of incoming wireless data 906, the FSD circuitry 904 may deliver the reordered wireless data to the application 1006 of the VPC 1004.

In example operation, the DDN server 902 may detect and/or steer the incoming wireless data 906 based on L1 inspection (e.g., L1 data inspection). In example operation, the DDN server 902 may parse and/or otherwise extract L1 data from the incoming wireless data 906. In example operation, the DDN server 902 may execute AI/ML model(s) with the L1 data as ML input(s) to generate ML output(s), which may include a location of a data source (e.g., a cellular data source). In example operation, the DDN server 902 may provide the location to the application 1006. In example operation, the application 1006 may cause one or more operations to occur. For example, the application 1006 may be an autonomous driving application, an autonomous robot application, etc., associated with the data source (e.g., the data source may be an autonomous vehicle, an autonomous robot, etc.). In some examples, in response to receiving the location of the data source, the application 1006 may determine a spectrum for which the data source is to use based on the location. Additionally and/or alternatively, the application 1006 may generate a command, a direction, an instruction, etc., to cause the data source, or device(s) associated thereof, to execute one or more actions (e.g., an autonomous driving action such as a change in speed or direction, an autonomous robot action such as a change in a robot arm position, etc.).

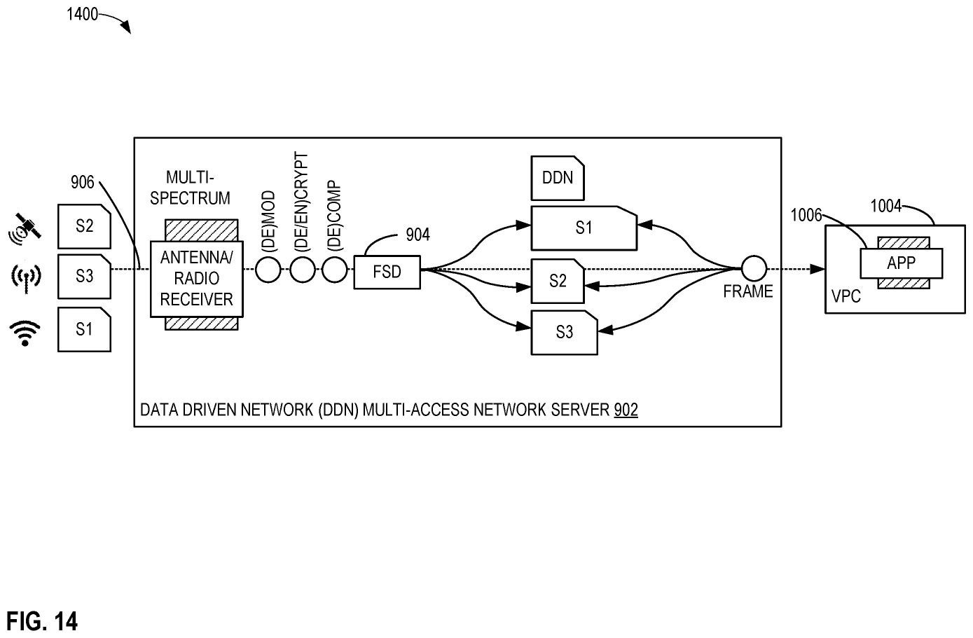

FIG. 14 is an example system 1400 including the DDN server 902 and the FSD circuitry 904 of FIG. 9, and the VPC 1004 and the application 1006 of FIG. 10. In example operation, in response to the detection of the spectrum of the incoming wireless data 906, the FSD circuitry 904 may execute various operations on the incoming wireless data 906, such as demodulation or modulation, decryption or encryption, decompression or compression, etc. In response to execution of the various operations on the incoming wireless data 906, the FSD circuitry 904 may deliver the incoming wireless data 906 to the application 1006 of the VPC 1004.

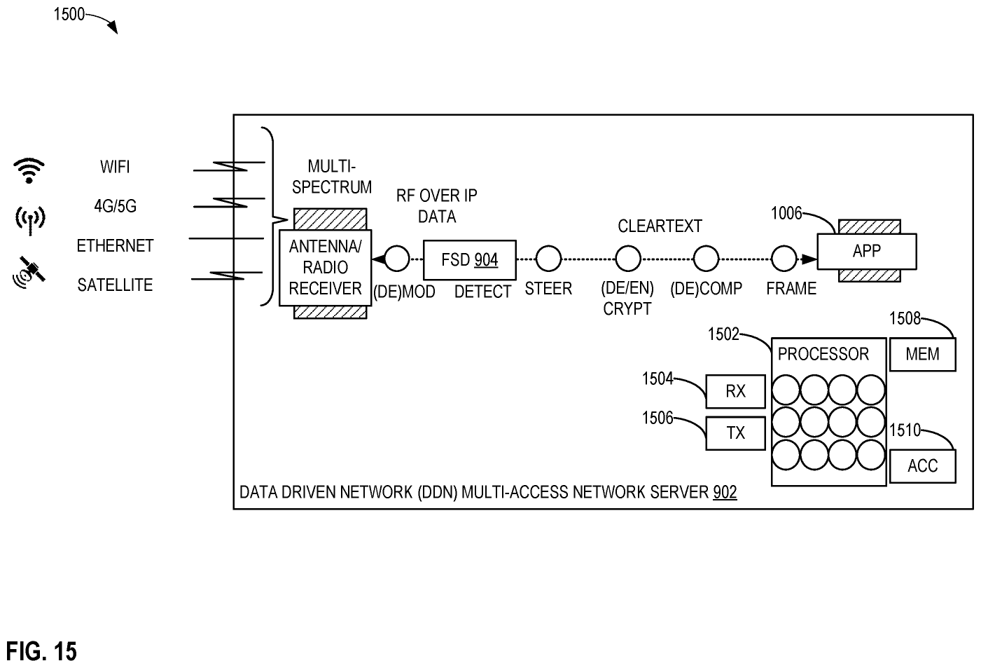

FIG. 15 is an illustration of an example system 1500 including the DDN server 902 and the FSD circuitry 904 of FIG. 9, and the application 1006 of FIG. 10. In this example, the DDN server 902 includes example processor circuitry 1502, example receive interface circuitry 1504, example transmit interface circuitry 1506, example memory 1508, and an example accelerator 1510. In some examples, the antenna/radio receiver, the FSD 904, and/or the application 1006 may be implemented by the processor circuitry 1502.

In example operation, the processor circuitry 1502, and/or, more generally, the DDN server 902, executes a workflow. For example, the processor circuitry 1502 can receive heterogeneous multi-spectrum data from various data sources (e.g., Wi-Fi data sources, 4G data sources, 5G data sources, Ethernet data sources, satellite data sources, etc.). The processor circuitry 1502 can execute the workflow on the data, which can include demodulation, spectrum detection, steering based on L1 portion(s) of the data, decryption, decompression, and frame construction.

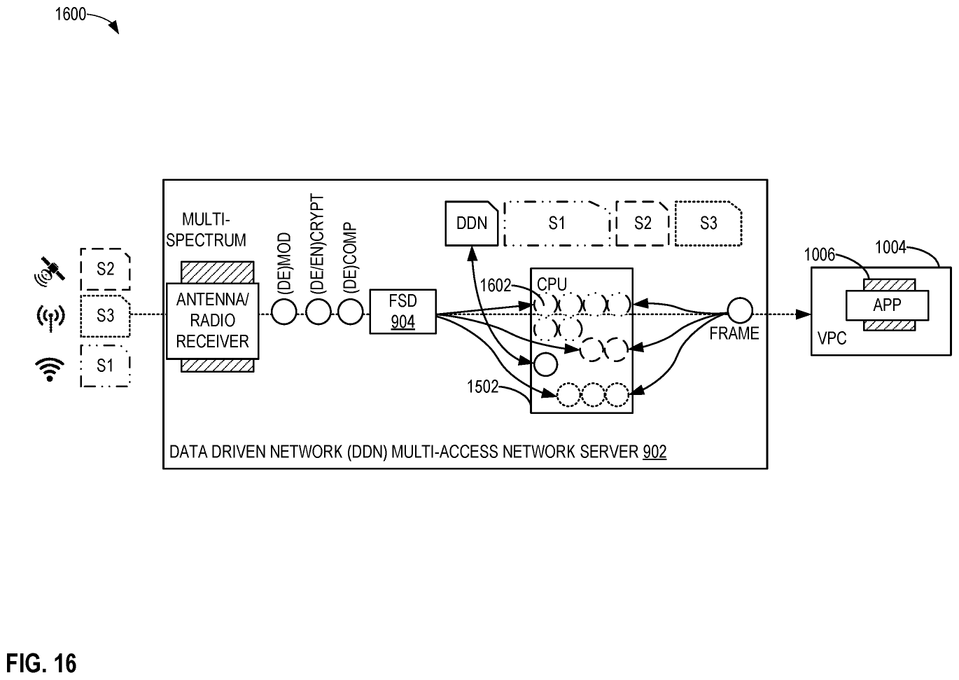

FIG. 16 is an illustration of an example system 1600 including the DDN server 902 and the FSD circuitry 904 of FIG. 9, the application 1006 of FIG. 10, and the processor circuitry 1502 of FIG. 15. The processor circuitry 1502 includes a plurality of compute cores 1602. For example, first ones of the compute cores 1602 can be configured to execute workloads corresponding to a first spectrum (S1). Second ones of the compute cores 1602 can be configured to execute workloads corresponding to a second spectrum (S2). Third ones of the compute cores 1602 can be configured to execute workloads corresponding to a third spectrum (S3). For example, the first, second, and/or third ones of the compute cores 1602 can have different clock frequencies, different sets of Instruction Set Architecture (ISA) instructions, etc., to optimize and/or otherwise improve execution of workloads for the various spectrums. Advantageously, the DDN server 902 can dimension compute resources for specific spectrums based on a DDN policy. For example, the FSD 904 can use (i) L1 spectrum real-time data, (ii) in/out-band network telemetry data, and/or (iii) DDN policy controls to condition network infrastructure including: (a) correction for lost packets within a specific spectrum, (b) order processing of multiple spectrums, (c) updates or changes to bandwidth capacity, (d) updates or changes in security settings, (e) rerouting decisions, and/or (f) the feeding of applications of payload data for processing.

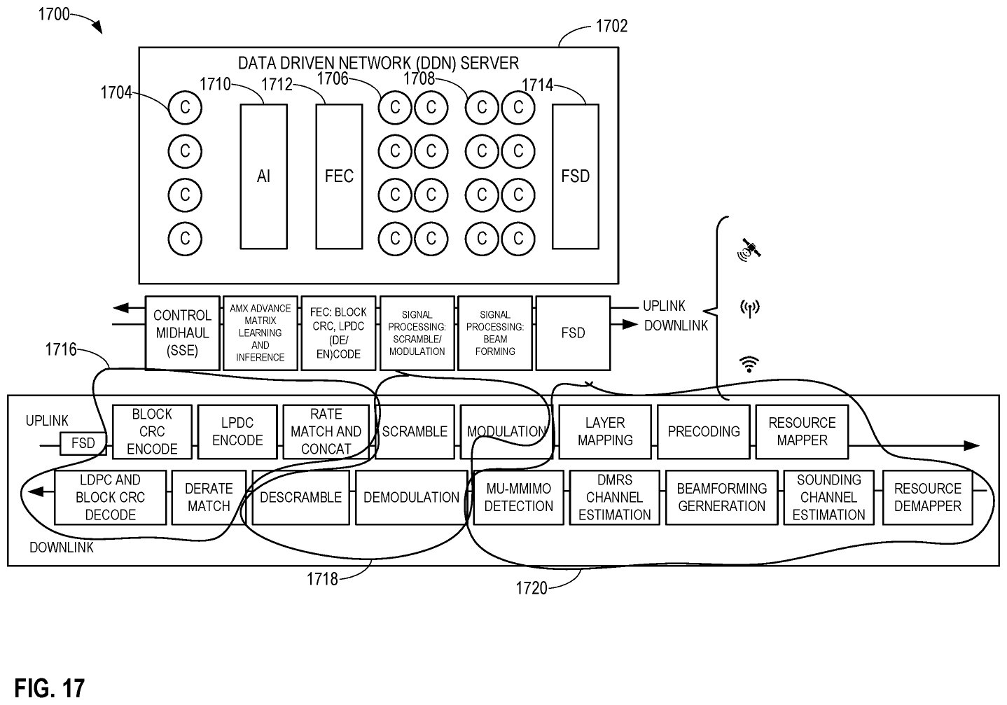

FIG. 17 is an illustration of an example system 1700 including an example implementation of an example DDN server 1702. The DDN server 902 of the illustrated example includes first example compute cores 1704, second example compute cores 1706, third example compute cores 1708, an example AI engine 1710, example forward error correction (FEC) circuitry 1712, and example frictionless spectrum detection (FSD) circuitry 1714.

In the illustrated example, the first cores 1704 execute and/or instantiate control midhaul workloads, such as Single Instruction, Multiple Data Extensions (SSE). In the illustrated example, the AI engine 1710 executes and/or instantiates x86 Advanced Matrix Extension (AMX) learning and inference functions. In the illustrated example, the FEC circuitry 1712 executes and/or instantiates FEC functions, such as block cyclic redundancy check (CRC), low-density parity-check (LDPC), decoding, and/or encoding functions. In the illustrated example, the FEC circuitry 1712 can execute and/or instantiate a first set of example functions 1716.

In the illustrated example, the second cores 1706 execute and/or instantiate signal processing functions, such as scramble and/or modulation functions. In some examples, the second cores 1706 can execute and/or instantiate a set of instructions such as Advanced Vector Extensions 512-bit instructions (also referred to herein as AVX-512 instructions) to implement the signal processing functions. In the illustrated example, the second cores 1706 can execute and/or instantiate a second set of example functions 1718.

In the illustrated example, the third cores 1708 execute and/or instantiate signal processing functions, such as beam forming functions. In some examples, the third cores 1708 can execute and/or instantiate a set of instructions such as instructions in an ISA that is tailored to and/or otherwise developed to improve and/or otherwise optimize 5G processing tasks (also referred to herein as 5G-ISA instructions). In the illustrated example, the third cores 1708 can execute and/or instantiate a third set of example functions 1720. In the illustrated example, the FSD executes and/or instantiates FSD functions 1716.

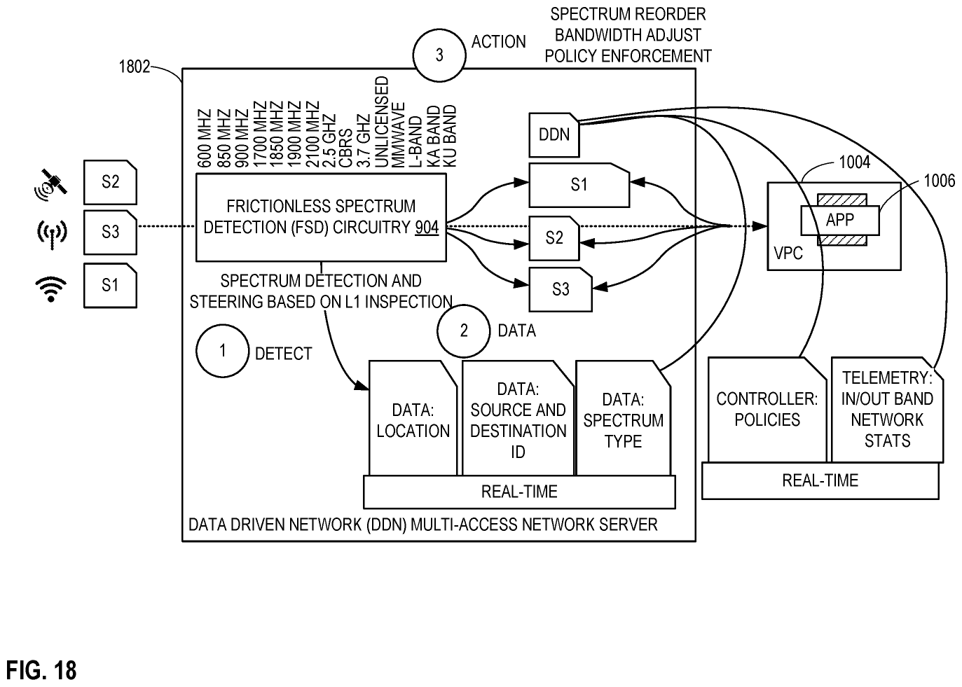

FIG. 18 is an illustration of an example DDN server 1802. In this example, the DDN server 1802 is a DDN multi-access network server. The DDN server 1802 includes the FSD circuitry 904 of FIG. 9, and the VPC 1004 and the application 1006 of FIG. 10. In example operation, the DDN server 1802 detects a spectrum of incoming data from one or more spectrums (e.g., 51, S2, S3, etc.). In example operation, the DDN server 1802 can determine parameters of the incoming data, such as location of a UE that generated the data, a source identifier that identifies the UE that generated the data, a destination identifier that identifies an electronic device for which the UE is to transmit the data, a spectrum type of a spectrum for which the data is utilized by the UE, etc., and/or any combination(s) thereof. In example operation, the DDN server 1802 can provide the data and/or the associated parameters to the application 1006. In example operation, the application 1006 can determine one or more actions based on the data and/or the associated parameters. For example, the application 1006 can determine an action such as spectrum reordering of data, bandwidth adjustment, policy enforcement, etc.

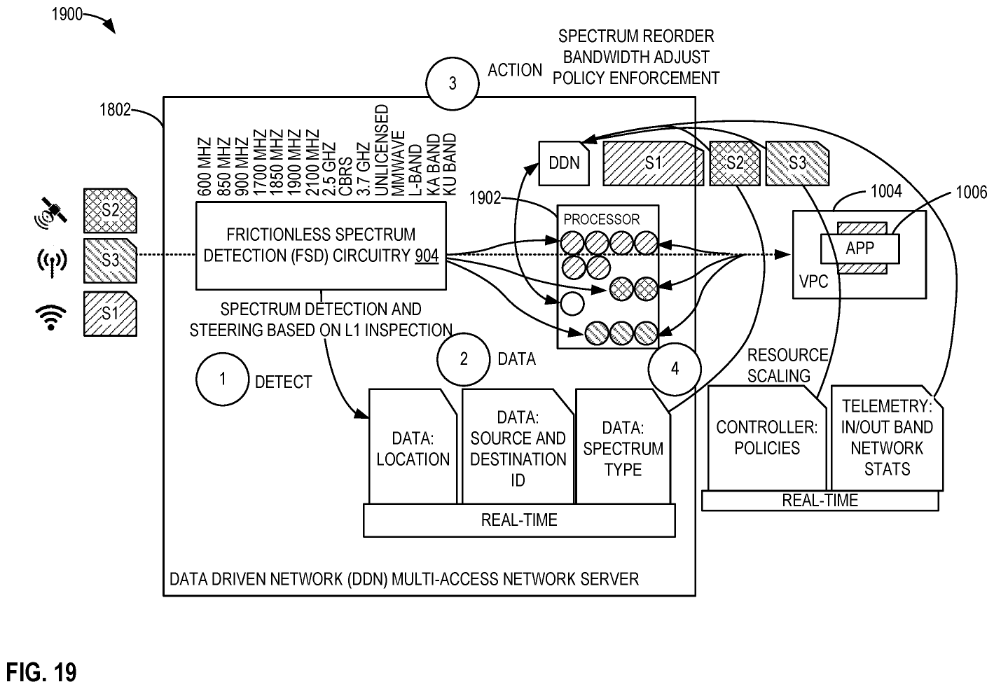

FIG. 19 is an illustration of a system 1900 including the DDN server 1802 of FIG. 18. In the illustrated example, the DDN server 1802 dimensions compute resources for specific spectrums according to a DDN policy. For example, in response to detecting the spectrum of incoming data, extracting parameters associated with the incoming data, and determining one or more actions based on at least one of the incoming data or the extracted parameters, the DDN server 1802 can configure one(s) of compute cores of an example processor 1902 to effectuate workloads that are optimized and/or otherwise tailored for specific spectrums.

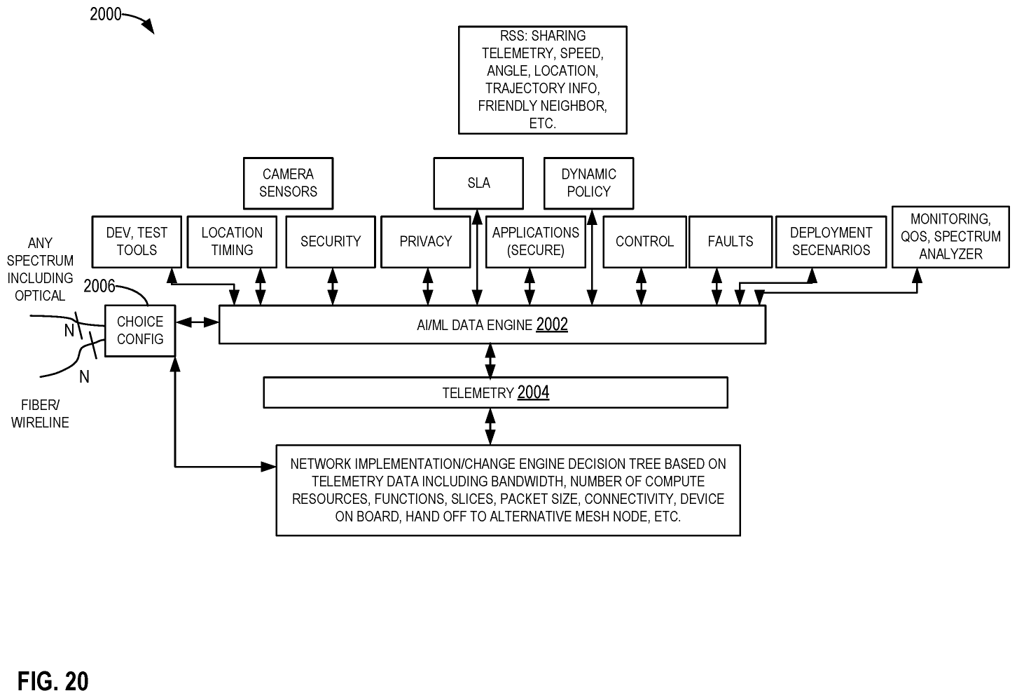

FIG. 20 is an illustration of example DDN system architecture 2000. The DDN system architecture 2000 includes an example AI/ML data engine 2002 to determine a choice of spectrum for which a UE is to utilize based on inputs. For example, the AI/ML data engine 2002 can obtain telemetry data 2004 such as network bandwidth, a quantity of compute resources (e.g., a number of compute cores), etc. In the illustrated example, the AI/ML data engine 2002 can obtain inputs such as location timing data, security data, privacy data, etc. In example operation, the AI/ML data engine 2002 can output an example choice configuration 2006 based on at least one of the inputs or the telemetry data 2004. For example, the AI/ML data engine 2002 can determine that a UE is to switch from a first spectrum to a second spectrum for improved communication and/or network quality, improved throughput, and/or reduced latency when executing application(s) or other workload(s).

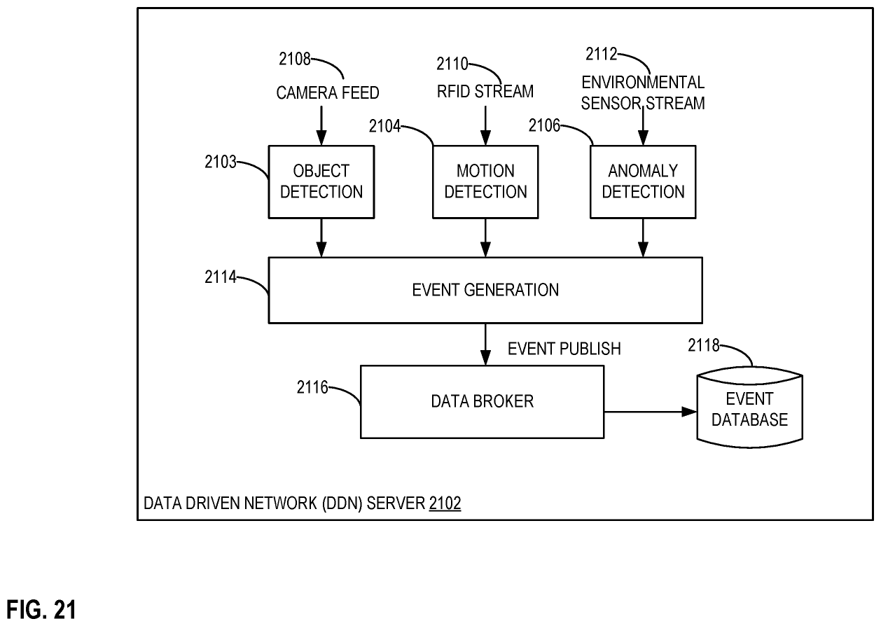

FIG. 21 is a block diagram of an example implementation of a DDN server 2102. In the illustrated example, the DDN server 2102 executes at least one of object detection 2103 (e.g., generate outputs from object detectors), motion detection 2104 (e.g., generate outputs from motion detectors), or anomaly detection 2106 (e.g., generate outputs from anomaly detectors) of object(s) in an environment. In some examples, the illustrated example of FIG. 21 may implement passive object data collection in which an infrastructure provides data associated with the object(s).

In the illustrated example, the DDN server 2102 may obtain an example camera feed 2108, an example RFID stream 2110, and an example environmental sensor stream 2112. In some examples, the DDN server 2102 implements the object detection 2103 with object detection circuitry, the motion detection 2104 with motion detection circuitry, and/or the anomaly detection 2106 with anomaly detection circuitry. For example, the DDN server 2102 may detect an object based on the camera feed 2108. The DDN server 2102 may detect motion of the object based on the RFID stream 2110. The DDN server 2102 may detect an anomaly condition associated with the object based on the environmental sensor stream 2112, which may include one or more environmental sensors (e.g., moisture, pressure, temperature, etc., sensors).

In the illustrated example, the DDN server 2102 may execute example event generation 2114 with event generation circuitry. For example, the DDN server 2102 may generate and publish an event indicative of output(s) of at least one of the object detection 2103, the motion detection 2104, or the anomaly detection 2106. For example, discrete sensors like IP cameras, RFID readers, light sensors, temperature sensors, humidity sensors, accelerometers, etc., can feed their data into the event generation 2114, which can include logic specific to the type of sensor generating the data.

In some examples, the events can include location and/or direction information. In some examples, the events can include only raw sensor data. In some examples, the events can include a detection of a forklift moving right to left by a camera having an identifier of 34. In some examples, the events can include a detection that an RFID tag associated with a forklift having an identifier of ABC has moved from Zone X to Zone Y. In some examples, the events can include a determination that a temperature in a hallway having an identifier of 12 has increased by 5 degrees Fahrenheit. In some examples, the events can include a detection that the lights in a room with an identifier of C4 has gone out.

In some examples, the event may include a first indication that the object has been detected, a second indication that the object is in motion (or has moved from a first location to a second location), and/or a third indication that an anomaly condition is present. In some examples, the event may include direction information, location information, etc., associated with the object. In some examples, the events may include sensor data (e.g., raw sensor data). In some examples, the event(s) may include a direction and/or a location of an object in an environment.

In example operation, the DDN server 2102 may publish the event to an example data broker 2116, which may be implemented by data broker circuitry. The data broker 2116 may store the events in an example event database 2118, which may be accessed by device(s), application(s), etc. In some examples, the event database 2118 may be implemented by memory and/or one or more mass storage devices. In some examples, the DDN server 2102 may implement at least one of the object detection 2103, the motion detection 2104, the anomaly detection 2106, the event generation 2114, or the data broker 2116 by executing an AI/ML model as described herein.

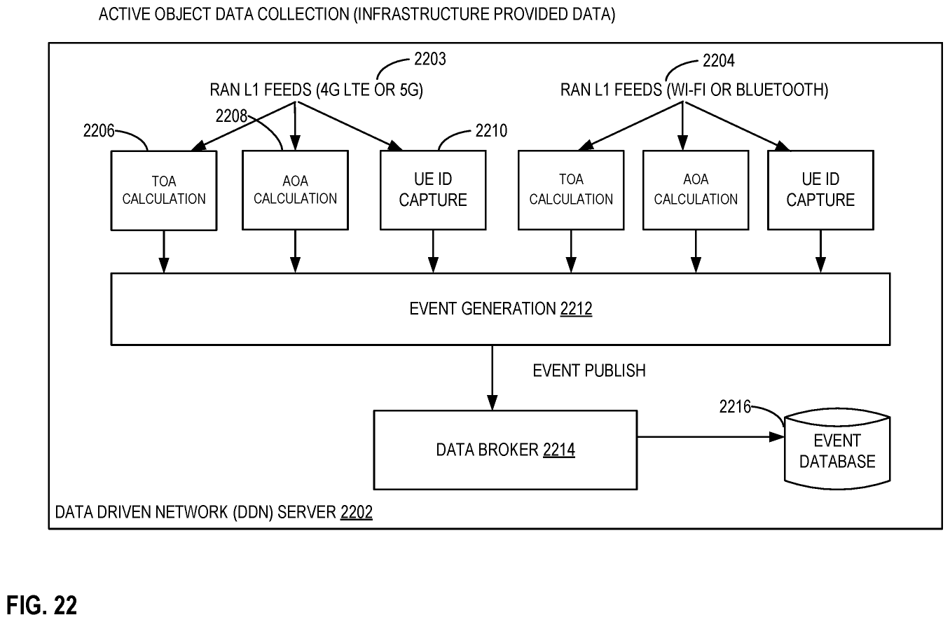

FIG. 22 is a block diagram of an example DDN server 2202. In some examples, the DDN server 2202 identifies a location of object(s) in an environment based on at least one of time-of-arrival (TOA) data, angle-of-arrival (AOA) data, or device identification data in terrestrial settings. In some examples, the illustrated example of FIG. 22 may implement passive object data collection in which an infrastructure provides data associated with the object(s).

In the illustrated example, the DDN server 2202 obtains a first example RAN L1 feed 2203 and a second example RAN L1 feed 2204. In this example, the first RAN L1 feed 2203 may be implemented by 4G LTE or 5G (or 6G in other examples). In this example, the second RAN L1 feed 2204 may be implemented by Wi-Fi or Bluetooth (or RFID or GNSS in other examples). In example operation, the DDN server 2202 may execute an example time-of-arrival (TOA) calculation 2206, an example angle-of-arrival (AOA) calculation 2208, and an example user equipment (UE) identifier (ID) capture operation 2210 on the first RAN L1 feed 2203 and/or the second RAN L1 feed 2204.

In example operation, the DDN server 2202 may execute example event generation operations 2212 based on the TOA calculation 2206, the AOA calculation 2208, and the UE ID capture 2210. For example, the event generation operations 2212 may generate an event based on a TOA measurement, an AOA measurement, and a UE ID (e.g., a UE ID captured and/or otherwise extracted from the first RAN L1 feed 2203 and/or the second RAN L1 feed 2204). The event generation operations 2212 may cause event(s) to be published to an example data broker 2214. The data broker 2214 may store the event(s) in an example event database 2216. In some examples, the event database 2216 may be implemented by memory and/or one or more mass storage devices. In some examples, the event(s) may include a direction and/or a location of an object in an environment. In some examples, the DDN server 2202 may implement at least one of the event generation 2014 or the data broker 2016 by executing an AI/ML model.

In some examples, RAN based sensor data such as UE TOA data, UE AOA data, and UE scan report data can be fed into the event generation operations 2212. For example, the event generation operations 2212 can generate an event that includes a UE with an identifier of 123 is 12.5 meters away from basestation-2 at an angle of 37 degrees. In some examples, the event generation operations 2212 can generate an event that includes a UE with an identifier of 456 is 34.2 meters away from basestation-1 at an angle of 172 degrees. In some examples, the event generation operations 2212 can generate an event that indicates a Wi-Fi device with a media access control (MAC) address of 3F is 10.5 meters away from a Wi-Fi access point (AP) with an identifier of 37 at an angle of 17 degrees.

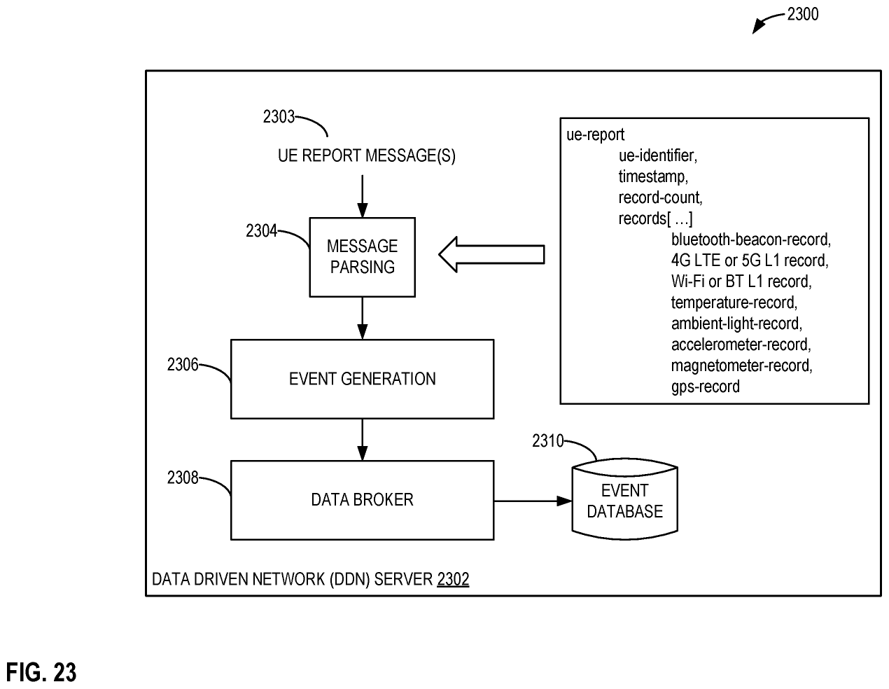

FIG. 23 is a block diagram of an example workflow 2300 in which an example DDN server 2302 parses example messages 2303 from user equipment (UEs) to generate example events. In some examples, the illustrated example of FIG. 23 may implement active object data collection in which an object, such as a UE, may provide data associated with the object.

In example operation, the DDN server 2302 may execute example message parsing 2304 on the messages 2303. For example, the DDN server 2302 may parse the messages 2303 to extract data of interest from the messages 2303. In some examples, the messages 2303 may include UE identifiers (identified by UE-identifier), timestamps (identified by timestamp), record counts (identified by record-count), and/or records (identified by records[1 . . . n]). In this example, the records may include multi-spectrum, multi-modal records, such as Bluetooth, 4G LTE, 5G L1, Wi-Fi or Bluetooth L1, sensor records (e.g., temperature, ambient light, accelerometer, magnetometer, etc., records), GPS records, etc.

In example operation, the DDN server 2302 may generate event(s) based on the parsed messages by executing event generation 2306. In example operation, the DDN server 2302 may provide the event(s) to an example data broker 2308. In example operation, the data broker 2308 may push the event(s) to an example event database 2310, which may be accessed by device(s), application(s), etc. In some examples, the event database 2310 may be implemented by memory and/or one or more mass storage devices. In some examples, the event(s) can include a first event that indicates a UE with an identifier of 123 is 2.9 meters away from a Bluetooth beacon with an identifier of 7 at an angle of 33 degrees. In some examples, the event(s) can include a second event that indicates a UE with an identifier of 456 is able to see a Wi-Fi network with a service set identifier (SSID) of “Network-1” at an received signal strength indicator (RSSI) of −63 decibel-milliwatts (dBm).

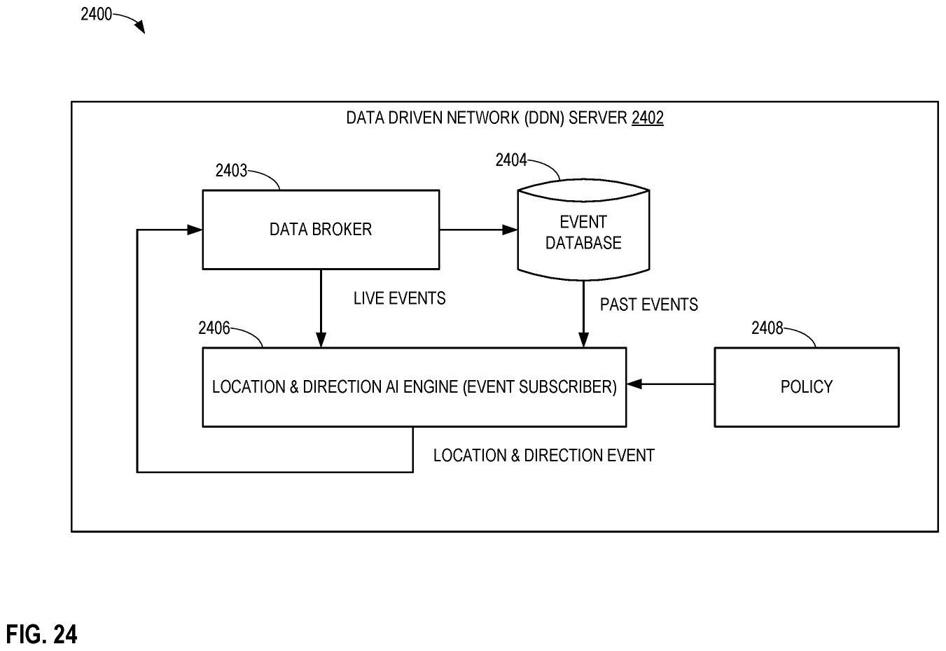

FIG. 24 is a block diagram of an example workflow 2400 in which an example DDN server 2402 generates location and/or direction events based on at least one of live events or past events associated with objects in an environment. In example operation, an example data broker 2403 pushes events to an example event database 2404 and an example location and direction AI engine 2406. In example operation, the location and direction AI engine 2406 may obtain past events from the event database 2404. In example operation, the location and direction AI engine 2406 may generate location and/or direction events based on the live events, the past events, and an example policy 2408. In some examples, the policy 2408 may be representative of one or more requirements, specifications, etc., that may adjust operation of the location and direction AI engine 2406. In some examples, the location events include a location of an object and/or an action to be executed in connection with the object. In some examples, the direction events include a direction in which the object may be moving and/or an action to be executed in connection with the object.

In some examples, the location and direction AI engine 2406 can subscribe to various “topics” and based on certain “policies”, publish qualified events that may include a forklift with an identifier of ABC is at location X/Y/Z with a velocity vector of V. In some examples, the events may include a UE with an identifier of 123 is at location A/B/C with a velocity vector of V. In some examples, the events may include a Wi-Fi device with a MAC address of 2F is at location E/F/G with a velocity vector of V. For example, these events can be sent to the data broker 2403 on a unique “topic” as well as stored in the event database 2404.

FIG. 25 is a block diagram 2500 showing an overview of a configuration for edge computing, which includes a layer of processing referred to in many of the following examples as an “edge cloud”. As shown, the edge cloud 2510 is co-located at an edge location, such as an access point or base station 2540, a local processing hub 2550, or a central office 2520, and thus may include multiple entities, devices, and equipment instances. The edge cloud 2510 is located much closer to the endpoint (consumer and producer) data sources 2560 (e.g., autonomous vehicles 2561, user equipment 2562, business and industrial equipment 2563, video capture devices 2564, drones 2565, smart cities and building devices 2566, sensors and Internet-of-Things (IoT) devices 2567, etc.) than the cloud data center 2530. Compute, memory, and storage resources that are offered at the edges in the edge cloud 2510 are critical to providing ultra-low latency response times for services and functions used by the endpoint data sources 2560 as well as reduce network backhaul traffic from the edge cloud 2510 toward cloud data center 2530 thus improving energy consumption and overall network usages among other benefits.

In some examples, the central office 2520, the cloud data center 2530, and/or portion(s) thereof, may implement one or more location engines that locate and/or otherwise identify positions of devices of the endpoint (consumer and producer) data sources 2560 (e.g., autonomous vehicles 2561, user equipment 2562, business and industrial equipment 2563, video capture devices 2564, drones 2565, smart cities and building devices 2566, sensors and Internet-of-Things (IoT) devices 2567, etc.). In some such examples, the central office 2520, the cloud data center 2530, and/or portion(s) thereof, may implement one or more location engines to execute location detection operations with improved accuracy.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

In contrast to the network architecture of FIG. 25, traditional endpoint (e.g., UE, vehicle-to-vehicle (V2V), vehicle-to-everything (V2X), etc.) applications are reliant on local device or remote cloud data storage and processing to exchange and coordinate information. A cloud data arrangement allows for long-term data collection and storage, but is not optimal for highly time varying data, such as a collision, traffic light change, etc. and may fail in attempting to meet latency challenges.

Depending on the real-time requirements in a communications context, a hierarchical structure of data processing and storage nodes may be defined in an edge computing deployment. For example, such a deployment may include local ultra-low-latency processing, regional storage and processing as well as remote cloud data-center based storage and processing. Key performance indicators (KPIs) may be used to identify where sensor data is best transferred and where it is processed or stored. This typically depends on the ISO layer dependency of the data. For example, lower layer (PHY, MAC, routing, etc.) data typically changes quickly and is better handled locally in order to meet latency requirements. Higher layer data such as Application Layer data is typically less time critical and may be stored and processed in a remote cloud data-center. At a more generic level, an edge computing system may be described to encompass any number of deployments operating in the edge cloud 2510, which provide coordination from client and distributed computing devices.

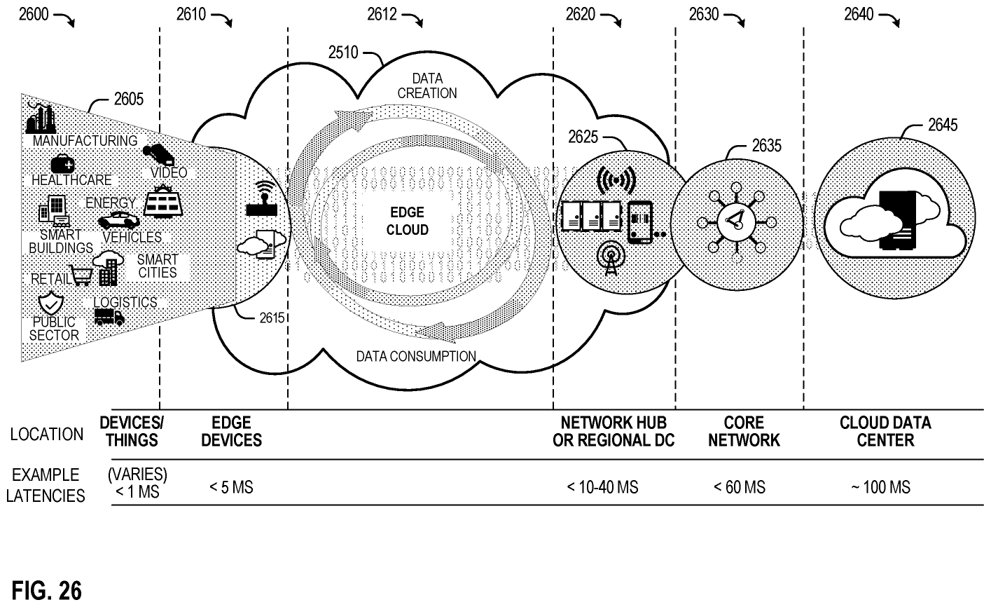

FIG. 26 illustrates operational layers among endpoints, an edge cloud, and cloud computing environments. Specifically, FIG. 26 depicts examples of computational use cases 2605, utilizing the edge cloud 2510 of FIG. 25 among multiple illustrative layers of network computing. The layers begin at an endpoint (devices and things) layer 2600, which accesses the edge cloud 2510 to conduct data creation, analysis, and data consumption activities. The edge cloud 2510 may span multiple network layers, such as an edge devices layer 2610 having gateways, on-premise servers, or network equipment (nodes 2615) located in physically proximate edge systems; a network access layer 2620, encompassing base stations, radio processing units, network hubs, regional data centers (DC), or local network equipment (equipment 2625); and any equipment, devices, or nodes located therebetween (in layer 2612, not illustrated in detail). The network communications within the edge cloud 2510 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 2600, under 5 ms at the edge devices layer 2610, to even between 10 to 40 ms when communicating with nodes at the network access layer 2620. Beyond the edge cloud 2510 are core network 2630 and cloud data center 2632 layers, each with increasing latency (e.g., between 40-60 ms at the core network layer 2630, to 100 or more ms at the cloud data center layer 2640). As a result, operations at a core network data center 2635 or a cloud data center 2645, with latencies of at least 60 to 100 ms or more, will not be able to accomplish many time-critical functions of the use cases 2605. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 2635 or a cloud data center 2645, a central office or content data network may be considered as being located within a “near edge” layer (“near” to the cloud, having high latency values when communicating with the devices and endpoints of the use cases 2605), whereas an access point, base station, on-premise server, or network gateway may be considered as located within a “far edge” layer (“far” from the cloud, having low latency values when communicating with the devices and endpoints of the use cases 2605). It will be understood that other categorizations of a particular network layer as constituting a “close”, “local”, “near”, “middle”, or “far” edge may be based on latency, distance, number of network hops, or other measurable characteristics, as measured from a source in any of the network layers 2600-2640.

The various use cases 2605 may access resources under usage pressure from incoming streams, due to multiple services utilizing the edge cloud. For example, location detection of devices associated with such incoming streams of the various use cases 2605 is desired and may be achieved with example location engines as described herein. To achieve results with low latency, the services executed within the edge cloud 2510 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to service level agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 2510 may provide the ability to serve and respond to multiple applications of the use cases 2605 (e.g., object tracking, location detection, video surveillance, connected cars, etc.) in real-time or near real-time, and meet ultra-low latency requirements for these multiple applications. These advantages enable a whole new class of applications (VNFs), Function-as-a-Service (FaaS), Edge-as-a-Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 2510 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 2510 (network layers 2610-2630), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 2510.

As such, the edge cloud 2510 is formed from network components and functional features operated by and within edge gateway nodes, edge aggregation nodes, or other edge compute nodes among network layers 2610-2630. The edge cloud 2510 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 2510 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

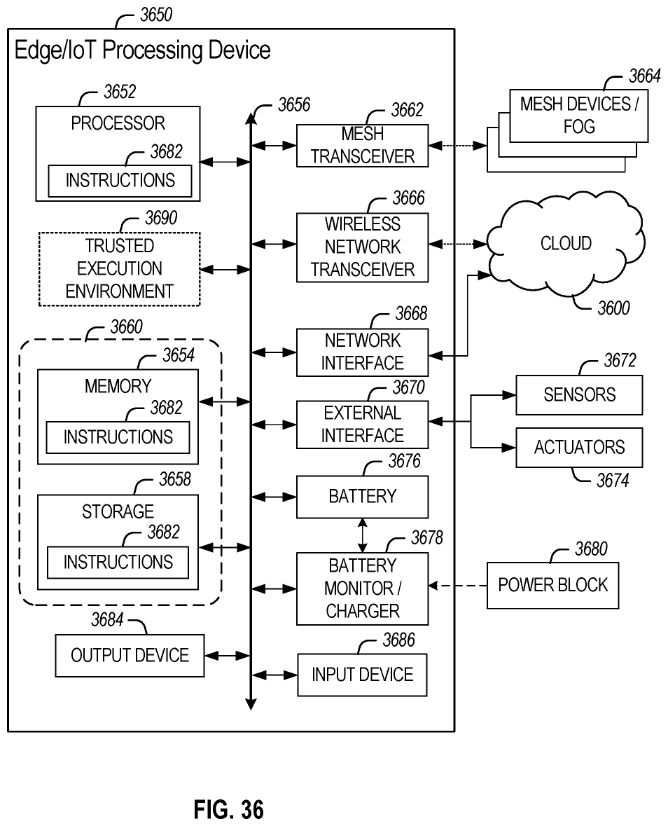

The network components of the edge cloud 2510 may be servers, multi-tenant servers, appliance computing devices, and/or any other type of computing devices. For example, the edge cloud 2510 may include an appliance computing device that is a self-contained electronic device including a housing, a chassis, a case or a shell. In some examples, the edge cloud 2510 may include an appliance to be operated in harsh environmental conditions (e.g., extreme heat or cold ambient temperatures, strong wind conditions, wet or frozen environments, and the like). In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures), and/or enable submergibility. Example housings may include power circuitry to provide power for stationary and/or portable implementations, such as alternating current (AC) power inputs, direct current (DC) power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, light emitting diodes (LEDs), speakers, I/O ports (e.g., universal serial bus (USB)), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include IoT devices. The appliance computing device may include hardware and software components to manage local issues such as device temperature, vibration, resource utilization, updates, power issues, physical and network security, etc. The example processor systems of at least FIGS. 36, 37, 38, and/or 39 illustrate example hardware for implementing an appliance computing device. The edge cloud 2510 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

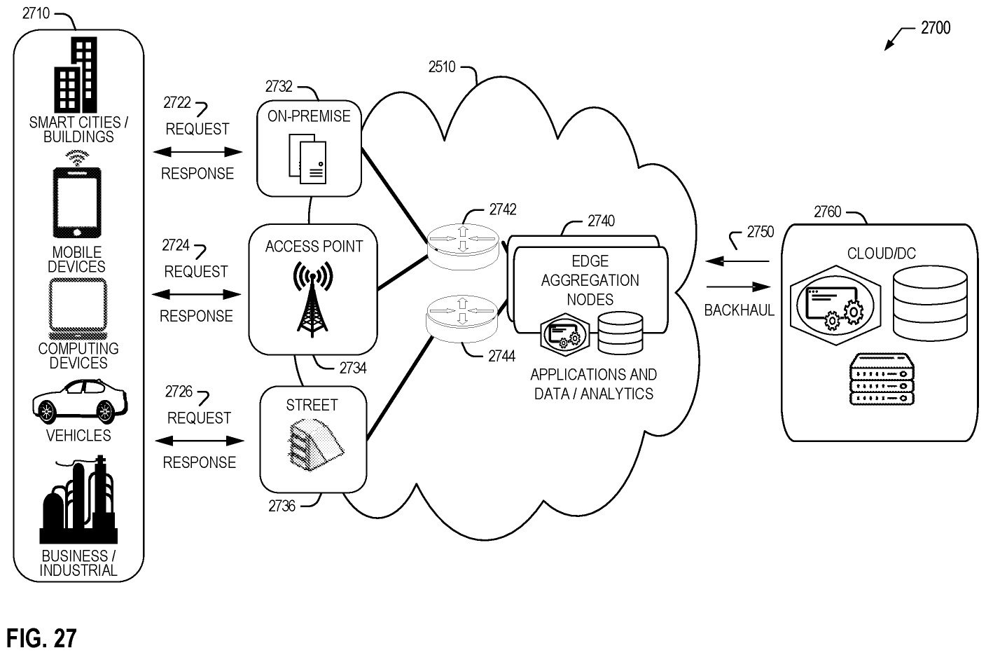

In FIG. 27, various client endpoints 2710 (in the form of mobile devices, computers, autonomous vehicles, business computing equipment, industrial processing equipment) exchange requests and responses that are specific to the type of endpoint network aggregation. For instance, client endpoints 2710 may obtain network access via a wired broadband network, by exchanging requests and responses 2722 through an on-premise network system 2732. Some client endpoints 2710, such as mobile computing devices, may obtain network access via a wireless broadband network, by exchanging requests and responses 2724 through an access point (e.g., cellular network tower) 2734. Some client endpoints 2710, such as autonomous vehicles may obtain network access for requests and responses 2726 via a wireless vehicular network through a street-located network system 2736. However, regardless of the type of network access, the TSP may deploy aggregation points 2742, 2744 within the edge cloud 2510 of FIG. 25 to aggregate traffic and requests. Thus, within the edge cloud 2510, the TSP may deploy various compute and storage resources, such as at edge aggregation nodes 2740, to provide requested content. The edge aggregation nodes 2740 and other systems of the edge cloud 2510 are connected to a cloud or data center (DC) 2760, which uses a backhaul network 2750 to fulfill higher-latency requests from a cloud/data center for websites, applications, database servers, etc. Additional or consolidated instances of the edge aggregation nodes 2740 and the aggregation points 2742, 2744, including those deployed on a single server framework, may also be present within the edge cloud 2510 or other areas of the TSP infrastructure. Advantageously, example location engines as described herein may detect and/or otherwise determine locations of the client endpoints 2710 with improved performance and accuracy and reduced latency.

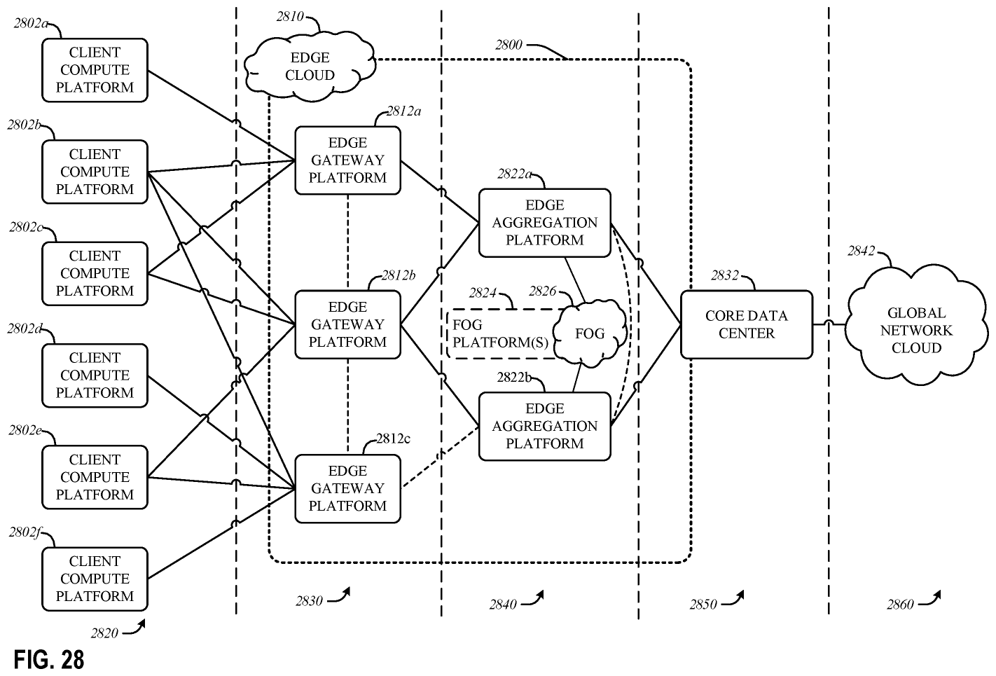

FIG. 28 depicts an example edge computing system 2800 for providing edge services and applications to multi-stakeholder entities, as distributed among one or more client compute platforms 2802, one or more edge gateway platforms 2812, one or more edge aggregation platforms 2822, one or more core data centers 2832, and a global network cloud 2842, as distributed across layers of the edge computing system 2800. The implementation of the edge computing system 2800 may be provided at or on behalf of a telecommunication service provider (“telco”, or “TSP”), internet-of-things service provider, cloud service provider (CSP), enterprise entity, or any other number of entities. Various implementations and configurations of the edge computing system 2800 may be provided dynamically, such as when orchestrated to meet service objectives.

Individual platforms or devices of the edge computing system 2800 are located at a particular layer corresponding to layers 2820, 2830, 2840, 2850, and 2860. For example, the client compute platforms 2802a, 2802b, 2802c, 2802d, 2802e, 2802f are located at an endpoint layer 2820, while the edge gateway platforms 2812a, 2812b, 2812c are located at an edge devices layer 2830 (local level) of the edge computing system 2800. Additionally, the edge aggregation platforms 2822a, 2822b (and/or fog platform(s) 2824, if arranged or operated with or among a fog networking configuration 2826) are located at a network access layer 2840 (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provides a decentralized architecture and serves as an extension to cloud computing by collaborating with one or more edge node devices, providing the subsequent amount of localized control, configuration and management, and much more for end devices. Furthermore, fog computing provides the ability for edge resources to identify similar resources and collaborate to create an edge-local cloud which can be used solely or in conjunction with cloud computing to complete computing, storage or connectivity related services. Fog computing may also allow the cloud-based services to expand their reach to the edge of a network of devices to offer local and quicker accessibility to edge devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 2832 is located at a core network layer 2850 (a regional or geographically central level), while the global network cloud 2842 is located at a cloud data center layer 2860 (a national or world-wide layer). The use of “core” is provided as a term for a centralized network location—deeper in the network—which is accessible by multiple edge platforms or components; however, a “core” does not necessarily designate the “center” or the deepest location of the network. Accordingly, the core data center 2832 may be located within, at, or near the edge cloud 2810. Although an illustrative number of client compute platforms 2802a, 2802b, 2802c, 2802d, 2802e, 2802f; edge gateway platforms 2812a, 2812b, 2812c; edge aggregation platforms 2822a, 2822b; edge core data centers 2832; and global network clouds 2842 are shown in FIG. 28, it should be appreciated that the edge computing system 2800 may include any number of devices and/or systems at each layer. Devices at any layer can be configured as peer nodes and/or peer platforms to each other and, accordingly, act in a collaborative manner to meet service objectives. For example, in additional or alternative examples, the edge gateway platforms 2812a, 2812b, 2812c can be configured as an edge of edges such that the edge gateway platforms 2812a, 2812b, 2812c communicate via peer to peer connections. In some examples, the edge aggregation platforms 2822a, 2822b and/or the fog platform(s) 2824 can be configured as an edge of edges such that the edge aggregation platforms 2822a, 2822b and/or the fog platform(s) communicate via peer to peer connections. Additionally, as shown in FIG. 28, the number of components of respective layers 2820, 2830, 2840, 2850, and 2860 generally increases at each lower level (e.g., when moving closer to endpoints (e.g., client compute platforms 2802a, 2802b, 2802c, 2802d, 2802e, 2802f)). As such, one edge gateway platforms 2812a, 2812b, 2812c may service multiple ones of the client compute platforms 2802a, 2802b, 2802c, 2802d, 2802e, 2802f, and one edge aggregation platform (e.g., one of the edge aggregation platforms 2822a, 2822b) may service multiple ones of the edge gateway platforms 2812a, 2812b, 2812c.

Consistent with the examples provided herein, a client compute platform (e.g., one of the client compute platforms 2802a, 2802b, 2802c, 2802d, 2802e, 28020 may be implemented as any type of endpoint component, device, appliance, or other thing capable of communicating as a producer or consumer of data. For example, a client compute platform can include a mobile phone, a laptop computer, a desktop computer, a processor platform in an autonomous vehicle, etc. In additional or alternative examples, a client compute platform can include a camera, a sensor, etc. Further, the label “platform,” “node,” and/or “device” as used in the edge computing system 2800 does not necessarily mean that such platform, node, and/or device operates in a client or slave role; rather, any of the platforms, nodes, and/or devices in the edge computing system 2800 refer to individual entities, platforms, nodes, devices, and/or subsystems which include discrete and/or connected hardware and/or software configurations to facilitate and/or use the edge cloud 2810. Advantageously, example location engines as described herein may detect and/or otherwise determine locations of the client compute platforms 2802a, 2802b, 2802c, 2802d, 2802e, 2802f with improved performance and accuracy as well as with reduced latency.

As such, the edge cloud 2810 is formed from network components and functional features operated by and within the edge gateway platforms 2812a, 2812b, 2812c and the edge aggregation platforms 2822a, 2822b of layers 2830, 2840, respectively. The edge cloud 2810 may be implemented as any type of network that provides edge computing and/or storage resources which are proximately located to radio access network (RAN) capable endpoint devices (e.g., mobile computing devices, IoT devices, smart devices, etc.), which are shown in FIG. 28 as the client compute platforms 2802a, 2802b, 2802c, 2802d, 2802e, 2802f. In other words, the edge cloud 2810 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 267GPP carrier networks.

In some examples, the edge cloud 2810 may form a portion of, or otherwise provide, an ingress point into or across a fog networking configuration 2826 (e.g., a network of fog platform(s) 2824, not shown in detail), which may be implemented as a system-level horizontal and distributed architecture that distributes resources and services to perform a specific function. For instance, a coordinated and distributed network of fog platform(s) 2824 may perform computing, storage, control, or networking aspects in the context of an IoT system arrangement. Other networked, aggregated, and distributed functions may exist in the edge cloud 2810 between the core data center 2832 and the client endpoints (e.g., client compute platforms 2802a, 2802b, 2802c, 2802d, 2802e, 28020. Some of these are discussed in the following sections in the context of network functions or service virtualization, including the use of virtual edges and virtual services which are orchestrated for multiple tenants.

As discussed in more detail below, the edge gateway platforms 2812a, 2812b, 2812c and the edge aggregation platforms 2822a, 2822b cooperate to provide various edge services and security to the client compute platforms 2802a, 2802b, 2802c, 2802d, 2802e, 2802f. Furthermore, because a client compute platforms (e.g., one of the client compute platforms 2802a, 2802b, 2802c, 2802d, 2802e, 28020 may be stationary or mobile, a respective edge gateway platform 2812a, 2812b, 2812c may cooperate with other edge gateway platforms to propagate presently provided edge services, relevant service data, and security as the corresponding client compute platforms 2802a, 2802b, 2802c, 2802d, 2802e, 2802f moves about a region. To do so, the edge gateway platforms 2812a, 2812b, 2812c and/or edge aggregation platforms 2822a, 2822b may support multiple tenancy and multiple tenant configurations, in which services from (or hosted for) multiple service providers, owners, and multiple consumers may be supported and coordinated across a single or multiple compute devices.

In examples disclosed herein, edge platforms in the edge computing system 2800 includes meta-orchestration functionality. For example, edge platforms at the far-edge (e.g., edge platforms closer to edge users, the edge devices layer 2830, etc.) can reduce the performance or power consumption of orchestration tasks associated with far-edge platforms so that the execution of orchestration components at far-edge platforms consumes a small fraction of the power and performance available at far-edge platforms.

The orchestrators at various far-edge platforms participate in an end-to-end orchestration architecture. Examples disclosed herein anticipate that the comprehensive operating software framework (such as, open network automation platform (ONAP) or similar platform) will be expanded, or options created within it, so that examples disclosed herein can be compatible with those frameworks. For example, orchestrators at edge platforms implementing examples disclosed herein can interface with ONAP orchestration flows and facilitate edge platform orchestration and telemetry activities. Orchestrators implementing examples disclosed herein act to regulate the orchestration and telemetry activities that are performed at edge platforms, including increasing or decreasing the power and/or resources expended by the local orchestration and telemetry components, delegating orchestration and telemetry processes to a remote computer and/or retrieving orchestration and telemetry processes from the remote computer when power and/or resources are available.

The remote devices described above are situated at alternative locations with respect to those edge platforms that are offloading telemetry and orchestration processes. For example, the remote devices described above can be situated, by contrast, at a near-edge platforms (e.g., the network access layer 2840, the core network layer 2850, a central office, a mini-datacenter, etc.). By offloading telemetry and/or orchestration processes at a near edge platforms, an orchestrator at a near-edge platform is assured of (comparatively) stable power supply, and sufficient computational resources to facilitate execution of telemetry and/or orchestration processes. An orchestrator (e.g., operating according to a global loop) at a near-edge platform can take delegated telemetry and/or orchestration processes from an orchestrator (e.g., operating according to a local loop) at a far-edge platform. For example, if an orchestrator at a near-edge platform takes delegated telemetry and/or orchestration processes, then at some later time, the orchestrator at the near-edge platform can return the delegated telemetry and/or orchestration processes to an orchestrator at a far-edge platform as conditions change at the far-edge platform (e.g., as power and computational resources at a far-edge platform satisfy a threshold level, as higher levels of power and/or computational resources become available at a far-edge platform, etc.).

A variety of security approaches may be utilized within the architecture of the edge cloud 2810. In a multi-stakeholder environment, there can be multiple loadable security modules (LSMs) used to provision policies that enforce the stakeholder's interests including those of tenants. In some examples, other operators, service providers, etc. may have security interests that compete with the tenant's interests. For example, tenants may prefer to receive full services (e.g., provided by an edge platform) for free while service providers would like to get full payment for performing little work or incurring little costs. Enforcement point environments could support multiple LSMs that apply the combination of loaded LSM policies (e.g., where the most constrained effective policy is applied, such as where if any of A, B or C stakeholders restricts access then access is restricted). Within the edge cloud 2810, each edge entity can provision LSMs that enforce the Edge entity interests. The cloud entity can provision LSMs that enforce the cloud entity interests. Likewise, the various fog and IoT network entities can provision LSMs that enforce the fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (e.g., to identify what elements are required by the system to conduct a service, how the system responds to service conditions and changes, and the like).

Additionally, in examples disclosed herein, edge platforms and/or orchestration components thereof may consider several factors when orchestrating services and/or applications in an edge environment. These factors can include next-generation central office smart network functions virtualization and service management, improving performance per watt at an edge platform and/or of orchestration components to overcome the limitation of power at edge platforms, reducing power consumption of orchestration components and/or an edge platform, improving hardware utilization to increase management and orchestration efficiency, providing physical and/or end to end security, providing individual tenant quality of service and/or service level agreement satisfaction, improving network equipment-building system compliance level for each use case and tenant business model, pooling acceleration components, and billing and metering policies to improve an edge environment.

A “service” is a broad term often applied to various contexts, but in general, it refers to a relationship between two entities where one entity offers and performs work for the benefit of another. However, the services delivered from one entity to another must be performed with certain guidelines, which ensure trust between the entities and manage the transaction according to the contract terms and conditions set forth at the beginning, during, and end of the service.

An example relationship among services for use in an edge computing system is described below. In scenarios of edge computing, there are several services, and transaction layers in operation and dependent on each other—these services create a “service chain”. At the lowest level, ingredients compose systems. These systems and/or resources communicate and collaborate with each other in order to provide a multitude of services to each other as well as other permanent or transient entities around them. In turn, these entities may provide human-consumable services. With this hierarchy, services offered at each tier must be transactionally connected to ensure that the individual component (or sub-entity) providing a service adheres to the contractually agreed to objectives and specifications. Deviations at each layer could result in overall impact to the entire service chain.

One type of service that may be offered in an edge environment hierarchy is Silicon Level Services. For instance, Software Defined Silicon (SDSi)-type hardware provides the ability to ensure low level adherence to transactions, through the ability to intra-scale, manage and assure the delivery of operational service level agreements. Use of SDSi and similar hardware controls provide the capability to associate features and resources within a system to a specific tenant and manage the individual title (rights) to those resources. Use of such features is among one way to dynamically “bring” the compute resources to the workload.

For example, an operational level agreement and/or service level agreement could define “transactional throughput” or “timeliness”—in case of SDSi, the system and/or resource can sign up to guarantee specific service level specifications (SLS) and objectives (SLO) of a service level agreement (SLA). For example, SLOs can correspond to particular key performance indicators (KPIs) (e.g., frames per second, floating point operations per second, latency goals, etc.) of an application (e.g., service, workload, etc.) and an SLA can correspond to a platform level agreement to satisfy a particular SLO (e.g., one gigabyte of memory for 250 frames per second). SDSi hardware also provides the ability for the infrastructure and resource owner to empower the silicon component (e.g., components of a composed system that produce metric telemetry) to access and manage (add/remove) product features and freely scale hardware capabilities and utilization up and down. Furthermore, it provides the ability to provide deterministic feature assignments on a per-tenant basis. It also provides the capability to tie deterministic orchestration and service management to the dynamic (or subscription based) activation of features without the need to interrupt running services, client operations or by resetting or rebooting the system.

At the lowest layer, SDSi can provide services and guarantees to systems to ensure active adherence to contractually agreed-to service level specifications that a single resource has to provide within the system. Additionally, SDSi provides the ability to manage the contractual rights (title), usage and associated financials of one or more tenants on a per component, or even silicon level feature (e.g., SKU features). Silicon level features may be associated with compute, storage or network capabilities, performance, determinism or even features for security, encryption, acceleration, etc. These capabilities ensure not only that the tenant can achieve a specific service level agreement, but also assist with management and data collection, and assure the transaction and the contractual agreement at the lowest manageable component level.

At a higher layer in the services hierarchy, Resource Level Services, includes systems and/or resources which provide (in complete or through composition) the ability to meet workload demands by either acquiring and enabling system level features via SDSi, or through the composition of individually addressable resources (compute, storage and network). At yet a higher layer of the services hierarchy, Workflow Level Services, is horizontal, since service-chains may have workflow level requirements. Workflows describe dependencies between workloads in order to deliver specific service level objectives and requirements to the end-to-end service. These services may include features and functions like high-availability, redundancy, recovery, fault tolerance or load-leveling (we can include lots more in this). Workflow services define dependencies and relationships between resources and systems, describe requirements on associated networks and storage, as well as describe transaction level requirements and associated contracts in order to assure the end-to-end service. Workflow Level Services are usually measured in Service Level Objectives and have mandatory and expected service requirements.

At yet a higher layer of the services hierarchy, Business Functional Services (BFS) are operable, and these services are the different elements of the service which have relationships to each other and provide specific functions for the customer. In the case of Edge computing and within the example of Autonomous Driving, business functions may be composing the service, for instance, of a “timely arrival to an event”—this service would require several business functions to work together and in concert to achieve the goal of the user entity: GPS guidance, RSU (Road Side Unit) awareness of local traffic conditions, Payment history of user entity, Authorization of user entity of resource(s), etc. Furthermore, as these BFS(s) provide services to multiple entities, each BFS manages its own SLA and is aware of its ability to deal with the demand on its own resources (Workload and Workflow). As requirements and demand increases, it communicates the service change requirements to Workflow and resource level service entities, so they can, in-turn provide insights to their ability to fulfill. This step assists the overall transaction and service delivery to the next layer.

At the highest layer of services in the service hierarchy, Business Level Services (BLS), is tied to the capability that is being delivered. At this level, the customer or entity might not care about how the service is composed or what ingredients are used, managed, and/or tracked to provide the service(s). The primary objective of business level services is to attain the goals set by the customer according to the overall contract terms and conditions established between the customer and the provider at the agreed to a financial agreement. BLS(s) are comprised of several Business Functional Services (BFS) and an overall SLA.

This arrangement and other service management features described herein are designed to meet the various requirements of edge computing with its unique and complex resource and service interactions. This service management arrangement is intended to inherently address several of the resource basic services within its framework, instead of through an agent or middleware capability. Services such as: locate, find, address, trace, track, identify, and/or register may be placed immediately in effect as resources appear on the framework, and the manager or owner of the resource domain can use management rules and policies to ensure orderly resource discovery, registration and certification.

Moreover, any number of edge computing architectures described herein may be adapted with service management features. These features may enable a system to be constantly aware and record information about the motion, vector, and/or direction of resources as well as fully describe these features as both telemetry and metadata associated with the devices. These service management features can be used for resource management, billing, and/or metering, as well as an element of security. The same functionality also applies to related resources, where a less intelligent device, like a sensor, might be attached to a more manageable resource, such as an edge gateway. The service management framework is made aware of change of custody or encapsulation for resources. Since nodes and components may be directly accessible or be managed indirectly through a parent or alternative responsible device for a short duration or for its entire lifecycle, this type of structure is relayed to the service framework through its interface and made available to external query mechanisms.

Additionally, this service management framework is always service aware and naturally balances the service delivery requirements with the capability and availability of the resources and the access for the data upload the data analytics systems. If the network transports degrade, fail or change to a higher cost or lower bandwidth function, service policy monitoring functions provide alternative analytics and service delivery mechanisms within the privacy or cost constraints of the user. With these features, the policies can trigger the invocation of analytics and dashboard services at the edge ensuring continuous service availability at reduced fidelity or granularity. Once network transports are re-established, regular data collection, upload and analytics services can resume.

The deployment of a multi-stakeholder edge computing system may be arranged and orchestrated to enable the deployment of multiple services and virtual edge instances, among multiple edge platforms and subsystems, for use by multiple tenants and service providers. In a system example applicable to a cloud service provider (CSP), the deployment of an edge computing system may be provided via an “over-the-top” approach, to introduce edge computing platforms as a supplemental tool to cloud computing. In a contrasting system example applicable to a telecommunications service provider (TSP), the deployment of an edge computing system may be provided via a “network-aggregation” approach, to introduce edge computing platforms at locations in which network accesses (from different types of data access networks) are aggregated. However, these over-the-top and network aggregation approaches may be implemented together in a hybrid or merged approach or configuration.

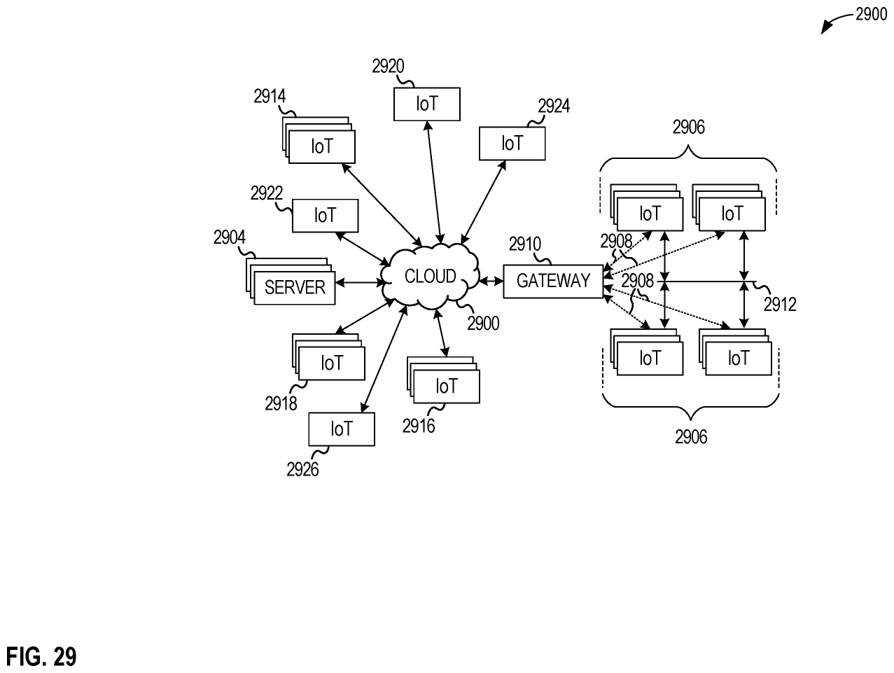

FIG. 29 illustrates a drawing of a cloud computing network, or cloud 2900, in communication with a number of Internet of Things (IoT) devices. The cloud 2900 may represent the Internet, or may be a local area network (LAN), or a wide area network (WAN), such as a proprietary network for a company. The IoT devices may include any number of different types of devices, grouped in various combinations. For example, a traffic control group 2906 may include IoT devices along streets in a city. These IoT devices may include stoplights, traffic flow monitors, cameras, weather sensors, and the like. The traffic control group 2906, or other subgroups, may be in communication with the cloud 2900 through wired or wireless links 2908, such as Low-Power Wide-Area (LPWA) links, and the like. Further, a wired or wireless sub-network 2912 may allow the IoT devices to communicate with each other, such as through a local area network, a wireless local area network, and the like. The IoT devices may use another device, such as a gateway 2910 or 2928 to communicate with remote locations such as the cloud 2900; the IoT devices may also use one or more servers 2930 to facilitate communication with the cloud 2900 or with the gateway 2910. For example, the one or more servers 2930 may operate as an intermediate network node to support a local Edge cloud or fog implementation among a local area network. Further, the gateway 2928 that is depicted may operate in a cloud-to-gateway-to-many Edge devices configuration, such as with the various IoT devices 2914, 2920, 2924 being constrained or dynamic to an assignment and use of resources in the cloud 2900.

Other example groups of IoT devices may include remote weather stations 2914, local information terminals 2916, alarm systems 2918, automated teller machines 2920, alarm panels 2922, or moving vehicles, such as emergency vehicles 2924 or other vehicles 2926, among many others. Each of these IoT devices may be in communication with other IoT devices, with servers 2904, with another IoT fog device or system, or a combination therein. The groups of IoT devices may be deployed in various residential, commercial, and industrial settings (including in both private or public environments). Advantageously, example location engines as described herein may achieve location detection of one(s) of the IoT devices of the traffic control group 2906, one(s) of the IoT devices 2914, 2916, 2918, 2920, 2922, 2924, 2926, etc., and/or a combination thereof with improved performance, improved accuracy, and/or reduced latency.

As may be seen from FIG. 29, a large number of IoT devices may be communicating through the cloud 2900. This may allow different IoT devices to request or provide information to other devices autonomously. For example, a group of IoT devices (e.g., the traffic control group 2906) may request a current weather forecast from a group of remote weather stations 2914, which may provide the forecast without human intervention. Further, an emergency vehicle 2924 may be alerted by an automated teller machine 2920 that a burglary is in progress. As the emergency vehicle 2924 proceeds towards the automated teller machine 2920, it may access the traffic control group 2906 to request clearance to the location, for example, by lights turning red to block cross traffic at an intersection in sufficient time for the emergency vehicle 2924 to have unimpeded access to the intersection.

Clusters of IoT devices, such as the remote weather stations 2914 or the traffic control group 2906, may be equipped to communicate with other IoT devices as well as with the cloud 2900. This may allow the IoT devices to form an ad-hoc network between the devices, allowing them to function as a single device, which may be termed a fog device or system (e.g., as described above with reference to FIG. 28).

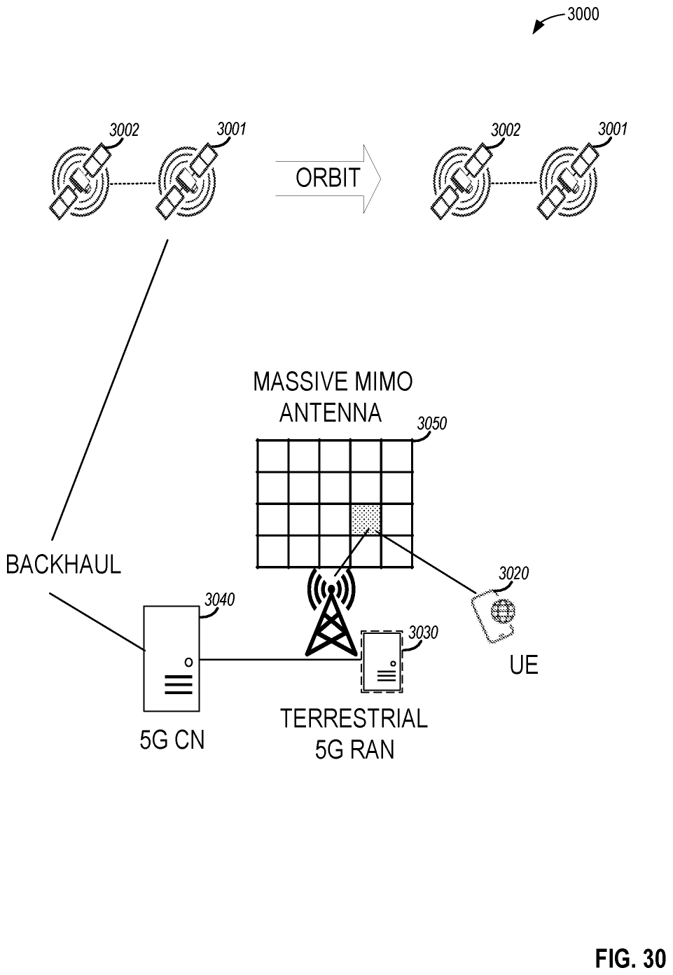

FIG. 30 illustrates network connectivity in non-terrestrial (satellite) and terrestrial (mobile cellular network) settings, according to an example. As shown, a satellite constellation (e.g., a Low Earth Orbit constellation) may include multiple satellites 3001, 3002, which are connected to each other and to one or more terrestrial networks. Specifically, the satellite constellation is connected to a backhaul network, which is in turn connected to a 5G core network 3040. The 5G core network is used to support 5G communication operations at the satellite network and at a terrestrial 5G radio access network (RAN) 3030.

FIG. 30 also depicts the use of the terrestrial 5G RAN 3030, to provide radio connectivity to a user equipment (UE) 3020 via a massive multiple input, multiple output (MIMO) antenna 3050. It will be understood that a variety of network communication components and units are not depicted in FIG. 30 for purposes of simplicity. With these basic entities in mind, the following techniques describe ways in which terrestrial and satellite networks can be extended for various Edge computing scenarios. Alternatively, the illustrated example of FIG. 30 may be applicable to other cellular technologies (e.g., 6G and the like).

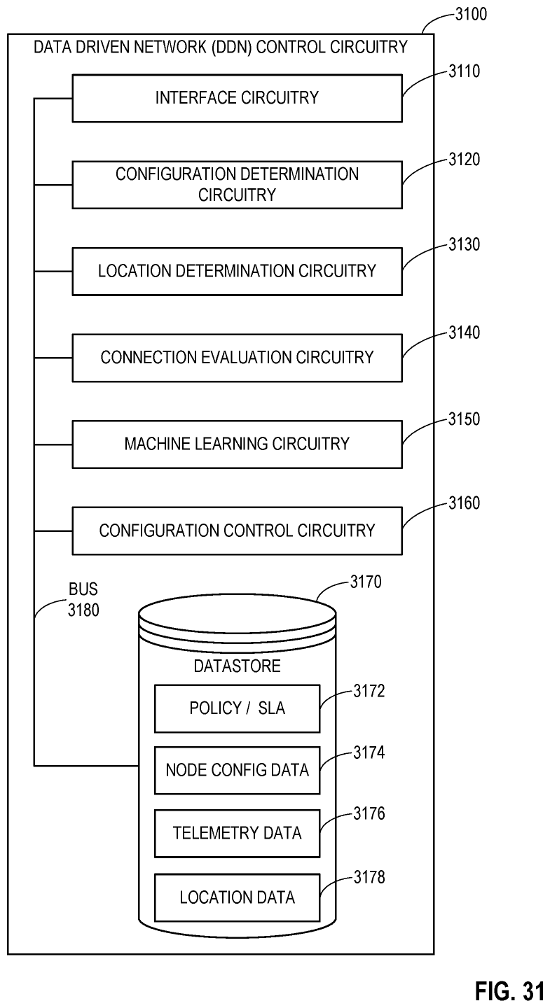

FIG. 31 is a block diagram of data driven network (DDN) control circuitry 3100 to change (e.g., dynamically change) network connections of electronic devices based on telemetry data associated with at least one of the electronic devices or a network. In some examples, the DDN control circuitry 3100 can implement the DDN control circuitry 240 of FIG. 2. In some examples, the DDN control circuitry 3100 can implement the DDNMAC 302 of FIG. 3. In some examples, the DDN control circuitry 3100 can implement the DDNMAC circuitry 402 of FIGS. 4 and/or 5. In some examples, the DDN control circuitry 3100 can implement the DDNMAC circuitry 602 of FIG. 6. In some examples, the DDN control circuitry 3100 can implement any server described herein, such as an edge server (e.g., the first edge server 702 and/or the second edge server 704 of FIG. 7), a DDN server (e.g., the DDN server 902 of FIGS. 9-1, the DDN server 1702 of FIG. 17, the DDN server 1802 of FIGS. 18-19, etc.).

The DDN control circuitry 3100 of FIG. 31 may be instantiated (e.g., creating an instance of, bring into being for any length of time, materialize, implement, etc.) by processor circuitry such as a central processing unit executing instructions. Additionally or alternatively, the DDN control circuitry 3100 of FIG. 31 may be instantiated (e.g., creating an instance of, bring into being for any length of time, materialize, implement, etc.) by an ASIC or an FPGA structured to perform operations corresponding to the instructions. It should be understood that some or all of the DDN control circuitry 3100 of FIG. 31 may, thus, be instantiated at the same or different times.

The DDN control circuitry 3100 of FIG. 31 may be instantiated (e.g., creating an instance of, bring into being for any length of time, materialize, implement, etc.) by programmable circuitry such as a Central Processor Unit (CPU) executing first instructions. Additionally or alternatively, the DDN control circuitry 3100 of FIG. 31 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 31 may, thus, be instantiated at the same or different times. Some or all of the circuitry of FIG. 31 may be instantiated, for example, in one or more threads executing concurrently on hardware and/or in series on hardware. Moreover, in some examples, some or all of the circuitry of FIG. 31 may be implemented by microprocessor circuitry executing instructions and/or FPGA circuitry performing operations to implement one or more virtual machines and/or containers. Some or all of the DDN control circuitry 3100 of FIG. 31 may be instantiated, for example, in one or more threads executing concurrently on hardware and/or in series on hardware. Moreover, in some examples, some or all of the DDN control circuitry 3100 of FIG. 31 may be implemented by one or more virtual machines and/or containers executing on the microprocessor.

The DDN control circuitry 3100 of the illustrated example includes example interface circuitry 3110, example configuration determination circuitry 3120, example location determination circuitry 3130, example connection evaluation circuitry 3140, example machine learning circuitry 3150, example configuration control circuitry 3160, an example datastore 3170, and an example bus 3180. In this example, the datastore 3170 includes an example policy and/or service level agreement (SLA) 3172, example node configuration data 3174 (identified by NODE CONFIG DATA), example telemetry data 3176, and example location data 3178.

In the illustrated example of 31, the interface circuitry 3110, the configuration determination circuitry 3120, the location determination circuitry 3130, the connection evaluation circuitry 3140, the machine learning circuitry 3150, the configuration control circuitry 3160, and/or the datastore 3170 are in communication with one(s) of each other via the bus 3180. For example, the bus 3180 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally or alternatively, the bus 3180 can be implemented by any other type of computing or electrical bus.

In the illustrated example of FIG. 31, the DDN control circuitry 3100 includes the interface circuitry 3110 to receive and/or transmit multi-spectrum, multi-modal terrestrial and/or non-terrestrial data. For example, the interface circuitry 3110 can receive data from a sensor, another electronic device such as a server, etc., using any type of communication connection technology such as 5G cellular, satellite, Wi-Fi, Bluetooth, and the like. In some examples, the interface circuitry 3110 can transmit data to a sensor, another electronic device such as a server, etc., using any type of communication connection technology such as 5G cellular, satellite, Wi-Fi, Bluetooth, and the like. In some examples, the DDN control circuitry 3100 includes means for receiving and/or means for transmitting multi-spectrum, multi-modal data. For example, the interface circuitry 3110 can implement the means for receiving and/or the means for transmitting.

In some examples, the DDN control circuitry 3100 is instantiated by programmable circuitry executing the DDN control circuitry 3100 instructions and/or configured to perform operations such as those represented by the flowchart(s) of FIGS. 32-35C.

In the illustrated example of FIG. 31, the DDN control circuitry 3100 includes the configuration determination circuitry 3120 to determine a configuration of an electronic device such as a UE. For example, the configuration determination circuitry 3120 can determine a current or instant configuration of a UE, which can include using a particular type of network connection (e.g., 5G cellular, Wi-Fi, etc.), operating parameters associated with the network connection (e.g., a bandwidth requirement, a latency requirement, etc.). In some examples, the configuration determination circuitry 3120 can determine the current/instant configuration of a UE based on telemetry data associated with the UE. In some examples, the configuration determination circuitry 3120 can determine the current/instant configuration based on a policy (e.g., a DDN policy), a service level agreement, etc., which can be the policy/SLA 3172. In some examples, the configuration determination circuitry 3120 can store the current/instant configuration of the UE as the node configuration data 3174. In some examples, the DDN control circuitry 3100 includes means for determining a configuration of an electronic device. For example, the configuration determination circuitry 3120 can implement the means for determining.

In some examples, the configuration control circuitry 3160 is instantiated by programmable circuitry executing configuration control instructions and/or configured to perform operations such as those represented by the flowchart(s) of FIGS. 32-35C.

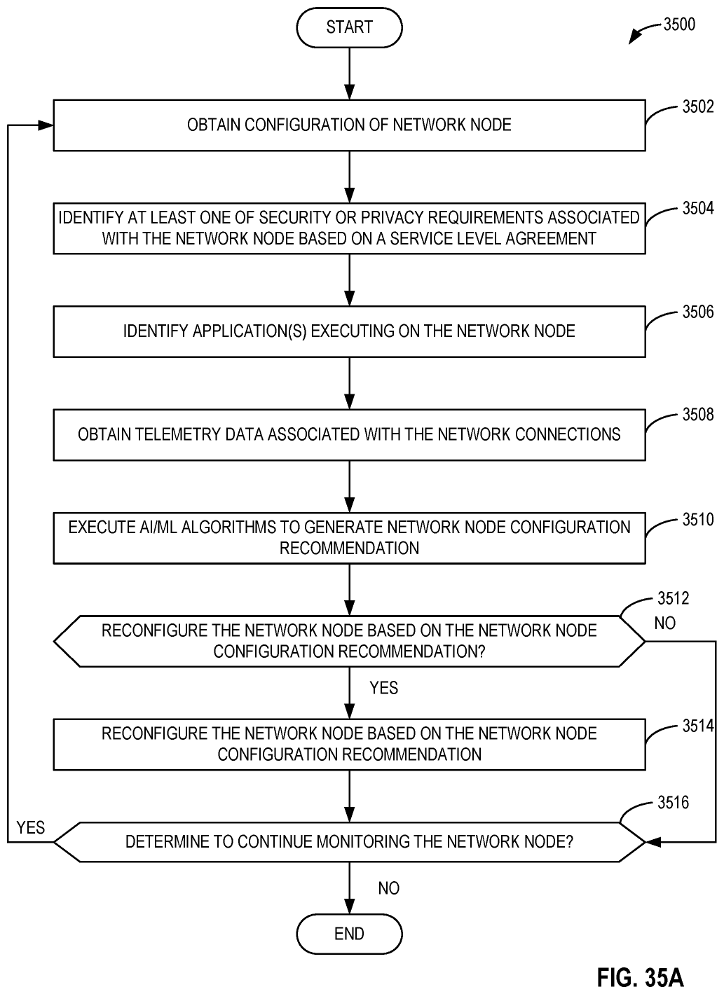

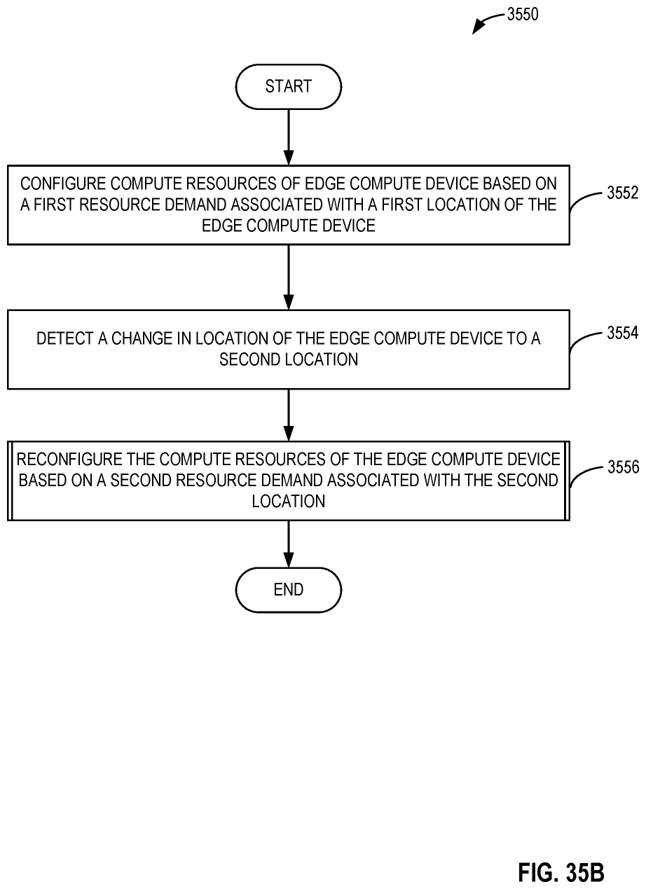

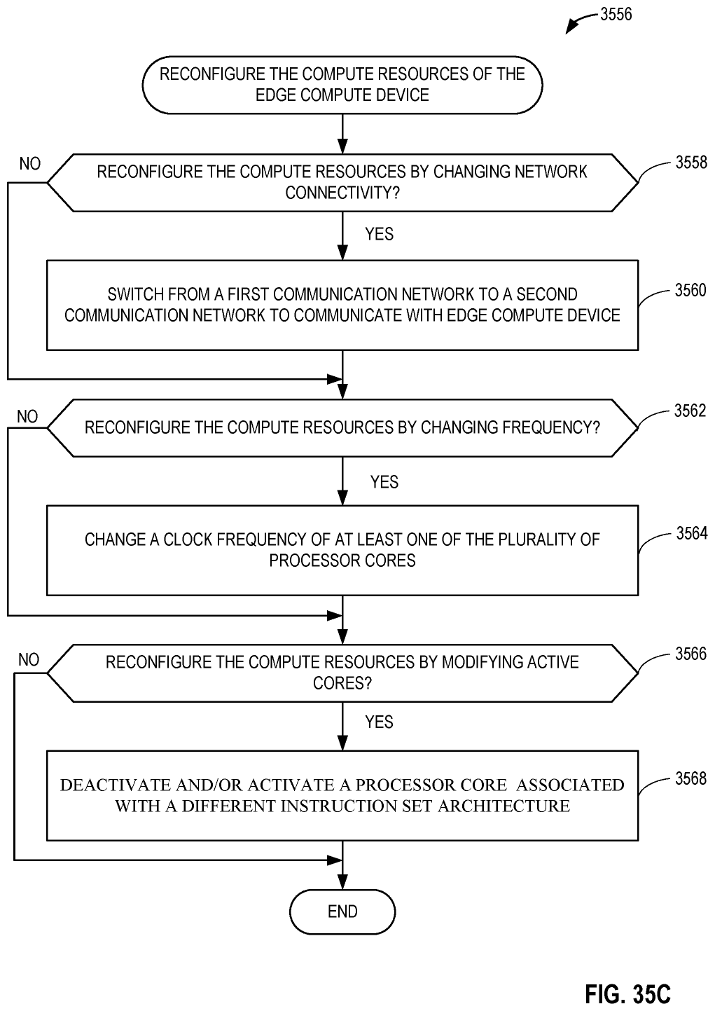

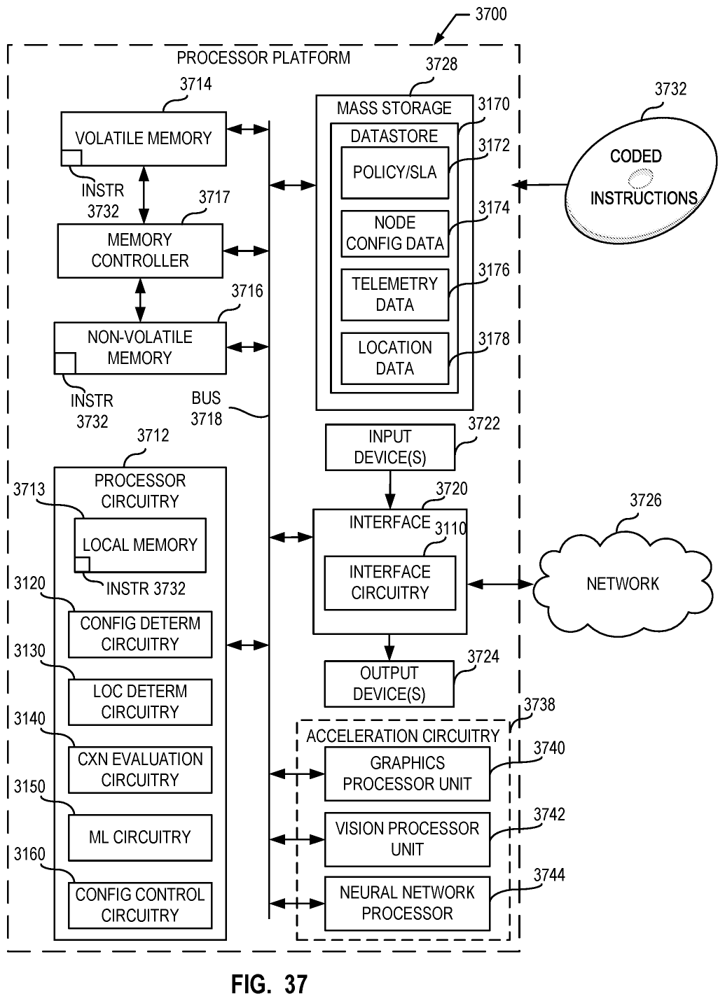

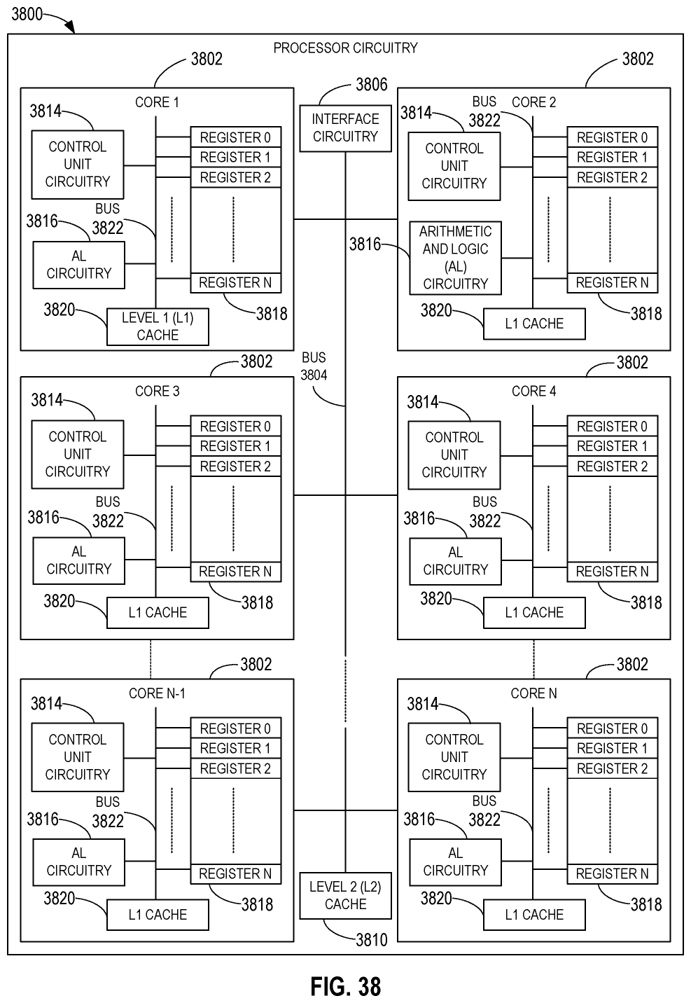

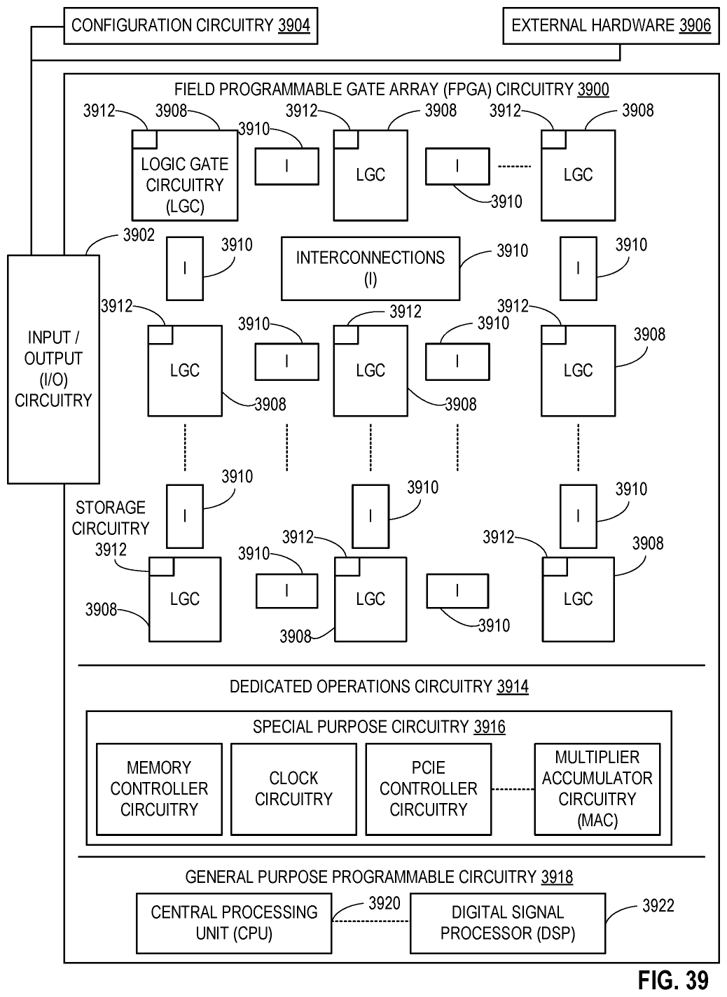

In some examples, the DDN control circuitry 3100 includes means for configuring, by executing an instruction with programmable circuitry, compute resources of the edge compute device based on a first resource demand associated with a first location of the edge compute device. For example, the means for configuring may be implemented by configuration determination circuitry 3120 and/or the configuration control circuitry 3160. In some examples, the configuration determination circuitry 3120 may be instantiated by programmable circuitry such as the example programmable circuitry 3712 of FIG. 37. For instance, the configuration determination circuitry 3120 may be instantiated by the example microprocessor 3800 of FIG. 38 executing machine executable instructions such as those implemented by at least blocks 3552 and/or 3556 of FIG. 35B. In some examples, configuration determination circuitry 3120 may be instantiated by hardware logic circuitry, which may be implemented by an ASIC, XPU, or the FPGA circuitry 3900 of FIG. 39 configured and/or structured to perform operations corresponding to the machine readable instructions. Additionally or alternatively, the configuration determination circuitry 3120 may be instantiated by any other combination of hardware, software, and/or firmware. For example, the configuration determination circuitry 3120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 31, the DDN control circuitry 3100 includes the location determination circuitry 3130 to determine a location of an electronic device. For example, the location determination circuitry 3130 can determine a location of a UE based on multi-modal, multi-spectrum data obtained from a plurality of data sources. In some examples, the location determination circuitry 3130 can store the multi-modal, multi-spectrum data as the location data 3178. In some examples, the location determination circuitry 3130 can store the location of the electronic device as the location data 3178. In some examples, the location determination circuitry 3130 can determine a location of an electronic device based on telemetry data associated with the electronic device. For example, the location determination circuitry 3130 can determine a location of a UE based on AOA data, TOA data, etc., and/or any combination(s) thereof. In some examples, the DDN control circuitry 3100 includes means for determining a location of an electronic device. For example, the location determination circuitry 3130 can implement the means for determining.

In some examples, the configuration control circuitry 3160 is instantiated by programmable circuitry executing configuration control instructions and/or configured to perform operations such as those represented by the flowchart(s) of FIGS. 32-35C.

In some examples, the DDN control circuitry 3100 includes means for detecting a change in location of the edge compute device from a first location to a second location. For example, the means for detecting the change in location may be implemented by the location determination circuitry 3130. In some examples, the location determination circuitry 3130 may be instantiated by programmable circuitry such as the example programmable circuitry 3712 of FIG. 37. For instance, the location determination circuitry 3130 may be instantiated by the example microprocessor 3800 of FIG. 38 executing machine executable instructions such as those implemented by at least blocks 3554 of FIG. 35B. In some examples, the location determination circuitry 3130 may be instantiated by hardware logic circuitry, which may be implemented by an ASIC, XPU, or the FPGA circuitry 3900 of FIG. 39 configured and/or structured to perform operations corresponding to the machine readable instructions. Additionally or alternatively, the location determination circuitry 3130 may be instantiated by any other combination of hardware, software, and/or firmware. For example, the location determination circuitry 3130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 31, the DDN control circuitry 3100 includes the connection evaluation circuitry 3140 to evaluate a connection (e.g., a communication connection, a network connection, etc.) utilized by an electronic device for data transfer. In some examples, the connection evaluation circuitry 3140 can evaluate a connection of a UE to a network based on communication and/or network quality metrics, which may include bandwidth, latency, etc. For example, the connection evaluation circuitry 3140 can evaluate the connection based on telemetry data associated with the UE, which can be stored as the telemetry data 3176. In some examples, the DDN control circuitry 3100 can, based on a first spectrum availability associated with a first location of an edge compute device, reconfigure the network resources of the edge compute device in response to detection of a change in location.

In some examples, the DDN control circuitry 3100 includes means for evaluating a connection associated with an electronic device. For example, the connection evaluation circuitry 3140 can implement the means for evaluating. In some examples, the connection evaluation circuitry 3140 is instantiated by programmable circuitry executing configuration control instructions and/or configured to perform operations such as those represented by the flowchart(s) of FIGS. 32-35C.

In some examples, the DDN control circuitry 3100 includes means for configuring network resources of an edge compute device based on a first spectrum availability associated with a first location of the edge compute device, and reconfigure the network resources of the edge compute device in response to detection of a change in location. For example, the means for configuring network resources may be implemented by connection evaluation circuitry 3140. In some examples, the connection evaluation circuitry 3140 may be instantiated by programmable circuitry such as the example programmable circuitry 3712 of FIG. 37. For instance, the connection evaluation circuitry 3140 may be instantiated by the example microprocessor 3800 of FIG. 38 executing machine executable instructions such as those implemented by at least blocks 3552 and 3556 of FIG. 35B. In some examples, the configuration control circuitry 3160 may be instantiated by hardware logic circuitry, which may be implemented by an ASIC, XPU, or the FPGA circuitry 3900 of FIG. 39 configured and/or structured to perform operations corresponding to the machine readable instructions. Additionally or alternatively, connection evaluation circuitry 3140 may be instantiated by any other combination of hardware, software, and/or firmware. For example, the connection evaluation circuitry 3140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 31, the DDN control circuitry 3100 includes the machine learning circuitry 3150 to execute and/or instantiate an AI/ML model to output an indication of whether an electronic device is to switch a type of network connection the electronic device is utilizing. For example, the machine learning circuitry 3150 can provide network environment data, telemetry data, service level agreement/policy data, etc., and/or any combination(s) thereof, as data inputs to an AI/ML model. In some examples, the machine learning circuitry 3150 can execute and/or instantiate the AI/ML model to output a recommendation indicative of an electronic device to switch from a first communication medium to a second communication medium to achieve improvements in communication and/or network quality. In some examples, the DDN control circuitry 3100 includes means for executing and/or instantiating an AI/ML model. For example, the machine learning circuitry 3150 can implement the means for executing and/or instantiating. In some examples, the configuration control circuitry 3160 is instantiated by programmable circuitry executing configuration control instructions and/or configured to perform operations such as those represented by the flowchart(s) of FIGS. 32-35C.

In some examples, the DDN control circuitry 3100 includes means for reconfiguring compute resources based on an output of a machine learning model, the machine learning model to process input telemetry data, the input telemetry data including at least one of a vendor identifier, an Internet Protocol address, or a media access control address. For example, the means for reconfiguring may be implemented by machine learning circuitry 3150. In some examples, the machine learning circuitry 3150 may be instantiated by programmable circuitry such as the example programmable circuitry 3712 of FIG. 37. For instance, the machine learning circuitry 3150 may be instantiated by the example microprocessor 3800 of FIG. 38 executing machine executable instructions such as those implemented by at least blocks 3502-3516 of FIG. 35A. In some examples, machine learning circuitry 3150 may be instantiated by hardware logic circuitry, which may be implemented by an ASIC, XPU, or the FPGA circuitry 3900 of FIG. 39 configured and/or structured to perform operations corresponding to the machine readable instructions. Additionally or alternatively, the machine learning circuitry 3150 may be instantiated by any other combination of hardware, software, and/or firmware. For example, the machine learning circuitry 3150 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 31, the DDN control circuitry 3100 includes the configuration control circuitry 3160 to control a configuration change of an electronic device. For example, the configuration control circuitry 3160 can determine based on an output from an AI/ML model that an electronic device is to switch from a first communication medium to a second communication medium. In some examples, the configuration control circuitry 3160 can transmit a command to the electronic device using the first communication medium. In some examples, in response to receiving the command, the electronic device can switch from the first communication medium to the second communication medium to achieve improvements in communication and/or network quality. In some examples, the DDN control circuitry 3100 includes means for controlling a configuration of an electronic device. For example, the configuration control circuitry 3160 can implement the means for controlling.

In some examples, the configuration control circuitry 3160 is instantiated by programmable circuitry executing configuration control instructions and/or configured to perform operations such as those represented by the flowchart(s) of FIGS. 32-35C.

In some examples, the DDN control circuitry 3100 includes means for reconfiguring, in response to detection of the change in location, the compute resources of the edge compute device based on a second resource demand associated with the second location. For example, the means for reconfiguring may be implemented configuration control circuitry 3160 and/or configuration determination circuitry 3120. In some examples, the configuration control circuitry 3160 may be instantiated by programmable circuitry such as the example programmable circuitry 3712 of FIG. 37. For instance, the configuration control circuitry 3160 may be instantiated by the example microprocessor 3800 of FIG. 38 executing machine executable instructions such as those implemented by at least blocks 3556 of FIG. 35B. In some examples, configuration control circuitry 3160 may be instantiated by hardware logic circuitry, which may be implemented by an ASIC, XPU, or the FPGA circuitry 3900 of FIG. 39 configured and/or structured to perform operations corresponding to the machine readable instructions. Additionally or alternatively, the configuration control circuitry 3160 may be instantiated by any other combination of hardware, software, and/or firmware. For example, the configuration control circuitry 3160 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the illustrated example of FIG. 31, the DDN control circuitry 3100 includes the datastore 3170 to record data, such as the policy/SLA 3172, the node configuration data 3176, the telemetry data 3178, and the location data 3178. In some examples, the DDN control circuitry 3100 includes means for storing data. For example, the datastore 3170 can implement the means for storing.

In some examples, the datastore 3170 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 3170 may additionally or alternatively be implemented by one or more double data rate (DDR) memories, such as DDR, DDR2, DDR3, DDR4, DDR5, mobile DDR (mDDR), DDR SDRAM, etc. The datastore 3170 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 3170 is illustrated as a single datastore, the datastore 3170 may be implemented by any number and/or type(s) of databases. Furthermore, the data stored in the datastore 3170 may be in any data format such as, for example, binary data, comma delimited data, tab delimited data, structured query language (SQL) structures, etc. The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list or in any other form.

While an example manner of implementing the DDN control circuitry 240 of FIG. 2, the DDNMAC 302 of FIG. 3, the DDNMAC circuitry 402 of FIGS. 4 and/or 5, the DDNMAC circuitry 602 of FIG. 6, the first edge server 702 and/or the second edge server 704 of FIG. 7, the DDN server 902 of FIGS. 9-16, the DDN server 1702 of FIG. 17, the DDN server 1802 of FIGS. 18-19, the DDN server 2102 of FIG. 21, the DDN server 2202 of FIG. 22, the DDN server 2302 of FIG. 23, and/or the DDN server 2402 of FIG. 24 is illustrated in FIG. 31, one or more of the elements, processes, and/or devices illustrated in FIG. 31 may be combined, divided, re-arranged, omitted, eliminated, and/or implemented in any other way. Further, the interface circuitry 3110, the configuration determination circuitry 3120, the location determination circuitry 3130, the connection evaluation circuitry 3140, the machine learning circuitry 3150, the configuration control circuitry 3160, and/or the datastore 3170, the bus 3180, and/or, more generally, the DDN control circuitry 240 of FIG. 2, the DDNMAC 302 of FIG. 3, the DDNMAC circuitry 402 of FIGS. 4 and/or 5, the DDNMAC circuitry 602 of FIG. 6, the first edge server 702 and/or the second edge server 704 of FIG. 7, the DDN server 902 of FIGS. 9-16, the DDN server 1702 of FIG. 17, the DDN server 1802 of FIGS. 18-19, the DDN server 2102 of FIG. 21, the DDN server 2202 of FIG. 22, the DDN server 2302 of FIG. 23, and/or the DDN server 2402 of FIG. 24, may be implemented by hardware alone or by hardware in combination with software and/or firmware. Thus, for example, any of the interface circuitry 3110, the configuration determination circuitry 3120, the location determination circuitry 3130, the connection evaluation circuitry 3140, the machine learning circuitry 3150, the configuration control circuitry 3160, and/or the datastore 3170, the bus 3180, and/or, more generally, the DDN control circuitry 240 of FIG. 2, the DDNMAC 302 of FIG. 3, the DDNMAC circuitry 402 of FIGS. 4 and/or 5, the DDNMAC circuitry 602 of FIG. 6, the first edge server 702 and/or the second edge server 704 of FIG. 7, the DDN server 902 of FIGS. 9-16, the DDN server 1702 of FIG. 17, the DDN server 1802 of FIGS. 18-19, the DDN server 2102 of FIG. 21, the DDN server 2202 of FIG. 22, the DDN server 2302 of FIG. 23, and/or the DDN server 2402 of FIG. 24, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the DDN control circuitry 240 of FIG. 2, the DDNMAC 302 of FIG. 3, the DDNMAC circuitry 402 of FIGS. 4 and/or 5, the DDNMAC circuitry 602 of FIG. 6, the first edge server 702 and/or the second edge server 704 of FIG. 7, the DDN server 902 of FIGS. 9-16, the DDN server 1702 of FIG. 17, the DDN server 1802 of FIGS. 18-19, the DDN server 2102 of FIG. 21, the DDN server 2202 of FIG. 22, the DDN server 2302 of FIG. 23, and/or the DDN server 2402 of FIG. 24 may include one or more elements, processes, and/or devices in addition to, or instead of, those illustrated in FIG. 31, and/or may include more than one of any or all of the illustrated elements, processes and devices.

Accordingly, while an example manner of implementing the DDN control circuitry of FIG. 1 is illustrated in FIGS. 2 and/or 31, one or more of the elements, processes, and/or devices illustrated in FIGS. 2 and/or 31 may be combined, divided, re-arranged, omitted, eliminated, and/or implemented in any other way. Further, the example interface circuitry 3110, the example configuration determination circuitry 3120, the example location determination circuitry 3130, the example connection evaluation circuitry 3140, the example machine learning circuitry 3150, the example configuration control circuitry 3160, the example datastore 3170, and/or, more generally, the example DDN control circuitry 240 and/or 3100 of FIGS. 2 and/or 31, may be implemented by hardware alone or by hardware in combination with software and/or firmware. Thus, for example, any of the example interface circuitry 3110, the example configuration determination circuitry 3120, the example location determination circuitry 3130, the example connection evaluation circuitry 3140, the example machine learning circuitry 3150, the example configuration control circuitry 3160, the example datastore 3170, and/or, more generally, the example DDN control circuitry 240 and/or 3100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example DDN control circuitry 240 and/or 3100 of FIGS. 2 and/or 31 may include one or more elements, processes, and/or devices in addition to, or instead of, those illustrated in FIGS. 2 and/or 31, and/or may include more than one of any or all of the illustrated elements, processes and devices.

Flowchart(s) representative of example machine readable instructions, which may be executed by programmable circuitry to implement and/or instantiate the DDN control circuitry 240 and/or 3100 of FIGS. 2 and/or 31 and/or representative of example operations which may be performed by programmable circuitry to implement and/or instantiate the DDN control circuitry 240 and/or 3100 of FIGS. 2 and/or 31, are shown in FIGS. 32-35C. The machine readable instructions may be one or more executable programs or portion(s) of one or more executable programs for execution by programmable circuitry such as the processor circuitry 3712 shown in the example processor platform 3700 discussed below in connection with FIG. 37 and/or may be one or more function(s) or portion(s) of functions to be performed by the example programmable circuitry (e.g., an FPGA) discussed below in connection with FIGS. 38 and/or 39. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 32-35C, many other methods of implementing the example DDN control circuitry 240 and/or 3100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 32-35C may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 32 is a flowchart representative of example machine readable instructions and/or example operations 3200 that may be executed and/or instantiated by processor circuitry to update a configuration of a network node. The machine readable instructions and/or the operations 3200 of FIG. 32 begin at block 3202, at which the DDN control circuitry 3100 (FIG. 31) (and/or the DDN control circuitry 240 of FIG. 2) identifies wireless connection capabilities of a network node. For example, the configuration determination circuitry 3120 (FIG. 31) can identify that an electronic device, such as a UE, has a first wireless connection capability of 5G cellular and a second wireless connection capability of Wi-Fi.

At block 3204, the DDN control circuitry 3100 configures the network node to utilize a first wireless connection capability to execute workload(s) based on strength and quality of the first wireless connection. For example, the configuration control circuitry 3160 (FIG. 31) can determine based on telemetry data associated with the UE that the UE has a stronger 5G cellular connection than a Wi-Fi connection (e.g., a Wi-Fi network may not be available, the UE is straddling a coverage area of a Wi-Fi network, etc.) based on a strength of signal or any other metric for communication and/or network quality.

At block 3206, the DDN control circuitry 3100 stores a configuration of the network node. For example, the configuration control circuitry 3160 can store an association of the UE and a 5G cellular connection in the datastore 3170 (FIG. 31) as the node configuration data 3174 (FIG. 31).

At block 3208, the DDN control circuitry 3100 obtains telemetry data from the network node. For example, the interface circuitry 3110 (FIG. 31) can receive 5G cellular data from the UE. In some examples, the interface circuitry 3110 can store the 5G cellular data, or portion(s) thereof, in the datastore 3170 as the telemetry data 3176 (FIG. 31).

At block 3210, the DDN control circuitry 3100 determines whether the first wireless connection strength and quality are below threshold(s) based on the telemetry data. For example, the connection evaluation circuitry 3140 (FIG. 31) can determine whether the 5G cellular connection strength associated with the UE is below a first threshold based on the telemetry data 3176 and/or whether the 5G cellular connection quality associated with the UE is below a second threshold based on the telemetry data 3176. In some examples, the determination is based on outputs from an AI/ML model.

If, at block 3210, the DDN control circuitry 3100 determines that the first wireless connection strength and quality are not below threshold(s) based on the telemetry data, control proceeds to block 3216. If, at block 3210, the DDN control circuitry 3100 determines that the first wireless connection strength and quality are below threshold(s) based on the telemetry data, control proceeds to block 3212. For example, the connection evaluation circuitry 3140 can determine that connection strength associated with a node is impacted by natural and/or unnatural events or conditions. In some examples, the connection evaluation circuitry 3140 can evaluate and/or otherwise determine connection strength based on signal fading loss, multipath fading, doppler and power loss of signal either transmitted or received, etc., and/or any combination(s) thereof. For example, a DDN node may be instantiated by a race car traveling at extreme speeds (e.g., 150, 200, etc., miles per hour (MPH)), and the connection evaluation circuitry 3140 may evaluate a satellite connection with the DDN node has derogated and a switch needs to happen, such as a switch to 5G cellular.

At block 3212, the DDN control circuitry 3100 instructs the network node to switch over to a second wireless connection that has improved strength and quality with respect to the first wireless connection. For example, the configuration control circuitry 3160 can instruct the UE to switch from the 5G cellular connection to the Wi-Fi connection to achieve improved connection and/or network strength and quality.

At block 3214, the DDN control circuitry 3100 updates the configuration of the network node. For example, the configuration control circuitry 3160 can update the association of the UE and the 5G cellular connection to be an association of the UE and the Wi-Fi connection. In some examples, the configuration control circuitry 3160 can store the new/updated association as the node configuration data 3174.

At block 3216, the DDN control circuitry 3100 determines whether to continue monitoring the network. For example, the interface circuitry 3110 can determine whether the UE has left a coverage area. In some examples, the interface circuitry 3100 can determine whether additional telemetry data associated with the UE has been received. If, at block 3216, the interface circuitry 3110 determines to continue monitoring the network, control returns to block 3208, otherwise the example machine readable instructions and/or the example operations 3200 of FIG. 32 conclude.

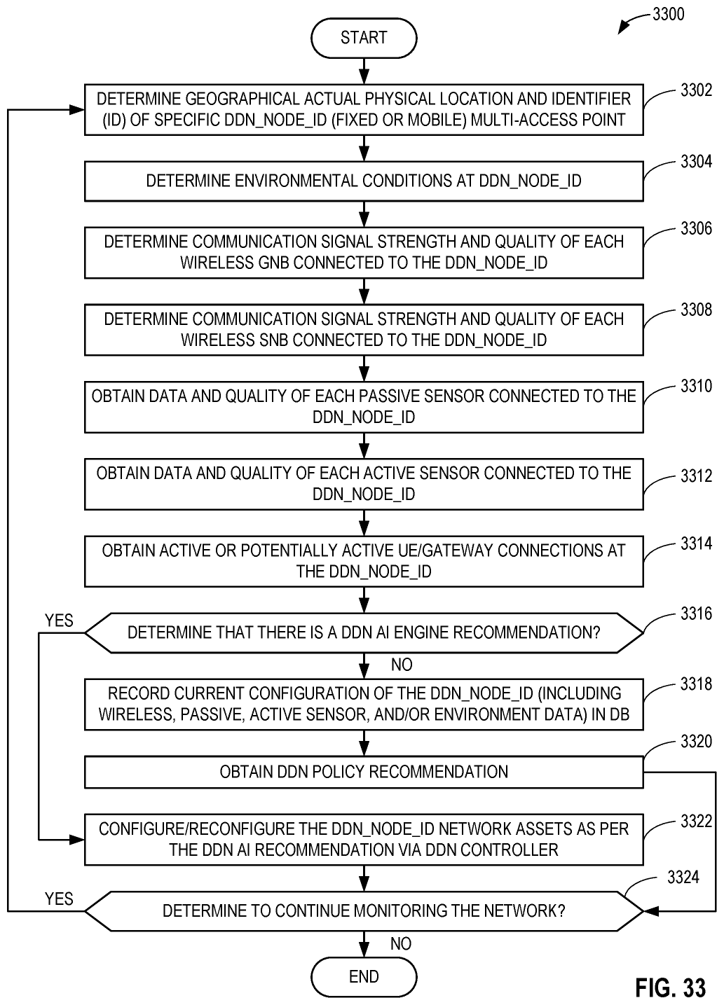

FIG. 33 is a flowchart representative of example machine readable instructions and/or example operations 3300 that may be executed and/or instantiated by processor circuitry to dynamically control network connections of electronic devices in a network. The machine readable instructions and/or the operations 3300 of FIG. 33 begin at block 3302, at which the DDN control circuitry 3100 (FIG. 31) (and/or the example DDN control circuitry 240 of FIG. 2) determines a geographical actual physical location and identifier (ID) of specific DDN_NODE_ID (fixed or mobile) multi-access point. For example, the location determination circuitry 3130 (FIG. 31) can execute an AI/ML model with AOA data, TOA data, etc., as inputs to determine a location of a DDN node (e.g., a DDN node that has an identifier) as an output from the AI/ML model. In some examples, the location determination circuitry 3130 can store the location as the location data 3178 (FIG. 31) in the datastore 3170 (FIG. 31).

At block 3304, the DDN control circuitry 3100 determines environmental conditions at the DDN_NODE_ID. For example, the machine learning circuitry 3150 (FIG. 31) can execute an AI/ML model with the telemetry data 3176 (FIG. 31), the location data 3178 (FIG. 31), and/or network environment data to determine network environment conditions at the DDN node.

At block 3306, the DDN control circuitry 3100 determines communication signal strength and quality of each wireless gNB connected to the DDN_NODE_ID. For example, the connection evaluation circuitry 3140 (FIG. 31) can determine communication signal strength and quality of each gNB in communication with the DDN node.

At block 3308, the DDN control circuitry 3100 determines communication signal strength and quality of each wireless sNB connected to the DDN_NODE_ID. For example, the connection evaluation circuitry 3140 can determine communication signal strength and quality of each sNB in communication with the DDN node.

At block 3310, the DDN control circuitry 3100 obtains data and quality of each passive sensor connected to the DDN_NODE_ID. For example, the interface circuitry 3110 (FIG. 31) can obtain data from the DDN node that corresponds to sensor data from passive sensor(s) obtained by the DDN node.

At block 3312, the DDN control circuitry 3100 obtains data and quality of each active sensor connected to the DDN_NODE_ID. For example, the interface circuitry 3110 can obtain data from the DDN node that corresponds to sensor data from active sensor(s) obtained by the DDN node.

At block 3314, the DDN control circuitry 3100 obtains active or potentially active UE/Gateway connections at the DDN_NODE_ID. For example, the interface circuitry 3110 can obtain data associated with active or potentially active UE/Gateway connections at the DDN node.

At block 3316, the DDN control circuitry 3100 determines whether there is a DDN AI engine recommendation. For example, the machine learning circuitry 3150 can execute and/or instantiate an AI/ML model to output a recommendation indicative of the DDN node to switch network connections for improved communication signal strength and/or quality.

If, at block 3316, the DDN control circuitry 3100 determines that there is not a DDN AI engine recommendation, control proceeds to block 3318. At block 3318, the DDN control circuitry 3100 records a current configuration of the DDN_NODE_ID (including wireless, passive, active sensor, and/or environment data) in a database (DB). For example, the configuration determination circuitry 3120 (FIG. 31) can store the current or instant configuration of the DDN node as the node configuration data 3174 in the datastore 3170.

At block 3320, the DDN control circuitry 3100 obtains a DDN policy recommendation. For example, the configuration determination circuitry 3120 can determine that the DDN node is to use a network connection in accordance with requirements of a DDN policy or SLA, which can include bandwidth requirements, latency requirements, throughput requirements, etc. In response to obtaining the DDN policy recommendation at block 3320, control proceeds to block 3324.

If, at block 3316, the DDN control circuitry 3100 determines that there is a DDN AI engine recommendation, control proceeds to block 3322. At block 3322, the DDN control circuitry 3100 configures/reconfigures the DDN_NODE_ID network assets as per the DDN AI recommendation via a DDN control circuitry. For example, the configuration control circuitry 3160 (FIG. 31) can transmit a command, a direction, an instruction, etc., to the DDN node to cause the DDN node to configure/reconfigure its network connections based on the DDN AI recommendation.

In response to configuring/reconfiguring the DDN_NODE_ID network assets as per the DDN AI recommendation via a DDN control circuitry at block 3322, control proceeds to block 3324. At block 3324, the DDN control circuitry 3100 determines whether to continue monitoring the network. For example, the interface circuitry 3110 can determine whether the DDN node has left a coverage area. In some examples, the interface circuitry 3110 can determine whether additional telemetry data associated with the DDN node has been received. If, at block 3324, the interface circuitry 3110 determines to continue monitoring the network, control returns to block 3302. Otherwise, the example machine readable instructions and/or the example operations 3300 of FIG. 33 conclude.

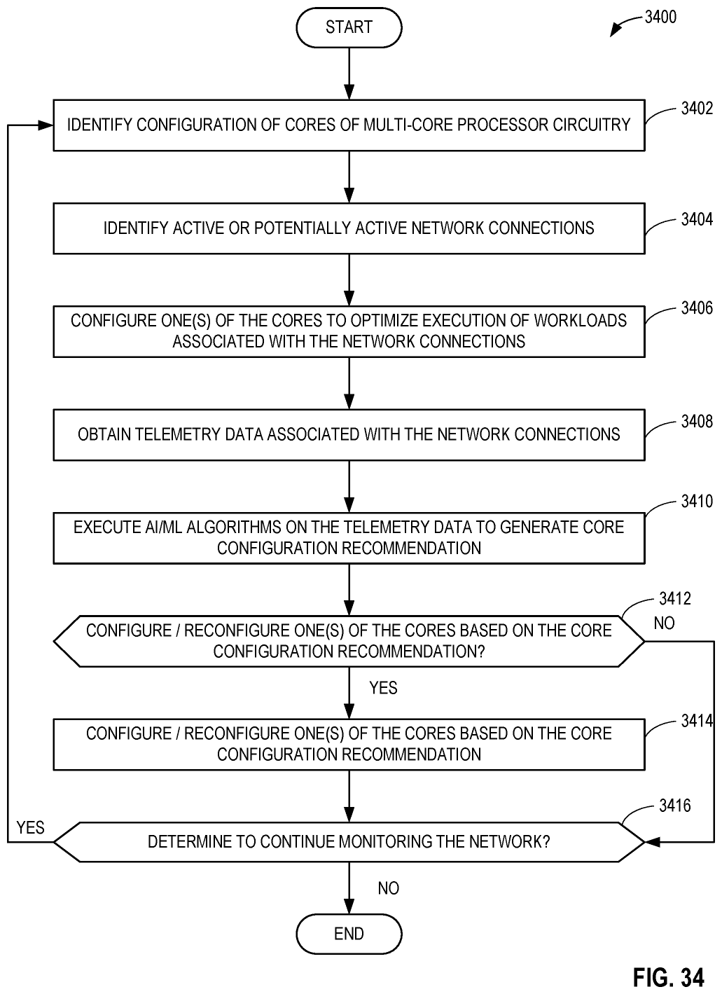

FIG. 34 is a flowchart representative of example machine readable instructions and/or example operations 3400 that may be executed and/or instantiated by processor circuitry to dimension compute resources of a server to facilitate network operation of multiple nodes. The machine readable instructions and/or the operations 3400 of FIG. 34 begin at block 3402, at which the DDN control circuitry 3100 obtains a configuration of a cores of multi-core processor circuitry. For example, the configuration determination circuitry 3120 (FIG. 31) can determine a configuration of the compute cores 408 of the DDN workload optimized processor circuitry 406 of FIG. 4. In some examples, the configuration determination circuitry 3120 can determine that a first one of the compute cores 408 is configured to execute a first type of workload using a first clock frequency and/or a first set of ISA instructions. In some examples, the configuration determination circuitry 3120 can determine that a second one of the compute cores 408 is configured to execute a second type of workload using a second clock frequency and/or a second set of ISA instructions. In some examples, the configuration determination circuitry 3120 can determine that the first one of the compute cores 408 is configured to execute a first workload for a first DDN node and the second one of the compute cores 408 is configured to execute a second workload for a second DDN node.

At block 3404, the DDN control circuitry 3100 identifies active or potentially active network connections. For example, the connection evaluation circuitry 3140 (FIG. 31) can determine whether the DDN node has one or more active connections and/or one or more potentially active network connections (e.g., a network connection that the DDN node is capable of using but is not at using it at a particular time).

At block 3406, the DDN control circuitry 3100 configures one(s) of the cores to optimize execution of workloads associated with the network connections. For example, the configuration control circuitry 3160 (FIG. 31) can change a third of the compute cores 408 from a first configuration to a second configuration to execute the first workload or a third workload. In some examples, the configuration control circuitry 3160 can change the configuration by changing a clock frequency of the third one of the compute cores 408, loading a different type of ISA instruction to execute the first workload or the third workload, etc., and/or any combination(s) thereof.

At block 3408, the DDN control circuitry 3100 obtains telemetry data associated with the network connections. For example, the interface circuitry 3110 (FIG. 31) can obtain telemetry data associated with the active network connections handled by the DDN node.

At block 3410, the DDN control circuitry 3100 executes AI/ML algorithms on the telemetry data to generate a core configuration recommendation. For example, the machine learning circuitry 3150 (FIG. 31) can execute an AI/ML model with telemetry data as model inputs to generate model outputs, which can include a recommendation to change a configuration one or more of the compute cores 408 to optimize and/or otherwise improve execution of workloads.

At block 3412, the DDN control circuitry 3100 determines whether to configure/reconfigure one(s) of the cores based on the core configuration recommendation. For example, the configuration control circuitry 3160 can determine that the recommendation from the AI/ML model is indicative of a recommendation to configure or reconfigure a configuration of one or more of the compute cores 408.

If, at block 3412, the DDN control circuitry 3100 determines not to configure/reconfigure one(s) of the cores based on the core configuration recommendation, control proceeds to block 3416. If, at block 3412, the DDN control circuitry 3100 determines to configure/reconfigure one(s) of the cores based on the core configuration recommendation, control proceeds to block 3414.

At block 3414, the DDN control circuitry 3100 configures/reconfigures one(s) of the cores based on the core configuration recommendation. For example, the configuration control circuitry 3160 can configure one or more of the cores 408 based on the core configuration recommendation.

At block 3416, the DDN control circuitry 3100 determines whether to continue monitoring the network. For example, the interface circuitry 3110 can determine whether new telemetry data associated with the DDN node has been received, the DDN node is within or has left a coverage area, etc. If, at block 3416, the DDN control circuitry 310 determines to continue monitoring the network, control returns to block 3402, otherwise the example machine readable instructions and/or the example operations 3400 of FIG. 34 conclude.

FIG. 35A is a flowchart representative of example machine readable instructions and/or example operations 3500 that may be executed and/or instantiated by processor circuitry to reconfigure a network node based on an AI/ML recommendation. The machine readable instructions and/or the operations 3500 of FIG. 35 begin at block 3502, at which the DDN control circuitry 3100 obtains a configuration of a network node. For example, the configuration determination circuitry 3120 (FIG. 31) can determine a configuration associated with a DDN node, which can include a type and/or configuration of a network connection that the DDN node is utilizing.

At block 3504, the DDN control circuitry 3100 identifies at least one of security or privacy requirements associated with the network node based on a service level agreement. For example, the configuration determination circuitry 3120 can identify whether the DDN node has privacy requirements such as opting out of a particular network connection such as 5G cellular, Bluetooth, etc., based on a service level agreement, a policy, etc.

At block 3506, the DDN control circuitry 3100 identifies application(s) executing on the network node. For example, the configuration determination circuitry 3120 can obtain a list of one or more applications, services, etc., that the DDN node is executing.

At block 3508, the DDN control circuitry 3100 obtains telemetry data associated with the network connections. For example, the interface circuitry 3110 (FIG. 31) can obtain telemetry data from the DDN node.

At block 3510, the DDN control circuitry 3100 executes AI/ML algorithms to generate a network node configuration recommendation. For example, the machine learning circuitry 3150 can execute and/or instantiate an AI/ML model to generate a network node configuration recommendation, which can include a determination that the DDN node is to switch from 5G cellular to Wi-Fi to achieve improved execution of the application(s) the DDN node is/are executing.

At block 3512, the DDN control circuitry 3100 determines whether to reconfigure the network node based on the network node configuration recommendation. For example, the configuration control circuitry 3160 can determine whether the network node configuration recommendation is indicative of a change to a network connection that the DDN node is utilizing for improved performance.

If, at block 3512, the DDN control circuitry 3100 determines not to reconfigure the network node based on the network node configuration recommendation, control proceeds to block 3516. If, at block 3512, the DDN control circuitry 3100 determines to reconfigure the network node based on the network node configuration recommendation, control proceeds to block 3514.

At block 3514, the DDN control circuitry 3100 reconfigures the network node based on the network node configuration recommendation. For example, the configuration control circuitry 3160 can send data to the DDN node to cause the DDN node to switch from 5G cellular to Wi-Fi to achieve improved performance.

At block 3516, the DDN control circuitry 3100 determines whether to continue monitoring the network node. For example, the interface circuitry 3110 can determine whether new telemetry data associated with the DDN node has been received, the DDN node is within or has left a coverage area, etc. If, at block 3516, the DDN control circuitry 310 determines to continue monitoring the network node, control returns to block 3502, otherwise the example machine readable instructions and/or the example operations 3500 of FIG. 35A conclude.

FIG. 35B is a flowchart representative of example machine readable instructions and/or example operations 3550 that may be executed and/or instantiated by processor circuitry to configure and/or reconfigure a network node. The machine readable instructions and/or the operations 3550 of FIG. 35 begin at block 3552, at which the configuration determination circuitry 3120 configures compute resources of an edge compute device based on a first resource demand associated with a first location of the edge compute device. For example, an edge node (e.g., a GNodeB, a mobile server, etc.) may be reconfigured (e.g., reconfigure compute, reconfigure wireless connectivity, etc.) based on a first demand (e.g., a first quantity of UEs requesting resources from the edge compute device) and a first location (e.g., a first geographic location). The reconfiguration may be performed by creating and/or modifying a slice of the edge compute device, wherein the slice is a virtual network instance that is executed by the edge compute device. Each slice may allocate resources (e.g., radio bandwidth, processing power, memory, wireless communication type) for one or more devices, applications, workloads, etc., associated with and/or being executed on the edge compute device.

Slicing of the edge compute device allows multiple services, UEs, applications, etc., to share the physical infrastructure of the edge compute device. Slicing provides improved flexibility and scalability of the edge compute device, as each slice may be tailored to the specific needs of UEs, applications, services, etc., that have requested resources from the edge compute device. The DDN control circuitry 3100 may self-configure and/or receive configuration instructions to prioritize some resource requests and/or allocate additional resources to a slice. Configuration of the edge compute device (e.g., a first edge compute device) may also involve communication with a second edge compute device to provide capabilities beyond that of the first edge compute device alone.

At block 3554, the example location determination circuitry 3130 detects a change in location of the edge compute device to a second location. For example, the location determination circuitry 3130 may determine a distance from a wireless communication tower has increased, which may result in reduced wireless connectivity for one or more UEs. Such information may be provided by the location determination circuitry 3130 and/or the configuration determination circuitry 3120 to change a configuration of the edge compute device to provide enhanced capabilities to the UE or to a terrestrial satellite.

In some examples, the location determination circuitry 3130 may determine a physical location that is associated with increased network congestion. That is, in an area with many UEs and/or other devices (e.g., a busy downtown, an airport, an area with many IoT sensors, etc.) that request resources from the edge compute device, the edge compute device may provide increased power and/or bandwidth (e.g., reconfigure the edge compute device to increase processing and/or network capabilities) to satisfy the demand. That is, rather than being overwhelmed by the increased density of UEs in or near the second location, leading to slower speeds and poorer connectivity, the edge compute device can allocated increased resources to satisfy the demand. The configuration determination circuitry 3120 may also determine a change in location and reallocate resources (e.g., increase resource capabilities) based on an analysis of the geographic topography of the location (e.g., an obstruction that can affect connectivity).

At block 3556, the DDN control circuitry 3100 reconfigures the compute resource of the edge compute device based on a second resource demand associated with the second location. For example, a slice can be reconfigured to allocate resources, such as CPU, memory, and storage, based a change in resource demand associated with the second location. The configuration determination circuitry 3120, the machine learning circuitry 3150, the configuration control circuitry 3160, and/or more generally any portion of the DDN control circuitry 3100 may change a network configuration, change an IP address, change processing capabilities, change an operating system for a slice of the virtual machine (VM), launch a container, install or remove software, change system settings, apply an update, etc., in response to the second resource demand associated with the second location. In some examples, the edge compute device and/or any processor circuitry associated with the edge compute device may instantiate additional virtual partitions (e.g., with related resources and settings) that can be provided to satisfy the demand associated with the second location.

The edge compute device may, for example, reconfigure the compute resources based on an output of a machine learning model, the machine learning model to process input telemetry data, the input telemetry data including at least one of a vendor identifier, an Internet Protocol address, or a media access control address. In some examples, interface circuitry 3110, the configuration determination circuitry 3120, and/or the machine learning circuitry 3150 may collect telemetry data associated with a resource demand, the telemetry data including: a timestamp associated with the first resource demand, a number of compute cores assigned to the first resource demand, or network communication metrics associated with the first resource demand.

The reconfiguration may include launching a slice, creating a clone of a slice, deployment of additional VMs, etc. In some examples, the configuration control circuitry 3160 may reconfigure the compute resources to adjust a wireless capability of the edge compute device (e.g., modify a Wi-Fi connection, a cellular connection, a Bluetooth connection, etc.). For example, the DDN control circuitry 3100 may enable and/or disable a network adapter, a modem, and/or any communication/interface circuitry. The connection evaluation circuitry 3140 may also obtain telemetry data including a communication signal strength associated with an electronic device in communication with the edge compute device and cause, based on the telemetry data, the electronic device to switch from a first communication network to a second communication network to communicate with the edge compute device. Therefore, the configuration determination circuitry 3120, configuration control circuitry 3160 and/or configuration determination circuitry 3120 may evaluate a network strength (e.g., determine signal strength and quality), as well as evaluate other factors such as network congestion and network interference. In some examples, the connection evaluation circuitry 3140 may also prioritize networks based on quality of service requirements, etc.

The instructions 3550 end. However, additional instances of the instructions 3550 can be executed in response to, for example, a subsequent change in location and/or change in demand. As an illustrative example of the instructions 3550 in action, an electric vehicle may be equipped with an edge server executing the instructions 3550. The edge server may include the DDN control circuitry 3100 to, for example, control a wireless hotspot to provide network access, provide compute capabilities to devices within our outside of the electric vehicle, etc. Thus, the electric vehicle may execute the instructions 3552 to configure compute resources of the edge compute device and provide resources to endpoint devices (e.g., UEs proximate to the vehicle). The electric vehicle may change location, such as when a driver of the electric vehicle drives to a new geographic location. Then, the DDN control circuitry 3100 can then reconfigure the compute resources of the edge compute device based on the second location and/or change in resource demand associated with the second location. For example, a server of the electric vehicle could reconfigure a VM executing on the server to provide additional resources (e.g., a web server, a database server, wireless networking capabilities) to UEs that come into range of the moving electric vehicle. The resource demand may be associated with any combination of devices within or outside of the electric vehicle (e.g., any device on the electric vehicle's network).

FIG. 35C is a flowchart representative of example machine readable instructions and/or example operations 3556 to reconfigure the compute resources of the edge compute device. The machine readable instructions and/or the operations 3556 of FIG. 35C begin at block 3558, at which the configuration control circuitry 3160 determines if the DDN control circuitry 3100 is to reconfigure the compute resources by changing network connectivity. If so, the instructions continue at block 3560, at which the connection evaluation circuitry 3140 switches from a first communication network to a second communication network to communicate with edge compute device.

Otherwise, the instructions continue at block 3562, at which the configuration determination circuitry 3120 determines if the DDN control circuitry 3100 is to reconfigure the compute resources by changing a frequency of the processor circuitry. If so, at block 3564 the configuration control circuitry 3160 changes a clock frequency of at least one of the plurality of processor cores. If not, control continues to block 3566 at which the configuration determination circuitry 3120 determines if it is to reconfigure the compute resources by modifying active cores.

At block 3566, the DDN control circuitry 3100 determines if it is to reconfigure the compute resources by modifying active cores. If so, control continues at block 3568 at which the configuration control circuitry 3160 deactivates and/or activates a processor core associated with an instruction set architecture that is different than a first instruction set architecture. For example, the DDN control circuitry 3100 may deactivate a first one of the plurality of processor cores, the first one of the plurality of processor cores associated with a first instruction set architecture (ISA) and activate a second one of the plurality of processor cores, the second one of the plurality of processor cores associated with a second ISA different than the first ISA. The instructions end.

FIG. 36 is a block diagram of an example of components that may be present in an IoT device 3650 for implementing the techniques described herein. In some examples, the IoT device 3650 may implement the DDN control circuitry 3100 of FIG. 31. The IoT device 3650 may include any combinations of the components shown in the example or referenced in the disclosure above. The components may be implemented as ICs, portions thereof, discrete electronic devices, or other modules, logic, hardware, software, firmware, or a combination thereof adapted in the IoT device 3650, or as components otherwise incorporated within a chassis of a larger system. Additionally, the block diagram of FIG. 36 is intended to depict a high-level view of components of the IoT device 3650. However, some of the components shown may be omitted, additional components may be present, and different arrangement of the components shown may occur in other implementations.

The IoT device 3650 may include processor circuitry in the form of, for example, a processor 3652, which may be a microprocessor, a multi-core processor, a multithreaded processor, an ultra-low voltage processor, an embedded processor, or other known processing elements. The processor 3652 may be a part of a system on a chip (SoC) in which the processor 3652 and other components are formed into a single integrated circuit, or a single package, such as the Edison™ or Galileo™ SoC boards from Intel. As an example, the processor 3652 may include an Intel® Architecture Core™ based processor, such as a Quark™, an Atom™, an i3, an i5, an i7, or an microcontroller (MCU)-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc.

The processor 3652 may communicate with a system memory 3654 over an interconnect 3656 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 3658 may also couple to the processor 3652 via the interconnect 3656. In an example the storage 3658 may be implemented via a solid state disk drive (SSDD). Other devices that may be used for the storage 3658 include flash memory cards, such as SD cards, microSD cards, xD picture cards, and the like, and USB flash drives. In low power implementations, the storage 3658 may be on-die memory or registers associated with the processor 3652. However, in some examples, the storage 3658 may be implemented using a micro hard disk drive (HDD). Further, any number of new technologies may be used for the storage 3658 in addition to, or instead of, the technologies described, such resistance change memories, phase change memories, holographic memories, or chemical memories, among others.

The components may communicate over the interconnect 3656. The interconnect 3656 may include any number of technologies, including industry standard architecture (ISA), extended ISA (EISA), peripheral component interconnect (PCI), peripheral component interconnect extended (PCIx), PCI express (PCIe), or any number of other technologies. The interconnect 3656 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 3662, 3666, 3668, or 3670. Accordingly, in various examples, applicable means for communicating (e.g., receiving, transmitting, etc.) may be embodied by such communications circuitry.

The interconnect 3656 may couple the processor 3652 to a mesh transceiver 3662, for communications with other mesh devices 3664. The mesh transceiver 3662 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 3664. For example, a wireless local area network (WLAN) unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The mesh transceiver 3662 may communicate using multiple standards or radios for communications at different range. For example, the IoT device 3650 may communicate with close devices, e.g., within about 10 meters, using a local transceiver based on BLE, or another low power radio, to save power. More distant mesh devices 3664, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 3666 may be included to communicate with devices or services in the cloud 3600 via local or wide area network protocols. The wireless network transceiver 3666 may be a LPWA transceiver that follows the IEEE 802.15.4, or IEEE 802.15.4g standards, among others. The IoT device 3650 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 3662 and wireless network transceiver 3666, as described herein. For example, the radio transceivers 3662 and 3666 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 3662 and 3666 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 3666, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 3668 may be included to provide a wired communication to the cloud 3600 or to other devices, such as the mesh devices 3664. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 3668 may be included to allow connect to a second network, for example, a NIC 3668 providing communications to the cloud over Ethernet, and a second NIC 3668 providing communications to other devices over another type of network.

The interconnect 3656 may couple the processor 3652 to an external interface 3670 that is used to connect external devices or subsystems. The external devices may include sensors 3672, such as accelerometers, level sensors, flow sensors, optical light sensors, camera sensors, temperature sensors, a global positioning system (GPS) sensors, pressure sensors, barometric pressure sensors, and the like. The external interface 3670 further may be used to connect the IoT device 3650 to actuators 3674, such as power switches, valve actuators, an audible sound generator, a visual warning device, and the like.

In some optional examples, various input/output (I/O) devices may be present within, or connected to, the IoT device 3650. For example, a display or other output device 3684 may be included to show information, such as sensor readings or actuator position. An input device 3686, such as a touch screen or keypad may be included to accept input. An output device 3684 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 3650.

A battery 3676 may power the IoT device 3650, although in examples in which the IoT device 3650 is mounted in a fixed location, it may have a power supply coupled to an electrical grid. The battery 3676 may be a lithium ion battery, or a metal-air battery, such as a zinc-air battery, an aluminum-air battery, a lithium-air battery, and the like.

A battery monitor/charger 3678 may be included in the IoT device 3650 to track the state of charge (SoCh) of the battery 3676. The battery monitor/charger 3678 may be used to monitor other parameters of the battery 3676 to provide failure predictions, such as the state of health (SoH) and the state of function (SoF) of the battery 3676. The battery monitor/charger 3678 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 3678 may communicate the information on the battery 3676 to the processor 3652 over the interconnect 3656. The battery monitor/charger 3678 may also include an analog-to-digital (ADC) convertor that allows the processor 3652 to directly monitor the voltage of the battery 3676 or the current flow from the battery 3676. The battery parameters may be used to determine actions that the IoT device 3650 may perform, such as transmission frequency, mesh network operation, sensing frequency, and the like.

A power block 3680, or other power supply coupled to a grid, may be coupled with the battery monitor/charger 3678 to charge the battery 3676. In some examples, the power block 3680 may be replaced with a wireless power receiver to obtain the power wirelessly, for example, through a loop antenna in the IoT device 3650. A wireless battery charging circuit, such as an LTC4020 chip from Linear Technologies of Milpitas, Calif., among others, may be included in the battery monitor/charger 3678. The specific charging circuits chosen depends on the size of the battery 3676, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 3658 may include instructions 3682 in the form of software, firmware, or hardware commands to implement the techniques described herein. Although such instructions 3682 are shown as code blocks included in the memory 3654 and the storage 3658, it may be understood that any of the code blocks may be replaced with hardwired circuits, for example, built into an application specific integrated circuit (ASIC).

In an example, the instructions 3682 provided via the memory 3654, the storage 3658, or the processor 3652 may be embodied as a non-transitory, machine readable medium 3660 including code to direct the processor 3652 to perform electronic operations in the IoT device 3650. The processor 3652 may access the non-transitory, machine readable medium 3660 over the interconnect 3656. For instance, the non-transitory, machine readable medium 3660 may be embodied by devices described for the storage 3658 of FIG. 36 or may include specific storage units such as optical disks, flash drives, or any number of other hardware devices. The non-transitory, machine readable medium 3660 may include instructions to direct the processor 3652 to perform a specific sequence or flow of actions, for example, as described with respect to the flowchart(s) and block diagram(s) of operations and functionality depicted above.

Also in a specific example, the instructions 3682 on the processor 3652 (separately, or in combination with the instructions 3682 of the machine readable medium 3660) may configure execution or operation of a trusted execution environment (TEE) 3690. In an example, the TEE 3690 operates as a protected area accessible to the processor 3652 for secure execution of instructions and secure access to data. Various implementations of the TEE 3690, and an accompanying secure area in the processor 3652 or the memory 3654 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the IoT device 3650 through the TEE 3690 and the processor 3652.

FIG. 37 is a block diagram of an example programmable circuitry platform 3700 structured to execute and/or instantiate the example machine-readable instructions and/or the example operations of FIGS. 32-35C to implement the DDN control circuitry 3100 of FIGS. 2 and/or 31. The programmable circuitry platform 3700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 3700 of the illustrated example includes programmable circuitry 3712. The programmable circuitry 3712 of the illustrated example is hardware. For example, the programmable circuitry 3712 can be implemented by one or more integrated circuits, logic circuits, FPGAs, microprocessors, CPUs, GPUs, DSPs, and/or microcontrollers from any desired family or manufacturer. The programmable circuitry 3712 may be implemented by one or more semiconductor based (e.g., silicon based) devices. In this example, the programmable circuitry 3712 implements the configuration determination circuitry 3120 (identified by CONFIG DETERM CIRCUITRY), the location determination circuitry 3130 (identified by LOC DETERM CIRCUITRY), the connection evaluation circuitry 3140 (identified by CXN EVALUATION CIRCUITRY), the machine learning circuitry 3150 (identified by ML CIRCUITRY), and the configuration control circuitry 3160 (identified by CONFIG CONTROL CIRCUITRY) of FIG. 31.

The programmable circuitry 3712 of the illustrated example includes a local memory 3713 (e.g., a cache, registers, etc.). The programmable circuitry 3712 of the illustrated example is in communication with main memory 3714, 3716, which includes a volatile memory 3714 and a non-volatile memory 3716, by a bus 3718. The volatile memory 3714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 3716 may be implemented by flash memory and/or any other desired type of memory device. Access to the main memory 3714, 3716 of the illustrated example is controlled by a memory controller 3717. In some examples, the memory controller 3717 may be implemented by one or more integrated circuits, logic circuits, microcontrollers from any desired family or manufacturer, or any other type of circuitry to manage the flow of data going to and from the main memory 3714, 3716.

The programmable circuitry platform 3700 of the illustrated example also includes interface circuitry 3720. The interface circuitry 3720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 3722 are connected to the interface circuitry 3720. The input device(s) 3722 permit(s) a user (e.g., a human user, a machine user, etc.) to enter data and/or commands into the programmable circuitry 3712. The input device(s) 3722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 3724 are also connected to the interface circuitry 3720 of the illustrated example. The output device(s) 3724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 3720 of the illustrated example, thus, typically includes a graphics driver card, a graphics driver chip, and/or graphics processor circuitry such as a GPU.

The interface circuitry 3720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 3726. The communication can be by, for example, an Ethernet connection, a digital subscriber line (DSL) connection, a telephone line connection, a coaxial cable system, a satellite system, a beyond-line-of-site wireless system, a line-of-site wireless system, a cellular telephone system, an optical connection, etc.

The programmable circuitry platform 3700 of the illustrated example also includes one or more mass storage devices 3728 to store software and/or data. In this example, the one or more mass storage devices 3728 implement the datastore 3170 of FIG. 31, which includes the policy/SLA 3172, the node configuration data 3174, the telemetry data 3176, and the location data 3178 of FIG. 31. Examples of such mass storage devices 3728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 3732, which may be implemented by the machine readable instructions of FIGS. 32-35C, may be stored in the mass storage device 3728, in the volatile memory 3714, in the non-volatile memory 3716, and/or on at least one non-transitory computer readable storage medium such as a CD or DVD which may be removable.

The programmable circuitry platform 3700 of the illustrated example of FIG. 37 includes example acceleration circuitry 3738, which includes an example graphics processing unit (GPU) 3740, an example vision processing unit (VPU) 3742, and an example neural network processor 3744. In this example, the GPU 3740, the VPU 3742, and the neural network processor 3744 are in communication with different hardware of the processor platform 3700, such as the volatile memory 3714, the non-volatile memory 3716, etc., via the bus 3718. In this example, the neural network processor 3744 may be implemented by one or more integrated circuits, logic circuits, microprocessors, GPUs, DSPs, or controllers from any desired family or manufacturer that can be used to execute an AI model, such as a neural network. In some examples, one or more of the configuration determination circuitry 3120, the location determination circuitry 3130, the connection evaluation circuitry 3140, the machine learning circuitry 3150, and/or the configuration control circuitry 3160 can be implemented in or with at least one of the GPU 3740, the VPU 3742, or the neural network processor 3744 instead of or in addition to the processor circuitry 3712.

FIG. 38 is a block diagram of an example implementation of the programmable circuitry 3712 of FIG. 37. In this example, the programmable circuitry 3712 of FIG. 37 is implemented by a microprocessor 3800. For example, the microprocessor 3800 may be a general-purpose microprocessor (e.g., general-purpose microprocessor circuitry). The microprocessor 3800 executes some or all of the machine-readable instructions of the flowcharts of FIGS. 32-35C to effectively instantiate the DDN control circuitry 3100 of FIGS. 2 and/or 31 as logic circuits to perform operations corresponding to those machine readable instructions. In some such examples, the DDN control circuitry 3100 of FIG. 31 is instantiated by the hardware circuits of the microprocessor 3800 in combination with the machine-readable instructions. For example, the microprocessor 3800 may be implemented by multi-core hardware circuitry such as a CPU, a DSP, a GPU, an XPU, etc. Although it may include any number of example cores 3802 (e.g., 1 core), the microprocessor 3800 of this example is a multi-core semiconductor device including N cores. The cores 3802 of the microprocessor 3800 may operate independently or may cooperate to execute machine readable instructions. For example, machine code corresponding to a firmware program, an embedded software program, or a software program may be executed by one of the cores 3802 or may be executed by multiple ones of the cores 3802 at the same or different times. In some examples, the machine code corresponding to the firmware program, the embedded software program, or the software program is split into threads and executed in parallel by two or more of the cores 3802. The software program may correspond to a portion or all of the machine readable instructions and/or operations represented by the flowcharts of FIGS. 32-35C.

The cores 3802 may communicate by a first example bus 3804. In some examples, the first bus 3804 may be implemented by a communication bus to effectuate communication associated with one(s) of the cores 3802. For example, the first bus 3804 may be implemented by at least one of an Inter-Integrated Circuit (I2C) bus, a Serial Peripheral Interface (SPI) bus, a PCI bus, or a PCIe bus. Additionally or alternatively, the first bus 3804 may be implemented by any other type of computing or electrical bus. The cores 3802 may obtain data, instructions, and/or signals from one or more external devices by example interface circuitry 3806. The cores 3802 may output data, instructions, and/or signals to the one or more external devices by the interface circuitry 3806. Although the cores 3802 of this example include example local memory 3820 (e.g., Level 1 (L1) cache that may be split into an L1 data cache and an L1 instruction cache), the microprocessor 3800 also includes example shared memory 3810 that may be shared by the cores (e.g., Level 2 (L2 cache)) for high-speed access to data and/or instructions. Data and/or instructions may be transferred (e.g., shared) by writing to and/or reading from the shared memory 3810. The local memory 3820 of each of the cores 3802 and the shared memory 3810 may be part of a hierarchy of storage devices including multiple levels of cache memory and the main memory (e.g., the main memory 3714, 3716 of FIG. 37). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 3802 may be referred to as a CPU, DSP, GPU, etc., or any other type of hardware circuitry. Each core 3802 includes control unit circuitry 3814, arithmetic and logic (AL) circuitry (sometimes referred to as an ALU) 3816, a plurality of registers 3818, the local memory 3820, and a second example bus 3822. Other structures may be present. For example, each core 3802 may include vector unit circuitry, single instruction multiple data (SIMD) unit circuitry, load/store unit (LSU) circuitry, branch/jump unit circuitry, floating-point unit (FPU) circuitry, etc. The control unit circuitry 3814 includes semiconductor-based circuits structured to control (e.g., coordinate) data movement within the corresponding core 3802. The AL circuitry 3816 includes semiconductor-based circuits structured to perform one or more mathematic and/or logic operations on the data within the corresponding core 3802. The AL circuitry 3816 of some examples performs integer based operations. In other examples, the AL circuitry 3816 also performs floating-point operations. In yet other examples, the AL circuitry 3816 may include first AL circuitry that performs integer-based operations and second AL circuitry that performs floating-point operations. In some examples, the AL circuitry 3816 may be referred to as an Arithmetic Logic Unit (ALU).

The registers 3818 are semiconductor-based structures to store data and/or instructions such as results of one or more of the operations performed by the AL circuitry 3816 of the corresponding core 3802. For example, the registers 3818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 3818 may be arranged in a bank as shown in FIG. 38. Alternatively, the registers 3818 may be organized in any other arrangement, format, or structure, such as by being distributed throughout the core 3802 to shorten access time. The second bus 3822 may be implemented by at least one of an I2C bus, a SPI bus, a PCI bus, or a PCIe bus.

Each core 3802 and/or, more generally, the microprocessor 3800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 3800 is a semiconductor device fabricated to include many transistors interconnected to implement the structures described above in one or more integrated circuits (ICs) contained in one or more packages.

The microprocessor 3800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 3800, in the same chip package as the microprocessor 3800 and/or in one or more separate packages from the microprocessor 3800.

FIG. 39 is a block diagram of another example implementation of the programmable circuitry 3712 of FIG. 37. In this example, the programmable circuitry 3712 is implemented by FPGA circuitry 3900. For example, the FPGA circuitry 3900 may be implemented by an FPGA. The FPGA circuitry 3900 can be used, for example, to perform operations that could otherwise be performed by the example microprocessor 3800 of FIG. 38 executing corresponding machine readable instructions. However, once configured, the FPGA circuitry 3900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 3800 of FIG. 38 described above (which is a general purpose device that may be programmed to execute some or all of the machine readable instructions represented by the flowchart(s) of FIGS. 32-35C but whose interconnections and logic circuitry are fixed once fabricated), the FPGA circuitry 3900 of the example of FIG. 39 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 32-35. In particular, the FPGA circuitry 3900 may be thought of as an array of logic gates, interconnections, and switches. The switches can be programmed to change how the logic gates are interconnected by the interconnections, effectively forming one or more dedicated logic circuits (unless and until the FPGA circuitry 3900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 32-35C. As such, the FPGA circuitry 3900 may be configured and/or structured to effectively instantiate some or all of the operations/functions corresponding to the machine readable instructions of the flowchart(s) of FIGS. 32-35C as dedicated logic circuits to perform the operations/functions corresponding to those software instructions in a dedicated manner analogous to an ASIC. Therefore, the FPGA circuitry 3900 may perform the operations/functions corresponding to the some or all of the machine readable instructions of FIGS. 32-35C faster than the general-purpose microprocessor can execute the same.

In the example of FIG. 39, the FPGA circuitry 3900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 3900 of FIG. 39 may access and/or load the binary file to cause the FPGA circuitry 3900 of FIG. 39 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 3900 of FIG. 39 to cause configuration and/or structuring of the FPGA circuitry 3900 of FIG. 39, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 3900 of FIG. 39 may access and/or load the binary file to cause the FPGA circuitry 3900 of FIG. 39 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 3900 of FIG. 39 to cause configuration and/or structuring of the FPGA circuitry 3900 of FIG. 39, or portion(s) thereof.

The FPGA circuitry 3900 of FIG. 39, includes example input/output (I/O) circuitry 3902 to obtain and/or output data to/from example configuration circuitry 3904 and/or external hardware 3906. For example, the configuration circuitry 3904 may be implemented by interface circuitry that may obtain a binary file, which may be implemented by a bit stream, data, and/or machine-readable instructions, to configure the FPGA circuitry 3900, or portion(s) thereof. In some such examples, the configuration circuitry 3904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 3906 may be implemented by external hardware circuitry. For example, the external hardware 3906 may be implemented by the microprocessor 3800 of FIG. 38.

The FPGA circuitry 3900 also includes an array of example logic gate circuitry 3908, a plurality of example configurable interconnections 3910, and example storage circuitry 3912. The logic gate circuitry 3908 and the configurable interconnections 3910 are configurable to instantiate one or more operations/functions that may correspond to at least some of the machine readable instructions of FIGS. 32-35C and/or other desired operations. The logic gate circuitry 3908 shown in FIG. 39 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 3908 to enable configuration of the electrical structures and/or the logic gates to form circuits to perform desired operations/functions. The logic gate circuitry 3908 may include other electrical structures such as look-up tables (LUTs), registers (e.g., flip-flops or latches), multiplexers, etc.

The configurable interconnections 3910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 3908 to program desired logic circuits.

The storage circuitry 3912 of the illustrated example is structured to store result(s) of the one or more of the operations performed by corresponding logic gates. The storage circuitry 3912 may be implemented by registers or the like. In the illustrated example, the storage circuitry 3912 is distributed amongst the logic gate circuitry 3908 to facilitate access and increase execution speed.

The example FPGA circuitry 3900 of FIG. 39 also includes example dedicated operations circuitry 3914. In this example, the dedicated operations circuitry 3914 includes special purpose circuitry 3916 that may be invoked to implement commonly used functions to avoid the need to program those functions in the field. Examples of such special purpose circuitry 3916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 3900 may also include example general purpose programmable circuitry 3918 such as an example CPU 3920 and/or an example DSP 3922. Other general purpose programmable circuitry 3918 may additionally or alternatively be present such as a GPU, an XPU, etc., that can be programmed to perform other operations.

Although FIGS. 38 and 39 illustrate two example implementations of the programmable circuitry 3712 of FIG. 37, many other approaches are contemplated. For example, FPGA circuitry may include an on-board CPU, such as one or more of the example CPU 3920 of FIG. 38. Therefore, the programmable circuitry 3712 of FIG. 37 may additionally be implemented by combining at least the example microprocessor 3800 of FIG. 38 and the example FPGA circuitry 3900 of FIG. 39. In some such hybrid examples, one or more cores 3802 of FIG. 38 may execute a first portion of the machine readable instructions represented by the flowchart(s) of FIGS. 32-35C to perform first operation(s)/function(s), the FPGA circuitry 3900 of FIG. 39 may be configured and/or structured to perform second operation(s)/function(s) corresponding to a second portion of the machine readable instructions represented by the flowcharts of FIG. 32-35C, and/or an ASIC may be configured and/or structured to perform third operation(s)/function(s) corresponding to a third portion of the machine readable instructions represented by the flowcharts of FIGS. 32-35C.

It should be understood that some or all of the circuitry of FIGS. 2 and/or 31 may, thus, be instantiated at the same or different times. For example, same and/or different portion(s) of the microprocessor 3800 of FIG. 38 may be programmed to execute portion(s) of machine-readable instructions at the same and/or different times. In some examples, same and/or different portion(s) of the FPGA circuitry 3900 of FIG. 39 may be configured and/or structured to perform operations/functions corresponding to portion(s) of machine-readable instructions at the same and/or different times.

In some examples, some or all of the circuitry of FIGS. 2 and/or 31 may be instantiated, for example, in one or more threads executing concurrently and/or in series. For example, the microprocessor 3800 of FIG. 38 may execute machine readable instructions in one or more threads executing concurrently and/or in series. In some examples, the FPGA circuitry 3900 of FIG. 39 may be configured and/or structured to carry out operations/functions concurrently and/or in series. Moreover, in some examples, some or all of the circuitry of FIGS. 2 and/or 31 may be implemented within one or more virtual machines and/or containers executing on the microprocessor 3800 of FIG. 38.

In some examples, the programmable circuitry 3712 of FIG. 37 may be in one or more packages. For example, the microprocessor 3800 of FIG. 38 and/or the FPGA circuitry 3900 of FIG. 39 may be in one or more packages. In some examples, an XPU may be implemented by the programmable circuitry 3712 of FIG. 37, which may be in one or more packages. For example, the XPU may include a CPU (e.g., the microprocessor 3800 of FIG. 38, the CPU 3920 of FIG. 39, etc.) in one package, a DSP (e.g., the DSP 3922 of FIG. 39) in another package, a GPU in yet another package, and an FPGA (e.g., the FPGA circuitry 3900 of FIG. 39) in still yet another package.

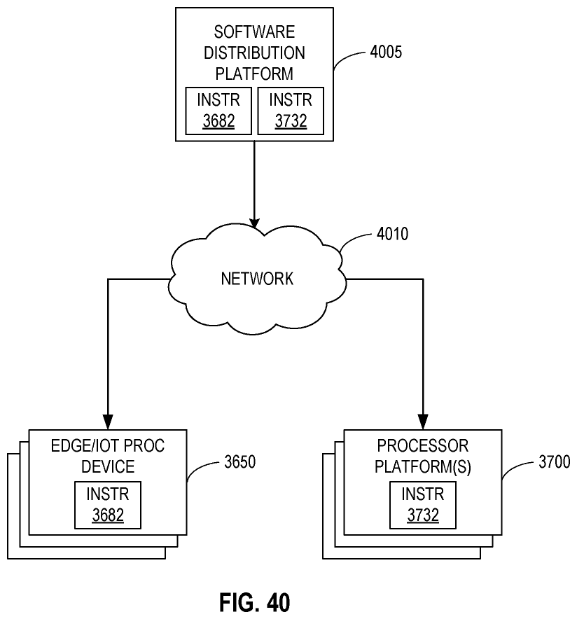

A block diagram illustrating an example software distribution platform 4005 to distribute software such as the example machine readable instructions 3732 of FIG. 37 to other hardware devices (e.g., hardware devices owned and/or operated by third parties from the owner and/or operator of the software distribution platform) is illustrated in FIG. 40. The example software distribution platform 4005 may be implemented by any computer server, data facility, cloud service, etc., capable of storing and transmitting software to other computing devices. The third parties may be customers of the entity owning and/or operating the software distribution platform 4005. For example, the entity that owns and/or operates the software distribution platform 4005 may be a developer, a seller, and/or a licensor of software such as the example machine readable instructions 3732 of FIG. 37. The third parties may be consumers, users, retailers, OEMs, etc., who purchase and/or license the software for use and/or re-sale and/or sub-licensing. In the illustrated example, the software distribution platform 4005 includes one or more servers and one or more storage devices. The storage devices store the machine readable instructions 3732, which may correspond to the example machine readable instructions of FIGS. 32-35C, as described above. The one or more servers of the example software distribution platform 4005 are in communication with an example network 4010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 3732 from the software distribution platform 4005. For example, the software, which may correspond to the example machine readable instructions of FIG. 32-35C, may be downloaded to the example programmable circuitry platform 3700, which is to execute the machine readable instructions 3732 to implement the DDN control circuitry 3100 of FIGS. 2 and/or 31. In some examples, one or more servers of the software distribution platform 4005 periodically offer, transmit, and/or force updates to the software (e.g., the example machine readable instructions 3732 of FIG. 37) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed for data driven networking. Disclosed systems, methods, apparatus, and articles of manufacture collect network node environmental and multi-access usage telemetry in substantially real-time based on real-world utilization. In some examples, that telemetry along with connection status and health of UE/gateways is fed to AI/ML models resulting in either new or existing DDN node profile with associated DDN instance sufficient to address any network degradations. Disclosed systems, methods, apparatus, and articles of manufacture reconfigure the DDN control planes and/or DDN nodes to address constrains at the physical location of the network node.

Disclosed systems, methods, apparatus, and articles of manufacture improve the efficiency of using a computing device by achieving improved network utilization. Disclosed systems, methods, apparatus, and articles of manufacture improve the efficiency of using a computing device by moving or activating radios (e.g., 5G radios) based on environmental conditions to avoid service gaps caused by congestion or outage. Disclosed systems, methods, apparatus, and articles of manufacture are accordingly directed to one or more improvement(s) in the operation of a machine such as a computer or other electronic and/or mechanical device.

It is noted that this patent claims priority from International Patent Application Number PCT/CN2022/082979, which was filed on Mar. 25, 2022, and is hereby incorporated by reference in its entirety.

Example methods, apparatus, systems, and articles of manufacture for data driven networking are disclosed herein. Further examples and combinations thereof include the following:

Example 1 includes a method comprising obtaining telemetry data associated with an electronic device, and causing the electronic device to switch from a first communication network to a second communication network based on the telemetry data.

In Example 2, the subject matter of Example 1 can optionally include identifying wireless connection capabilities of the electronic device.

In Example 3, the subject matter of Examples 1-2 can optionally include configuring the electronic device to utilize the first communication network based on a strength and/or quality of the first communication network.

In Example 4, the subject matter of Examples 1-3 can optionally include storing a configuration of the electronic device, the configuration including an association of the electronic device and at least one of the first communication network or the second communication network.

In Example 5, the subject matter of Examples 1-4 can optionally include determining that the first communication network has at least one of a connection strength that is below a first threshold or a connection quality that is below a second threshold.

In Example 6, the subject matter of Examples 1-5 can optionally include in response to determining that at least one of the first threshold or the second threshold are satisfied, instruct the electronic device to switch from the first communication network to the second communication network.

In Example 7, the subject matter of Examples 1-6 can optionally include that the second communication network has improved communication strength and quality with respect to the first communication network.

In Example 8, the subject matter of Examples 1-7 can optionally include that the first communication network is a fifth generation (5G) cellular network and the second communication network is a Wireless Fidelity (Wi-Fi network).

In Example 9, the subject matter of Examples 1-8 can optionally include updating the configuration of the electronic device in response to the switch to the second communication network, the configuration to be stored in a datastore.

In Example 10, the subject matter of Examples 1-9 can optionally include determining a geographical actual physical location and/or identifier of the electronic device based on the telemetry data.

In Example 11, the subject matter of Examples 1-10 can optionally include determining network environmental conditions associated with the electronic device.

In Example 12, the subject matter of Examples 1-11 can optionally include determining a communication signal strength and quality of one or more wireless gNodeBs in communication with the electronic device.

In Example 13, the subject matter of Examples 1-12 can optionally include determining a communication signal strength and quality of one or more wireless sNodeBs in communication with the electronic device.

In Example 14, the subject matter of Examples 1-13 can optionally include obtaining data and/or data quality of one or more sensors in communication with the electronic device.

In Example 15, the subject matter of Examples 1-14 can optionally include determining active and/or potentially active UE or gateways in communication with the electronic device.

In Example 16, the subject matter of Examples 1-15 can optionally include executing and/or instantiating a machine learning model to generate an output based on the telemetry data.

In Example 17, the subject matter of Examples 1-16 can optionally include that the output includes a recommendation or a determination for the electronic device to switch from the first to the second communication network.

In Example 18, the subject matter of Examples 1-17 can optionally include identifying a configuration of cores of multi-core processor circuitry.

In Example 19, the subject matter of Examples 1-18 can optionally include configuring ones of the cores of the multi-core processor circuitry to optimize and/or otherwise improve execution of workloads associated with the second communication network.

In Example 20, the subject matter of Examples 1-19 can optionally include outputting, with the machine learning model, a determination indicative of configuring the ones of the multi-core processor circuitry.

In Example 21, the subject matter of Examples 1-20 can optionally include that the configuring of the ones of the cores of the multi-core processor circuitry includes changing a clock frequency of the ones of the cores or a set of Instruction Set Architecture (ISA) instructions for which the ones of the cores are to load.

In Example 21, the subject matter of Examples 1-20 can optionally include that the telemetry data includes a vendor identifier, an Internet Protocol (IP) address, a media access control (MAC) address, a serial number, a certificate, Sounding Reference Signal (SRS) parameters associated with the electronic device.

Example 22 is at least one computer readable medium comprising instructions to perform the method of any of Examples 1-21.

Example 23 is edge server processor circuitry to perform the method of any of Examples 1-21.

Example 24 is an edge cloud processor circuitry to perform the method of any of Examples 1-21.

Example 25 is edge node processor circuitry to perform the method of any of Examples 1-21.

Example 26 is location engine circuitry to perform the method of any of Examples 1-21.

Example 27 is an apparatus comprising processor circuitry to perform the method of any of Examples 1-21.

Example 28 is an apparatus comprising one or more edge gateways to perform the method of any of Examples 1-21.

Example 29 is an apparatus comprising one or more edge switches to perform the method of any of Examples 1-21.

Example 30 is an apparatus comprising at least one of one or more edge gateways or one or more edge switches to perform the method of any of Examples 1-21.

Example 31 is an apparatus comprising accelerator circuitry to perform the method of any of Examples 1-21.

Example 32 is an apparatus comprising one or more graphics processor units to perform the method of any of Examples 1-21.

Example 33 is an apparatus comprising one or more Artificial Intelligence processors to perform the method of any of Examples 1-21.

Example 34 is an apparatus comprising one or more machine learning processors to perform the method of any of Examples 1-21.

Example 35 is an apparatus comprising one or more neural network processors to perform the method of any of Examples 1-21.

Example 36 is an apparatus comprising one or more digital signal processors to perform the method of any of Examples 1-21.

Example 37 is an apparatus comprising one or more general purpose processors to perform the method of any of Examples 1-21.

Example 38 is an apparatus comprising network interface circuitry to perform the method of any of Examples 1-21.

Example 39 is an Infrastructure Processor Unit to perform the method of any of Examples 1-21.

Example 40 is hardware queue management circuitry to perform the method of any of Examples 1-21.

Example 41 is at least one of remote radio unit circuitry or radio access network circuitry to perform the method of any of Examples 1-21.

Example 42 is base station circuitry to perform the method of any of Examples 1-21.

Example 43 is user equipment circuitry to perform the method of any of Examples 1-21.

Example 44 is an Internet of Things device to perform the method of any of Examples 1-21.

Example 45 is a software distribution platform to distribute machine-readable instructions that, when executed by processor circuitry, cause the processor circuitry to perform the method of any of Examples 1-21.

Example 46 is edge cloud circuitry to perform the method of any of Examples 1-21.

Example 47 is distributed unit circuitry to perform the method of any of Examples 1-21.

Example 48 is control unit circuitry to perform the method of any of Examples 1-21.

Example 49 is core server circuitry to perform the method of any of Examples 1-21.

Example 50 is satellite circuitry to perform the method of any of Examples 1-21.

Example 51 is at least one of one more GEO satellites or one or more LEO satellites to perform the method of any of Examples 1-21.

Example 52 includes an edge compute device comprising interface circuitry, machine readable instructions, and programmable circuitry to execute the machine readable instructions to configure compute resources of the edge compute device based on a first resource demand associated with a first location of the edge compute device, detect a change in location of the edge compute device to a second location, and in response to the detection of the change in location, reconfigure the compute resources of the edge compute device based on a second resource demand associated with the second location.

Example 53 includes the edge compute device of any of the previous examples, wherein the programmable circuitry is to configure network resources of the edge compute device based on a first spectrum availability associated with the first location of the edge compute device, and reconfigure the network resources of the edge compute device in response to the detection of the change in location.

Example 54 includes the edge compute device of any of the previous examples, wherein the edge compute device is a mobile edge compute device included in a network of edge compute devices, the network of edge compute devices including at least one stationary compute device.

Example 55 includes the edge compute device of any of the previous examples, wherein the programmable circuitry is to configure the compute resources of the edge compute device responsive to an input from another one of the edge compute devices, the input based on a third resource demand.

Example 56 includes the edge compute device of any of the previous examples, wherein the programmable circuitry is to reconfigure the compute resources based on an output of a machine learning model, the machine learning model to process input telemetry data, the input telemetry data including at least one of a vendor identifier, an Internet Protocol address, or a media access control address.

Example 57 includes the edge compute device of any of the previous examples, wherein the programmable circuitry is to execute a virtual machine to reconfigure the compute resources.

Example 58 includes the edge compute device of any of the previous examples, wherein the programmable circuitry is to collect telemetry data associated with the first resource demand, the telemetry data including a timestamp associated with the first resource demand, a number of compute cores assigned to the first resource demand, and network communication metrics associated with the first resource demand.

Example 59 includes the edge compute device of any of the previous examples, wherein the compute resources include a plurality of processor cores, and to reconfigure the compute resources, the programmable circuitry is to change a clock frequency of at least one of the plurality of processor cores.

Example 60 includes the edge compute device of any of the previous examples, wherein to reconfigure the compute resources based on the second resource demand, the programmable circuitry is to deactivate a first one of the plurality of processor cores, the first one of the plurality of processor cores associated with a first instruction set architecture (ISA), and activate a second one of the plurality of processor cores, the second one of the plurality of processor cores associated with a second ISA different than the first ISA.

Example 61 includes the edge compute device of any of the previous examples, wherein the programmable circuitry is to obtain telemetry data including a communication signal strength associated with an electronic device in communication with the edge compute device, and cause, based on the telemetry data, the electronic device to switch from a first communication network to a second communication network to communicate with the edge compute device.

Example 62 includes a machine readable storage medium comprising instructions to cause programmable circuitry to at least configure compute resources of an edge compute device based on a first resource demand associated with a first location of the edge compute device, detect a change in location of the edge compute device to a second location, and in response to detection of the change in location, reconfigure the compute resources of the edge compute device based on a second resource demand associated with the second location.

Example 63 includes the machine readable storage medium of any of the previous examples, wherein the instructions are to cause the programmable circuitry to configure network resources of the edge compute device based on a first spectrum availability associated with the first location of the edge compute device, and reconfigure the network resources of the edge compute device in response to the detection of the change in location.

Example 64 includes the machine readable storage medium of any of the previous examples, wherein the edge compute device is a mobile edge compute device included in a network of edge compute devices, the network of edge compute devices including at least one stationary compute device.

Example 65 includes the machine readable storage medium of any of the previous examples, wherein the instructions are to cause the programmable circuitry to configure the compute resources of the edge compute device responsive to an input from another one of the edge compute devices, the input based on a third resource demand.

Example 66 includes the machine readable storage medium of any of the previous examples, wherein the instructions are to cause the programmable circuitry to reconfigure the compute resources based on an output of a machine learning model, the machine learning model to process input telemetry data, the input telemetry data including at least one of a vendor identifier, an Internet Protocol address, or a media access control address.

Example 67 includes the machine readable storage medium of any of the previous examples, wherein the instructions are to cause the programmable circuitry to execute a virtual machine to reconfigure the compute resources.

Example 68 includes the machine readable storage medium of any of the previous examples, wherein the instructions are to cause the programmable circuitry to collect telemetry data associated with the first resource demand, the telemetry data including a timestamp associated with the first resource demand, a number of compute cores assigned to the first resource demand, and network communication metrics associated with the first resource demand.

Example 69 includes the machine readable storage medium of any of the previous examples, wherein the compute resources include a plurality of processor cores, and to reconfigure the compute resources, the programmable circuitry is to change a clock frequency of at least one of the plurality of processor cores.

Example 70 includes the machine readable storage medium of any of the previous examples, wherein to reconfigure the compute resources based on the second resource demand, the instructions are to cause the programmable circuitry to deactivate a first one of the plurality of processor cores, the first one of the plurality of processor cores associated with a first instruction set architecture (ISA), and activate a second one of the plurality of processor cores, the second one of the plurality of processor cores associated with a second ISA different than the first ISA.

Example 71 includes the machine readable storage medium of any of the previous examples, wherein the instructions are to cause the programmable circuitry to obtain telemetry data including a communication signal strength associated with an electronic device in communication with the edge compute device, and cause, based on the telemetry data, the electronic device to switch from a first communication network to a second communication network to communicate with the edge compute device.

In any of the previous examples, the machine readable storage medium may be a non-transitory machine readable storage medium.

Example 72 includes a method comprising configuring, by executing an instruction with programmable circuitry, compute resources of an edge compute device based on a first resource demand associated with a first location of the edge compute device, detecting, by executing an instruction with the programmable circuitry, a change in location of the edge compute device to a second location, and reconfiguring, by executing an instruction with the programmable circuitry in response to detection of the change in location, the compute resources of the edge compute device based on a second resource demand associated with the second location.

Example 73 includes the method of any of the previous examples, further including configuring network resources of the edge compute device based on a first spectrum availability associated with the first location of the edge compute device, and reconfiguring the network resources of the edge compute device in response to the detection of the change in location.

Example 74 includes the method of any of the previous examples, wherein the edge compute device is a mobile edge compute device included in a network of edge compute devices, the network of edge compute devices including at least one stationary compute device.

Example 75 includes the method of any of the previous examples, further including configuring the compute resources of the edge compute device responsive to an input from another one of the edge compute devices, the input based on a third resource demand.

Example 76 includes the method of any of the previous examples, further including reconfiguring the compute resources based on an output of a machine learning model, the machine learning model to process input telemetry data, the input telemetry data including at least one of a vendor identifier, an Internet Protocol address, or a media access control address.

Example 77 includes the method of any of the previous examples, further including executing a virtual machine to reconfigure the compute resources.

Example 78 includes the method of any of the previous examples, further including, further including collecting telemetry data associated with the first resource demand, the telemetry data including a timestamp associated with the first resource demand, a number of compute cores assigned to the first resource demand, and network communication metrics associated with the first resource demand.

Example 79 includes the method of any of the previous examples, wherein the compute resources include a plurality of processor cores, and to reconfigure the compute resources, the programmable circuitry is to change a clock frequency of at least one of the plurality of processor cores.

Example 80 includes the method of any of the previous examples, further including deactivating a first one of the plurality of processor cores, the first one of the plurality of processor cores associated with a first instruction set architecture (ISA), and activating a second one of the plurality of processor cores, the second one of the plurality of processor cores associated with a second ISA different than the first ISA.

Example 81 includes the method of any of the previous examples, further including obtaining telemetry data including a communication signal strength associated with an electronic device in communication with the edge compute device, and causing, based on the telemetry data, the electronic device to switch from a first communication network to a second communication network to communicate with the edge compute device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An edge compute device comprising:
interface circuitry;
machine readable instructions; and
programmable circuitry to execute the machine readable instructions to:
configure compute resources of the edge compute device based on a first resource demand associated with a first location of the edge compute device;
detect a change in location of the edge compute device to a second location; and
in response to the detection of the change in location, reconfigure the compute resources of the edge compute device based on a second resource demand associated with the second location.

2. The edge compute device of claim 1, wherein the programmable circuitry is to:
configure network resources of the edge compute device based on a first spectrum availability associated with the first location of the edge compute device; and
reconfigure the network resources of the edge compute device in response to the detection of the change in location.

3. The edge compute device of claim 1, wherein the edge compute device is a mobile edge compute device included in a network of edge compute devices, the network of edge compute devices including at least one stationary compute device.

4. The edge compute device of claim 3, wherein the programmable circuitry is to configure the compute resources of the edge compute device responsive to an input from another one of the edge compute devices, the input based on a third resource demand.

5. The edge compute device of claim 1, wherein the programmable circuitry is to reconfigure the compute resources based on an output of a machine learning model, the machine learning model to process input telemetry data, the input telemetry data including at least one of a vendor identifier, an Internet Protocol address, or a media access control address.

6. The edge compute device of claim 1, wherein the programmable circuitry is to execute a virtual machine to reconfigure the compute resources.

7. The edge compute device of claim 1, wherein the programmable circuitry is to collect telemetry data associated with the first resource demand, the telemetry data including:
a timestamp associated with the first resource demand;
a number of compute cores assigned to the first resource demand; and
network communication metrics associated with the first resource demand.

8-10. (canceled)

11. A non-transitory machine readable storage medium comprising instructions to cause programmable circuitry to at least:
configure compute resources of an edge compute device based on a first resource demand associated with a first location of the edge compute device;
detect a change in location of the edge compute device to a second location; and
in response to detection of the change in location, reconfigure the compute resources of the edge compute device based on a second resource demand associated with the second location.

12. The non-transitory machine readable storage medium of claim 11, wherein the instructions are to cause the programmable circuitry to:
configure network resources of the edge compute device based on a first spectrum availability associated with the first location of the edge compute device; and
reconfigure the network resources of the edge compute device in response to the detection of the change in location.

13. The non-transitory machine readable storage medium of claim 11, wherein the edge compute device is a mobile edge compute device included in a network of edge compute devices, the network of edge compute devices including at least one stationary compute device.

14. The non-transitory machine readable storage medium of claim 13, wherein the instructions are to cause the programmable circuitry to configure the compute resources of the edge compute device responsive to an input from another one of the edge compute devices, the input based on a third resource demand.

15. The non-transitory machine readable storage medium of claim 11, wherein the instructions are to cause the programmable circuitry to reconfigure the compute resources based on an output of a machine learning model, the machine learning model to process input telemetry data, the input telemetry data including at least one of a vendor identifier, an Internet Protocol address, or a media access control address.

16. The non-transitory machine readable storage medium of claim 11, wherein the instructions are to cause the programmable circuitry to execute a virtual machine to reconfigure the compute resources.

17. The non-transitory machine readable storage medium of claim 11, wherein the instructions are to cause the programmable circuitry to collect telemetry data associated with the first resource demand, the telemetry data including:
a timestamp associated with the first resource demand;
a number of compute cores assigned to the first resource demand; and
network communication metrics associated with the first resource demand.

18-20. (canceled)

21. A method comprising:
configuring, by executing an instruction with programmable circuitry, compute resources of an edge compute device based on a first resource demand associated with a first location of the edge compute device;
detecting, by executing an instruction with the programmable circuitry, a change in location of the edge compute device to a second location; and
reconfiguring, by executing an instruction with the programmable circuitry in response to detection of the change in location, the compute resources of the edge compute device based on a second resource demand associated with the second location.

22. The method of claim 21, further including:
configuring network resources of the edge compute device based on a first spectrum availability associated with the first location of the edge compute device; and
reconfiguring the network resources of the edge compute device in response to the detection of the change in location.

23. The method of claim 21, wherein the edge compute device is a mobile edge compute device included in a network of edge compute devices, the network of edge compute devices including at least one stationary compute device.

24. The method of claim 23, further including configuring the compute resources of the edge compute device responsive to an input from another one of the edge compute devices, the input based on a third resource demand.

25. The method of claim 21, further including reconfiguring the compute resources based on an output of a machine learning model, the machine learning model to process input telemetry data, the input telemetry data including at least one of a vendor identifier, an Internet Protocol address, or a media access control address.

26. The method of claim 21, further including executing a virtual machine to reconfigure the compute resources.

27-30. (canceled)
